(19) United States
(12) Patent Application Publication
(10) Pub. No.: US 2012/0226630 A1
(43) Pub. Date: Sep. 6, 2012

(54) COMPUTER ARCHITECTURE AND PROCESS FOR PROTECTIVE INCOME MANAGER

(75) Inventors: John Robert SAWYER, Cincinnati, OH (US); Lance Holliman POOLE, Birmingham, AL (US)

(73) Assignee: PROTECTIVE LIFE INSURANCE COMPANY, Birmingham, AL (US)

(21) Appl. No.: 13/408,652

(22) Filed: Feb. 29, 2012

Related U.S. Application Data
(60) Provisional application No. 61/448,129, filed on Mar. 1, 2011.

(51) Int. Cl. G06Q 40/06

(52) U.S. Cl. 705/36 R

(57) ABSTRACT

Computer systems and computer implemented methods are provided for issuing and administering a variable annuity product that maximizes income for covered person(s) by distributing substantially all annuity contract value by the maximum annuity date, and for implementing allocation adjustment in conjunction with the variable annuity product or another insurance product.

### RELATED APPLICATIONS

This application claims the benefit of, and priority to, U.S. Provisional Application No. 61/448,129, filed Mar. 1, 2011, entitled “Protective Income Manager,” which is incorporated herein by reference in its entirety.

### BACKGROUND

Baby Boomers have not saved enough for retirement. They have also suffered through two significant market declines, which have further eroded their retirement funds. It is likely that Baby Boomers will need to spend all of their retirement funds to meet healthcare cost and longevity realities.

There is a growing percentage of Baby Boomers who have no heirs. This leads to fewer people with bequest motivations.

We have determined that existing living benefit designs are not adequate for the circumstances described above. Existing living benefit designs do not maximize income; they provide longevity and market protection. In addition, existing living benefits designs, albeit unintentionally, have a built-in bequest mechanism based on 5/6% withdrawal amounts. In most all scenarios, beneficiaries receive a death benefit.

Retirement spending patterns may actually decrease as people age. People need more income in the early years of retirement versus the later years when their health and vitality limit their activities. Immediate annuities can maximize income and/or minimize bequests, but have very low acceptance with consumers and advisors. Thus, we have determined that there is a need in the market for an improved product with regard to existing living benefit designs.

### SUMMARY

We have developed a product that can serve as an income solution for the Baby Boomer market. Specifically, in some embodiments, we describe herein a variable annuity product called Protective Income Manager (PIM), which is designed to maximize income for the person or persons covered by PIM by distributing substantially all annuity contract value by the maximum annuity date. In some embodiments, there is no bequest motivation. In some embodiments, this product includes a risk management component for Allocation Adjustment.

In some embodiments, PIM provides a minimum guaranteed income amount for life. Both spouses can be optionally covered. The annual payment will often be greater than a traditional living benefit. Annual payment may increase or decrease with account performance and years left until by the maximum annuity date. In some embodiments, PIM has a built in mechanism to increase payments as the covered person(s) age(s).

In some embodiments, the account value is amortized over the remaining period. To determine the amortization schedule, PIM will use an internal interest rate that varies by age. The interest rate will be reviewed and may be reset periodically. Preferably, the account value is always available for withdrawals and/or surrenders. Minimum benefit is simply recalculated if money is withdrawn beyond annual payment.

PIM may be available, for example, as an optional rider to deferred annuity contracts. It may also be offered as a stand-alone product. If offered as an optional rider, it generally can only canceled by surrendering the contract.

In one aspect, the invention provides computer system architecture for generating, administering, and issuing a living benefit rider product attached to an annuity product, comprising a payment factor computer database storing payment factors, an interest rates computer database storing interest rates, a policy information computer database storing customer specific policy related information, an electronic annuity application computer system receiving requests for the annuity product including a request for an election of the living benefit rider product, a transaction computer system executing transactions associated with the living benefit rider product, a unit value computer system determining unit values of underlying investment funds based on daily stock market information and applying charges associated with the annuity product including the living benefit rider product, a general ledger computer system tracking pertinent financial transactions, a check writing and electronic funds transfer computer system processing withdrawals of proceeds under predetermined terms of the living benefit rider product, a financial reporting and trending computer system tracking sales and product performance, an annuity administration computer system, connectable to said payment factor database, said interest rates database, said policy information database, said electronic annuity application computer system, said transaction computer system, said unit value computer system, said general ledger computer system, said check writing and electronic funds transfer computer system, and said financial reporting and trending computer system.

In some embodiments, the annuity administration computer system performs receiving the election of the living benefit rider product from said electronic annuity application computer system including an election of single or joint coverage and an age of each covered person, and processing a request for a living benefit payment including determining an account value responsive to data received from said unit value computer system, determining the living benefit rider product including a predetermined withdrawal amount based on the interest rates, the customer specific policy related information, and the payment factors, and generating instructions to issue a policy for the annuity product including the living benefit rider product.

In another aspect, the invention comprises a computer system architecture for generating, administering, and issuing a living benefit rider product attached to an annuity product, comprising a payment factor computer database storing payment factors, an interest rates computer database storing interest rates, a policy information computer database storing customer specific policy related information, an electronic annuity application computer system receiving requests for the annuity product including a request for an election of the living benefit rider product, a transaction computer system executing transactions associated with the living benefit rider product including accessing financial computer systems, and an annuity administration computer system, connectable to said payment factor database, said interest rates database, said policy information database, said electronic annuity application computer system, and said transaction computer system, said annuity administration computer system receiving the election of the living benefit rider product from said electronic annuity application computer system including an election of single or joint coverage and an age of each covered person, and processing a request for a living benefit payment including determining an account value responsive to data received from said financial computer systems, determining the living benefit rider product including a predetermined withdrawal amount based on the interest rates, the customer specific policy related information, and the payment factors, and generating instructions to issue a policy for the annuity product including the living benefit rider product.

In some embodiments, the annuity administration computer system interfaces with a third party print computer system and a mailing partner computer system to provide client statements and transaction confirmations.

In some embodiments, the administration computer system interfaces with one or more broker dealer computer systems to track agent licensing information, calculate and pay commissions on policy sales, and access commission and contract information.

In some embodiments, the computer system architecture further comprises at least one of a general ledger computer system tracking pertinent financial transactions, a check writing and electronic funds transfer computer system processing withdrawals of proceeds under predetermined terms of the living benefit rider product, and a financial reporting and trending computer system tracking sales and product performance.

In some embodiments, the computer system architecture further comprises a unit value computer system determining unit values of underlying investment funds based on daily stock market information and applying charges associated with the annuity product including the living benefit rider product.

In some embodiments, the computer system architecture further comprises at least one client interaction computer application for a policyholder to make direct transactions that will impact the annuity product including the living benefit rider product, the client interaction computer application comprising at least one of an interactive voice response system, an interne interface for accessing values and initiating transactions, a policy print computer system generating printed policies and policy statements, and a tax reporting computer system generating tax reports.

In another aspect, the invention provides a computer system architecture for providing a living benefit, comprising an annuity administration computer system receiving an election of a protective income manager (PIM) variable annuity benefit, one or more computer databases storing a plurality of system tables, one or more financial computer systems, and one or more client interaction computer systems, the computer databases, the financial computer systems, and the client interaction computer systems each in electronic communication with the annuity administration computer system processing PIM withdrawals, wherein said receiving the election of the PIM benefit comprises receiving policy information including an election of single or joint coverage and an age of each covered person, and receiving a purchase payment, and wherein said processing the PIM withdrawals comprises determining a contract value responsive to data from the one or more financial computer systems, determining a payment factor responsive to data from one or more of the plurality of system tables, and determining an optimal withdrawal amount based on the contract value and the payment factor.

In some embodiments, plurality of system tables comprise at least one of a product rules table, a PIM payment factors table, an interest rates table, a policy information table, and a business rules table.

In some embodiments, the financial computer systems comprise at least one of a general ledger system, a check processing system, a financial reporting system, and a variable fund unit value system.

In some embodiments, the client interaction computer systems comprise at least one of an electronic annuity application system, a policy print system, an interactive voice response system, a system providing internet access to values and transactions, and a system providing client statements and trade confirmations.

In some embodiments, the computer system further comprises an allocation computer system allocating payments and contract value responsive to allocation instructions based on at least one of predetermined Allocation by Investment Category (AIC) guidelines and a Benefit Allocation Model Portfolio.

In some embodiments, the computer system further comprises an Allocation Adjustment computer system determining an accumulation unit value for each sub-account in a predetermined investment category, and when the accumulation unit value for a particular sub-account is determined to fall below a predetermined value, transferring the contract value in that sub-account to an alternate specified account. In some embodiments, the accumulation unit value is a 12-month Simple Moving Average (SMA₁₂).

In another aspect, the invention provides a computer implemented method of providing a living benefit, comprising receiving an electronic election of a protective income manager (PIM) variable annuity benefit, by an annuity administration computer system, said receiving the electronic election comprising receiving policy information including an election of single or joint coverage and an age of each covered person, and receiving a purchase payment, storing the policy information in a computer database in communication with the annuity administration computer system, determining a contract value, by the annuity administration computer system, responsive to data from a unit value computer system in communication with the annuity administration computer system valuing each underlying variable fund, determining a payment factor, by the annuity administration computer system, responsive to data from one or more system tables stored in the computer database, including at least one of a product rules table, a payment factors table, an interest/other rates table, a policy information table, and a business rules table, determining an optimal withdrawal amount, by the annuity administration computer system, based on the contract value and the payment factor, and providing a PIM payment, by the annuity administration computer system, using a check processing system or an electronic funds transfer system in communication with the annuity administration computer system.

In some embodiments, the computer implemented method further comprises receiving the electronic election of the PIM benefit from a broker dealer computer system.

In some embodiments, the computer implemented method further comprises receiving the electronic election of the PIM benefit from an electronic annuity application computer system.

In some embodiments, the computer implemented method further comprises determining a fee for the PIM benefit, by the annuity administration computer system, responsive to the contract value and data from the interest/other rates table.

In some embodiments, the computer implemented method further comprises rebalancing the portfolio, by the annuity administration computer system, on a periodic basis.

In some embodiments, the computer implemented method further comprises determining the optimal withdrawal amount on each monthly anniversary of the PIM effective date.

In some embodiments, the computer implemented method further comprises, when withdrawal in excess of the optimal withdrawal amount is made, resetting the optimal withdrawal amount on the next monthly anniversary, and determining the optimal withdrawal amount on each subsequent monthly anniversary to be the lesser of the initial optimal withdrawal amount and the reset optimal withdrawal amount.

In some embodiments, the computer implemented method further comprises, when joint coverage is elected, determining the payment factor responsive to the age of the youngest covered person.

In some embodiments, the computer implemented method further comprises providing a PIM payment at least equal to the initial optimal withdrawal amount, even when the contract value is zero.

In some embodiments, the computer implemented method further comprises monitoring, by the annuity administration computer system, the unit value for each sub-account in a predetermined investment category, and, when the value for a particular sub-account is determined to fall below a predetermined value, transferring the contract value in that sub-account to an alternate specified account.

In some embodiments, the unit value for each sub-account in a predetermined investment category is a 12-month Simple Moving Average (SMA₁₂).

In another aspect, the invention provides a computer implemented method of generating an electronic transaction to perform an allocation adjustment for a customer account of an annuity product, comprising retrieving by a specially programmed computer processor customer specific policy related information associated with the annuity product from a policy information computer database, determining by the specially programmed computer processor an accumulation unit value for at least one fund in a specified investment class of the account at a given time t (AUVₜ) for the customer specific policy related information, determining by the specially programmed computer processor a 12-month simple moving average accumulation unit value for the at least one fund for the prior 12 months (SMA₁₂), when AUVₜ is less than SMA₁₂, designating by the specially programmed computer processor the at least one fund as restricted, when the AUVₜ is greater than or equal to SMA₁₂, designating by the specially programmed computer processor the at least one fund as unrestricted, and when the at least one fund is designated as restricted, generating by the specially programmed computer processor the electronic transaction to perform the allocation adjustment for the customer account.

In some embodiments, the computer implemented method further comprises, when the at least one fund is designated as restricted, generating by the specially programmed computer processor the electronic transaction to perform the allocation adjustment for the customer account to convert the at least one fund to a predetermined alternative fund. In some embodiments, the alternative fund is a money market fund.

In some embodiments, the computer implemented method further comprises determining an updated AUV for the restricted fund at a time subsequent to time t, and when the updated AUV is greater than or equal to SMA₁₂, designating the previously-restricted fund as unrestricted, and using the percentage of account value in the alternative fund associated with said electronic transaction to purchase units in the previously-restricted fund. In some embodiments, the time subsequent to time t is monthly anniversary of the contract.

In some embodiments, the computer implemented method further comprises generating a daily extract with information including AUVₜ, SMA₁₂, name of the fund, and restricted indicator, and using the extract to populate a web site with the information so that customers can tell which funds have been restricted and which fund are unrestricted.

In another aspect, the invention provides a computer system architecture for allocation adjustment for a variable account of an insurance contract, comprising a unit value computer system determining an accumulation unit value for each underlying fund in the variable account and, for each contract, converting all purchase payments and contract value in the fund into accumulation units, a computer database storing unit value data, an allocation adjustment computer system determining the accumulation unit value for each fund in a specified investment class of the variable account at a given time t (AUVₜ), determining a 12-month simple moving average accumulation unit value for the fund for the prior 12 months (SMA₁₂), and when AUVₜ is less than SMA₁₂, designating the fund as restricted, and when the AUVₜ is greater than or equal to SMA₁₂, designating the fund as unrestricted, and a transaction computer system transferring all money in the restricted fund to a predetermined alternative fund when the fund is restricted, and when a previously-restricted fund is designated as unrestricted, using the percentage of account value in the alternative fund associated with said transferring to purchase units in the previously-restricted fund. In some embodiments, the alternative fund is a money market fund.

In some embodiments, the computer system architecture further comprises the transaction computer system determining an updated AUV for the restricted fund at a time subsequent to time t, and, when the updated AUV is greater than or equal to SMA₁₂, designating the previously-restricted fund as unrestricted, and using the percentage of account value in the alternative fund associated with said transferring to purchase units in the previously-restricted fund. In some embodiments, the time subsequent to time t is monthly anniversary of the contract.

In some embodiments, the computer system architecture further comprises a reporting computer system generating a daily extract with information including AUVₜ, SMA₁₂, name of the fund, and restricted indicator, and using the extract to populate a web site with the information so that customers can tell which funds have been restricted and which fund are unrestricted.

### BRIEF DESCRIPTION OF THE DRAWINGS

FIG. 1 is an exemplary diagram of PIM (Protective Income Manager) Computer Systems Architecture, according to some embodiments of the invention.

FIG. 2 is an exemplary flowchart showing steps to issue a policy for an annuity product, according to some embodiments of the invention.

FIG. 3 is an exemplary flowchart showing steps to allocate contract value, according to some embodiments of the invention.

FIG. 4 is an exemplary flowchart showing steps to apply a fee for a living benefit, according to some embodiments.

FIG. 5 is an exemplary flowchart showing steps for calculating an optimal withdrawal amount and providing a living benefit, according to some embodiments.

FIG. 6 is an exemplary flowchart showing additional processes that may be performed according to various embodiments of the invention.

FIG. 7 shows an exemplary Additional Rider/Benefit Controls Screen, GMWB (Guaranteed Minimum Withdrawal Benefit) Benefit Definition.

FIG. 8 shows an exemplary Plan Information Screen, Age Specifics Dialog Box.

FIG. 9 shows an exemplary GMWB Benefit Definition Dialog Box.

FIG. 10 shows an Automatic Withdrawal Screen, according to some embodiments.

FIG. 11 shows a Policy Master Screen with PIM and ATP (Asset Transfer Program) Checkboxes, according to some embodiments.

FIG. 12 shows an exemplary Additional Rider Information Screen.

FIG. 13 shows an exemplary PIM Information Dialog Box.

FIG. 14 shows a Unit Values Screen, according to some embodiments.

FIG. 15 shows an Additional Rider/Benefit Controls Screen with ATP Checkbox, according to some embodiments.

FIG. 16 shows a Fund Description Screen with ATP Checkbox, according to some embodiments.

FIG. 17 shows an exemplary AIC (Allocation by Investment Category) Checker Screen.

### DETAILED DESCRIPTION

In some embodiments, Protective Income Manager, or PIM, is a variable annuity product that may be provided as an optional rider to deferred annuity contracts and/or as a stand-alone product. The description herein refers to the embodiment in which PIM is a rider. PIM allows a customer to withdraw all of their contract value systematically over a period of time. In some embodiments, PIM advantageously guarantees the right to make withdrawals each year even if the contract value is reduced to zero due to poor market performance, and provides fixed lifetime income payments for the life of any covered person. PIM is designed to distribute the contract value by the maximum annuity commencement date, in annual amounts that may vary from year to year (the “Optimal Withdrawal Amount”) based on the contract value and a payment factor determined by the age and number of the Covered Peron(s).

As used herein, Covered Person refers to the person or persons upon whose lives the benefits of the rider are based. Covered Persons are selected at rider issue (Single vs. Joint) and may be subject to age requirements (e.g., must be between age 60 and 80 on the Rider Effective Date). The annuitant on the policy should be a covered person. Optimal Withdrawal Amount (OWA) is the maximum amount that may be withdrawn each contract year without incurring a surrender charge. Maximum Annuity Date is the latest annuity commencement date (ACD) permitted under the contract to which the rider is attached. In certain preferred embodiments, the maximum ACD is the younger covered person's 95th birthday. In alternative embodiments, the maximum ACD may be the older covered person's 95th birthday.

Exemplary contracts to which PIM may be added include ProtectiveRewards® Elite NY (AFAL), ProtectiveRewards® II NY (AFNB), ProtectiveAccess® XL NY (AFNX), ProtectiveAccess® XL (PLAX), ProtectiveRewards® Elite (PLLS), ProtectiveRewards® II (PLPR), Protective Variable Annuity (PVA Series B, C & L), and/or PVA NY (Series B, C & L), each available from the Protective Life Insurance Company. The PIM rider may be elected at the time the contract is purchased, or purchased at a later date (e.g., under the RightTime® option) as long as the rider age requirements are satisfied and the rider is still available for sale.

A Contract's Variable Account value at any time is the sum of the Sub-Account values and therefore reflects the investment experience of the Sub-Accounts to which it is allocated. In some embodiments, there is no guaranteed minimum Variable Account value. The Sub-Account value for any Sub-Account as of the Effective Date is equal to the amount of the initial Purchase Payment allocated to that Sub-Account. On subsequent Valuation Days prior to the Annuity Commencement Date, the Sub-Account value is equal to that part of any Purchase Payment allocated to the Sub-Account and any Contract Value transferred to the Sub-Account, adjusted by income, dividends, net capital gains or losses (realized or unrealized), decreased by partial surrenders (including any applicable surrender charges and premium tax), Contract Value transferred out of the Sub-Account and fees deducted from the Sub-Account. The Sub-Account value for a Contract may be determined on any day by multiplying the number of Accumulation Units attributable to the Contract in that Sub-Account by the Accumulation Unit value for the Accumulation Units in that Sub-Account on that day.

In some embodiments, Purchase Payments allocated and Contract Value transferred to a Sub-Account are converted into Accumulation Units. An Accumulation Unit is a unit of measure used to calculate the value of a Sub-Account prior to the Annuity Commencement Date. The number of Accumulation Units to be credited to a Contract is determined by dividing the dollar amount directed to the Sub-Account by the Accumulation Unit value of the appropriate class of Accumulation Units of that Sub-Account for the Valuation Day as of which the allocation or transfer occurs. Purchase Payments allocated or amounts transferred to a Sub-Account under a Contract increase the number of Accumulation Units of that Sub-Account credited to the Contract. Such allocations and transfers are executed as of the end of the Valuation Period in which a Purchase Payment or Written Notice or other instruction requesting a transfer is received. Certain events may reduce the number of Accumulation Units of a Sub-Account credited to a Contract. Any of the following exemplary events may result in the cancellation of the appropriate number of Accumulation Units of a Sub-Account:
surrenders and applicable surrender charges;
partial surrenders and applicable surrender charges;
partial automatic withdrawals;
transfer from a Sub-Account and any applicable transfer fee;
payment of a death benefit claim;
application of the Contract Value to an Annuity Option; and
deduction of the monthly Protective Income Manager fee and/or the annual contract maintenance fee

The Accumulation Unit value for each class of Accumulation Units in a Sub-Account at the end of every Valuation Day is the Accumulation Unit value for that class at the end of the previous Valuation Day times the net investment factor.

In some embodiments, Initial Optimal Withdrawal Amount as of the Rider Effective Date is determined by multiplying the “Protective Income Manager Payment Factor” (described below) by the Contract Value on that date. Optimal Withdrawal Amount will be recalculated on each subsequent Contract Anniversary prior to the Annuity Commencement Date by multiplying the Protective Income Manager Payment Factor by the Contract Value on that anniversary. The Payment Factor is determined by the age and number of the Covered Person(s). The payment factors and assumed interest rate that apply on the Rider Effective Date are described in detail below.

In some embodiments, if Protective Income Manager was purchased at the same time as the Contract (so the Rider Effective Date is the same as the Contract Effective Date), the Purchase Payments received within 120 days of that date will be aggregated and, at the end of that 120-day window, the Optimal Withdrawal Amount as of the Rider Effective Date will be recalculated. The recalculated Optimal Withdrawal Amount as of the Rider Effective Date will be equal to the Purchase Payments received during 120-day window less any withdrawals taken since that date (the Contract Value), multiplied by the payment factor as of the Contract Effective Date.

In some embodiments, the Optimal Withdrawal Amount is at least the greater of: (a) a specified percentage (e.g., 90%) of the Optimal Withdrawal Amount for the prior Contract Year; or (b) the initial Optimal Withdrawal Amount. The Optimal Withdrawal Amount may be accessed by requesting withdrawals individually or instructing that specific amounts be sent periodically. The Written Notice should include all the information necessary to complete and remit the requested amounts.

In some embodiments, the Protective Income Manager rider is designed for Protective Income Manager Withdrawals to be taken each Contract Year. In general, the Protective Income Manager rider allows withdrawal of the greater of (i) the Optimal Withdrawal Amount for a Contract Year or (ii) the RMD attributable to the Contract (determined as of December 31st immediately preceding the beginning of the Contract Year). If all withdrawals on and after the Rider Effective Date are Protective Income Manager Withdrawals, the Optimal Withdrawal Amount will never decrease below the initial Optimal Withdrawal Amount and that amount may be continued to be withdrawn for the lifetime of the Covered Person (or the last surviving Covered Person, if Joint Life Coverage is selected).

In some embodiments, the Optimal Withdrawal Amount is not cumulative. If only a part of, or none of, the Optimal Withdrawal Amount is withdrawn in any given Contract Year, any unused Optimal Withdrawal Amount cannot be carried over to any future Contract Years.

An Excess Withdrawal is any portion of a withdrawal that, when aggregated with all prior withdrawals during that Contract Year, exceeds the Optimal Withdrawal Amount. In some embodiments, if an Excess Withdrawal is taken, the next Contract Anniversary will be a Reset Date. On that date the “floor” will be Reset for all future Optimal Withdrawal Amounts following the Reset Date. The Optimal Withdrawal Amount on each Contract Anniversary following the Reset Date will be the lesser of the initial Optimal Withdrawal Amount and the Optimal Withdrawal Amount as of the Reset.

In some embodiments, if the Contract Value is reduced to zero due to poor Sub-Account performance, the deduction of fees, and/or a Protective Income Manager Withdrawal, the rider will be terminated the benefit settled under Protective Income Manager rider as follows. The remaining Optimal Withdrawal Amount will be paid until the Contract Anniversary following the date of the transaction that reduced the Contract Value to zero. An Annuity Commencement Date will be established that is the Contract Anniversary following the date of the transaction that reduced the Contract Value to zero. The Optimal Withdrawal Amount will continue to be recalculated on each Contract Anniversary. Because the Contract Value will be zero, the Optimal Withdrawal Amount will decrease by 10% each Contract Year, but will never drop below the initial Optimal Withdrawal Amount (or your Optimal Withdrawal Amount as of the most recent Reset Date, if applicable).

In some embodiments, a monthly fee may be deducted for the Protective Income Manager rider that compensates for the costs and risks assumed in providing this benefit. The fee may be greater if the rider is purchased under the RightTime® option. The fee may increase, but in some embodiments will never exceed a specified percentage (e.g., 2.00%, or 2.20% if purchased under the RightTime® option). In some embodiments, an option may be provided to elect not to pay an increase in the Protective Income Manager Fee. If this option is elected, then the most recent Protective Income Manager Payment Factor will be “locked in” will be used to calculate the Optimal Withdrawal Amount on all future Contract Anniversaries. In some embodiments, the Protective Income Manager fee is deducted from the Sub-Accounts of the Variable Account only; it is not deducted from the assets in the DCA (Dollar Cost Averaging) Fixed Account. The deduction of the monthly fee is treated as a partial surrender, but will not incur a surrender charge, will not reduce any penalty-free surrender amount available under the Contract, and will not reduce the current year's Optimal Withdrawal Amount or be treated as an Excess Withdrawal under the rider.

Under the Protective Income Manager rider, Purchase Payments and Contract Value are preferably allocated in accordance with predetermined Allocation Guidelines and Restrictions. In some embodiments, all Purchase Payments and Contract Value are allocated (a) in accordance with specified Allocation by Investment Category (AIC) guidelines or (b) in accordance with a specified eligible Benefit Allocation Model Portfolio; or (c) a portion of Purchase Payments and Contract Value are allocated in accordance with a Benefit Allocation Model Portfolio and the remaining portion in any manner, provided the overall allocation is consistent with the AIC guidelines. Allocation by Investment Category guidelines specify minimum and maximum percentages of the Contract Value that are allocated to each of a specified number of categories of Sub-Accounts. In some embodiments, the percentage of Contract Value to allocate to individual Sub-Accounts within each group can be selected, but the total investment for all Sub-Accounts in a group should comply with the specified minimum and maximum percentages for that group. Purchase Payments may also be allocated to dollar cost averaging (“DCA”) Fixed Account(s), provided that transfers from the DCA Fixed Account are allocated to the Sub-Accounts in accordance with the Allocation Guidelines and Restrictions described above.

In preferred embodiments, certain annuity products having a living benefit rider available (e.g., Protective Life Values Advantage or Dimensions products with SecurePay FX living benefit, or any products with a Protective Income Manager rider available, see examples above) include Allocation Adjustment. Under this program, the performance of each Sub-Account in specified categories of the Allocation by Investment Categories is monitored. If, on any Monthly Anniversary Day after the first Contract Anniversary, the Accumulation Unit value of a Sub-Account in the specified category drops below a specified level the Sub-Account will be temporarily “restricted” from allocations of Purchase Payments and Contract Value and all existing Contract Value in the Sub-Account will be transferred to a specified fund/s (e.g., Oppenheimer Money Fund Sub-Account). The “monthly anniversary” is the same day as the Contract's Effective Date in each subsequent calendar month. In some embodiments, if any monthly anniversary is not a Valuation Date or does not occur in the month, allocation adjustment transfers will process as of the next Valuation Period.

In some embodiments, under the Allocation Adjustment, a 12-month Simple Moving Average (“SMA”) is calculated for each Sub-Account on each Monthly Anniversary Day. (See, for example, Garrison M. M. et. al., Journal of Financial Planning February 2010, pp. 51-61, incorporated herein by reference, for discussion of 12-month SMA.) Each Sub-Account's SMA is the average Accumulation Unit value for that Sub-Account based on its Accumulation Unit value on the current monthly Anniversary Day and each of the last 11 Monthly Anniversary Days. If a Sub-Account has not been in existence for 12 months, the SMA will be calculated using the net asset value of the Fund in which the Sub-Account invests, adjusted for Contract charges and expenses, for each month no Accumulation Unit value is available. Once a Sub-Account's SMA on a Monthly Anniversary Day is calculated, it is compared to the Sub-Account's current Accumulation Unit value on that Monthly Anniversary Day. If the Sub-Account's current Accumulation Unit value is equal to or less than the Sub-Account's SMA over the 12 most recent Monthly Anniversary Days, then the Sub-Account will be considered to be restricted.

In some embodiments, Contract Value in the specified fund/s may be transferred to any non-restricted Sub-Account, and/or new allocation instructions may be submitted to allocate additional Purchase Payments, rebalance the Contract Value, and/or apply automatic DCA transfers to any non-restricted Sub-Accounts, provided the new instructions are consistent with the Allocation by Investment Category guidelines.

The Sub-Account may be considered to be no longer restricted when, on a subsequent Monthly Anniversary Day, the Sub-Account's current Accumulation Unit value is greater than its current 12-month SMA. If that occurs, on that Monthly Anniversary Day all of the Contract Value in the specified fund/s attributable to the previously restricted Sub-Account will be transferred back to the previously restricted Sub-Account based on the current allocation percentages. At this time, allocating Purchase Payments and transferring Contract Value into the previously restricted Sub-Account may be resumed, and any automated transactions involving the previously restricted Sub-Account will also be resumed.

In alternative embodiments, different mathematical models (other than SMA) may be used to monitor Sub-Accounts. In some embodiments, certain Sub-Accounts (e.g., Sub-Accounts in a conservative category) are not monitored or restricted.

The Protective Income Manager rider may also include portfolio rebalancing. Under this program, the Variable Account value is rebalanced based on allocation instructions in effect at the time of the rebalancing. Rebalancing may be specified on a quarterly, semi-annual, or annual basis. In some embodiments, if the period is not specified, rebalancing will be performed semi-annually based on the Rider Effective Date and/or each time the Contract allocation is changed (e.g., upon receipt of a request to transfer Contract Value (not including DCA or portfolio rebalancing transfers) or a subsequent Purchase Payment that is accompanied by new allocation instructions).

In some embodiments, certain Allocation instructions may be prohibited, such as one or more of (a) allocating a Purchase Payment so that the allocation of the Contract Value following the Purchase Payment is inconsistent with the Allocation Guidelines and Restrictions; (b) directing a dollar cost averaging transfer so that the allocation of the Contract Value following the transfer is inconsistent with the Allocation Guidelines and Restrictions; (c) transferring any Contract Value so that the allocation of the Contract Value following the transfer is inconsistent with the Allocation Guidelines and Restrictions; (d) deducting the proceeds of a withdrawal or partial surrender from an Allocation Option so that the allocation of the Contract Value following the withdrawal or surrender is inconsistent with the Allocation Guidelines and Restrictions; or (e) terminating the rebalancing of the Contract Value. In some embodiments, Prohibited Allocation instruction(s) will result in termination of the Protective Income Manager rider. A rider so terminated may be reinstated upon request subject to specified terms and conditions.

### PIM Computer Systems Architecture

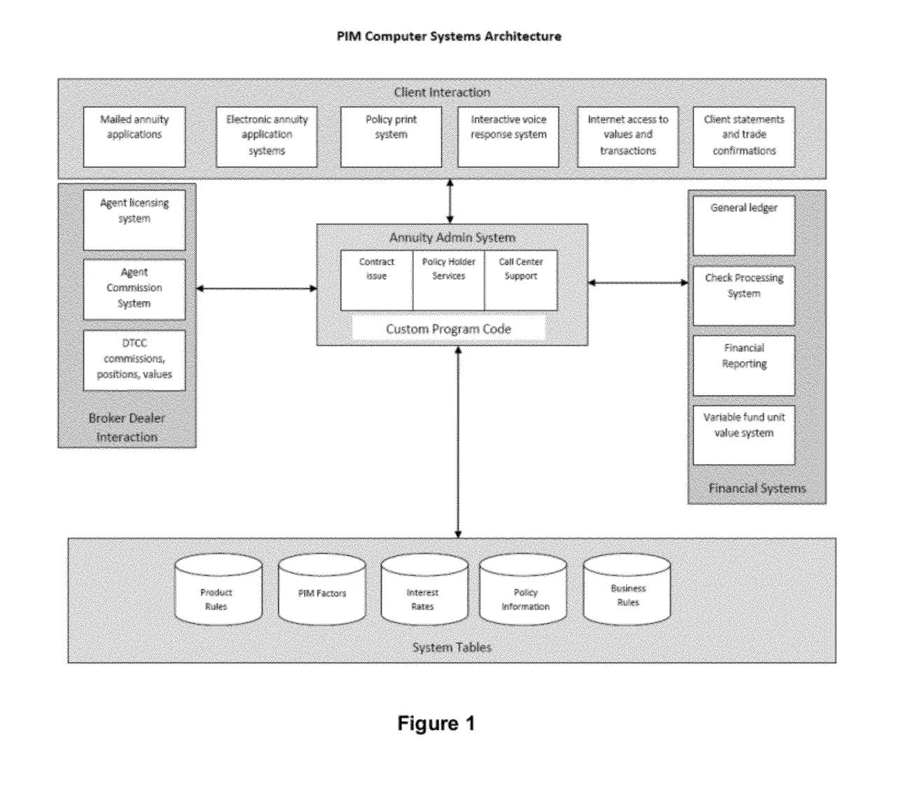

The PIM rider is developed on a variable annuity computing platform, which includes of a number of different interfaced systems running on multiple physical and virtual computers and processors. A schematic diagram of the PIM computer systems architecture, according to some embodiments, is shown in FIG. 1.

The annuity administration system (“the system”) is the core of the variable annuity computing platform. This system is used to issue annuity contracts, perform policy holder and maintenance activities once the contract is active, and to provide information to the call center to answer client questions. The system performs numerous calculations necessary to accurately value the annuity contracts and related benefits, and performs a wide variety of transactions in both real-time and batch. The system is maintained and enhanced in house by a team of systems developers and business systems analysts. The bulk of the custom programming being implemented to support the PIM product will be made to the annuity administration system. Various systems tables will also be coded to support the PIM functionality, including unique product rules, PIM factors, interest rates, and business rules. The system will access policy information stored in system tables for additional information needed in performing the calculations.

The annuity administration system interfaces to the client in a number of ways through a number of different systems. Client applications are received through the mail and also via several industry standard and proprietary electronic application systems. The client receives policy print created via specialized publishing tools. Client statements and transaction confirmations are generated via interfaces with third party print and mailing partners. The client may access account values and perform some transactions over the phone via a specialized interactive voice response system and also on the interne using a custom online customer service application. Many of these client-facing applications are custom modified to support the PIM product.

The annuity administration system also interfaces with various distribution partners who sell products for the insurance company. These systems are used to track agent licensing information, calculate and pay commissions on the policy sales, and provide access to commission and contract information using a number of proprietary and industry standard platforms, such as the DTCC (The Depository Trust & Clearing Corporation).

The annuity administration system also interfaces with various financial systems. Unique accounts will be established in the corporate general ledger for tracking pertinent financial transactions. The corporate check writing system (or EFT process) will be used to process withdrawals of proceeds under the terms of the PIM contract. Information on the PIM product will be sent to in-house financial reporting and trending systems to track sales and product performance.

In some embodiments, PIM comprises a variable annuity product, and special variable funds are preferably established in the unit value system for valuing the underlying variable funds and applying the specific charges associated with this product.

### Exemplary PIM Flows

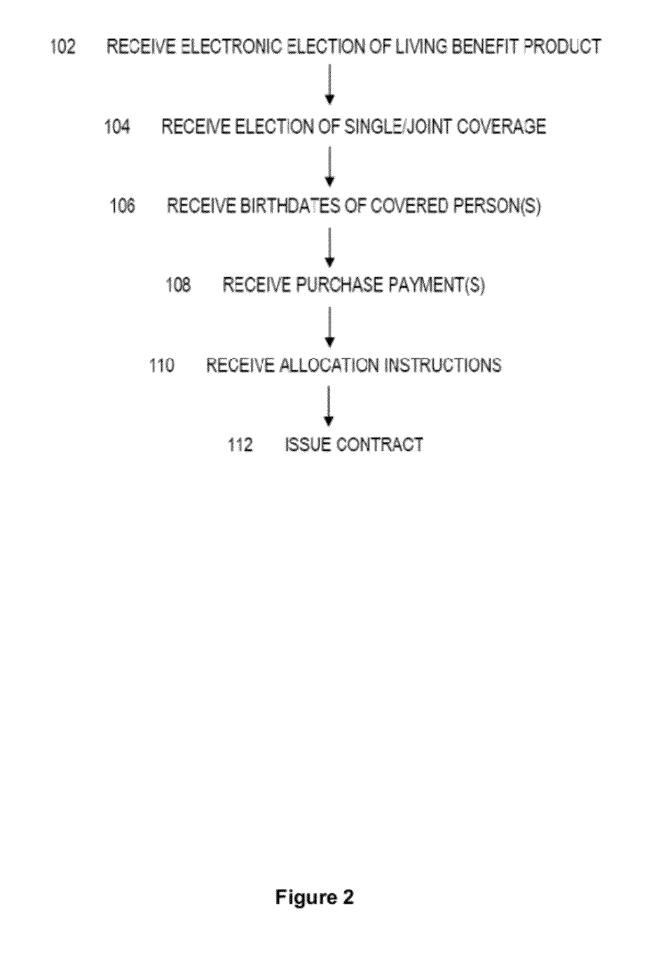

FIG. 2 shows exemplary steps to issue a policy for an annuity product. In some embodiments, to issue a contract with a living benefit according to the present invention, the system will receive an election of a living benefit product 102, receive an election of single or joint coverage 104, receive birthdates of covered person(s) 106, receive one or more purchase payments 108, receive allocation instructions 110, and then issue the contract 112.

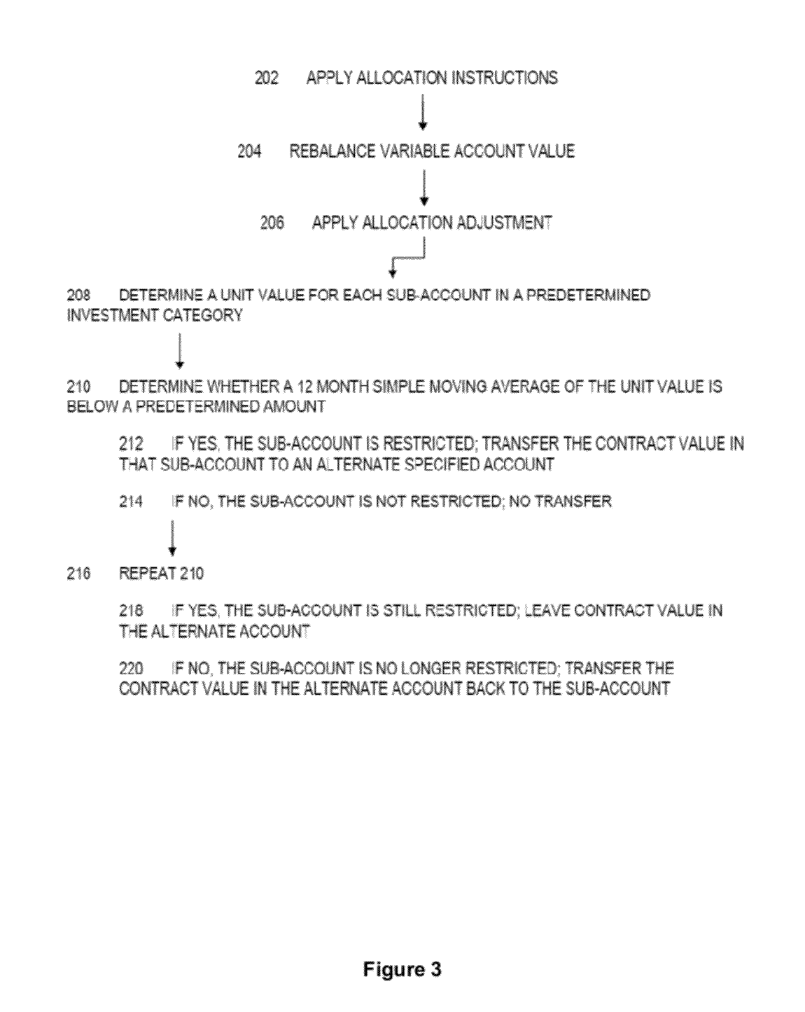

FIG. 3 shows exemplary steps for allocating contract value. The allocation instructions received at 110 are applied 202, preferably in accordance with AIC guidelines as described above. The contract value in the variable account may be periodically rebalanced 204. In some embodiments, the product includes allocation adjustment, which is applied at 206. A unit value is determined for each sub-account in a given investment category 208. Then, at a specified time, a determination is made as the whether a 12-month simple moving average of said unit value is below a specified amount 210. If yes, the sub-account is deemed restricted, and the contract value in that sub-account is transferred to an alternate specified account (e.g., a money market account) 212. If no, the sub-account is not restricted and no transfer occurs. Step 210 may be repeated periodically for the restricted sub-accounts 216. If the new determination is that the 12-month simple moving average is still below the specified amount, the sub-account is still restricted and the transferred value remains in the alternate specified account 218. If the new determination is that the 12-month simple moving average is no longer below the specified amount, the sub-account is no longer restricted, and the value in the alternate specified account attributable to the transfer may be returned to the sub-account 220.

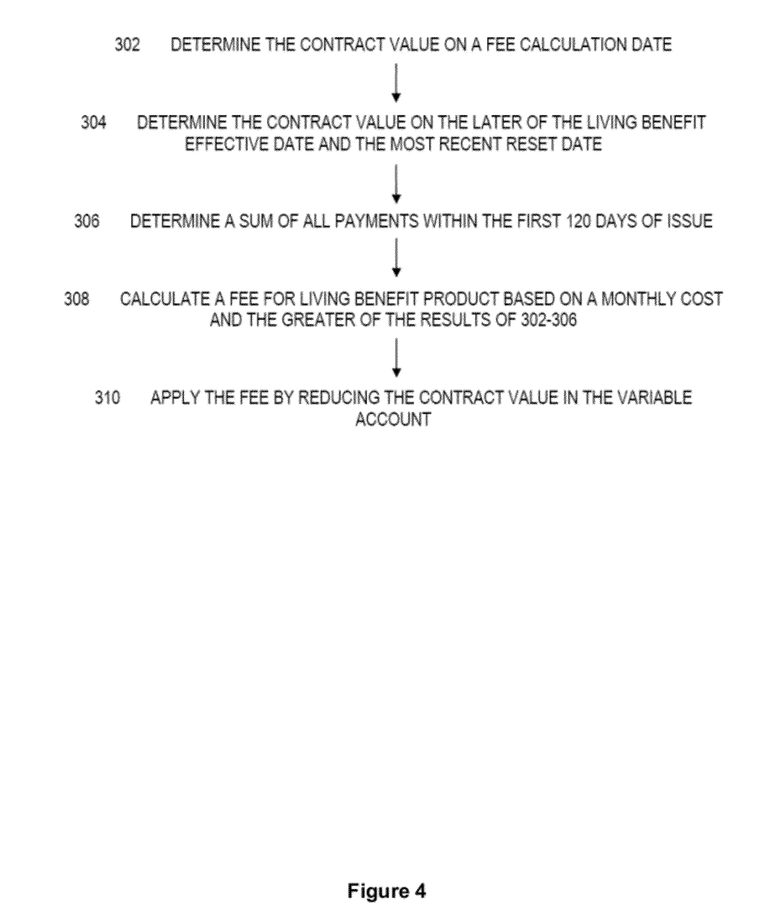

FIG. 4 is an exemplary flowchart showing steps to apply a fee for a living benefit, according to some embodiments. The contract value is determined on a fee calculation date 302. The contract value is determined on the later of the living benefit effective date and the most recent reset date 304. The sum of all payments within the first 120 days of issue may be determined 306. At 308, the fee for the living benefit product is calculated based on a specified monthly cost (e.g., may be table-driven) and the greater of the results of 302-306. The fee may then be applied, for example by reducing the contract value in the variable account 310.

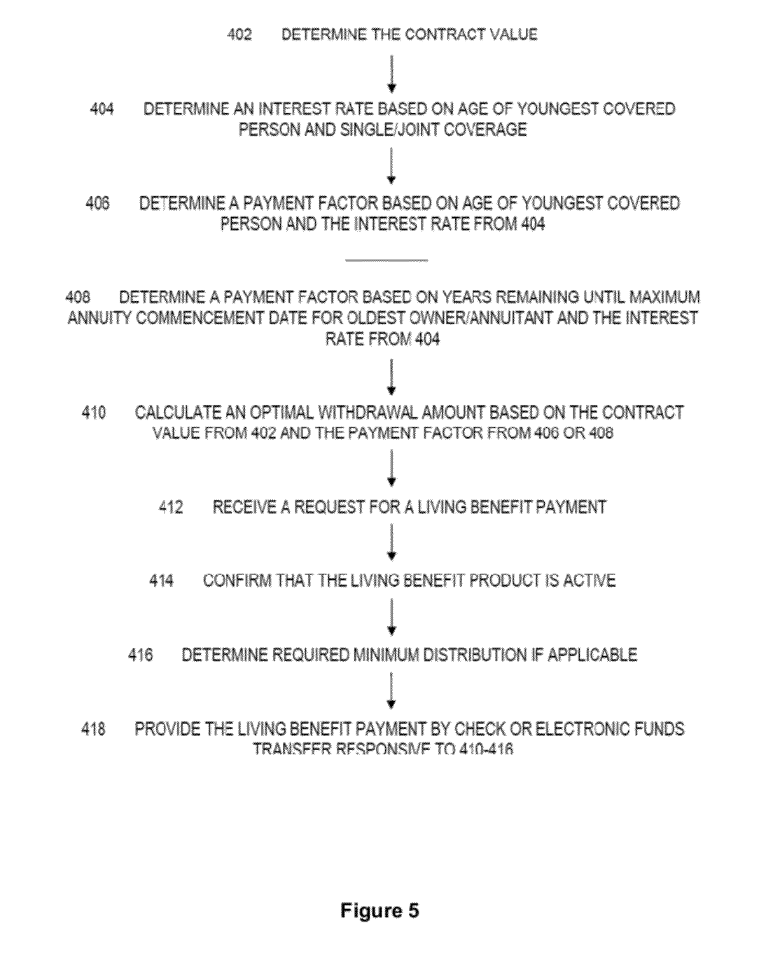

FIG. 5 is an exemplary flowchart showing steps for calculating an optimal withdrawal amount and providing a living benefit, according to some embodiments. The contract value is determined at 402. An interest rate is determined 404, for example, based on the age of the covered person as determined from 106 (youngest covered person, if joint coverage was elected at 104). Then, a payment factor is determined, for example based on the age of the youngest covered person 406, or alternatively based on the number of years remaining until the maximum annuity commencement date for the oldest owner/annuitant 408. Then, an optimal withdrawal amount is calculated 410, based on the contract value from 402 and the payment factor from 406 or 408. The system receives a request for a living benefit payment 412, confirms that the living benefit product is active 414, determines required minimum distribution if applicable 416, and provides the living benefit 418, for example by check or electronic funds transfer.

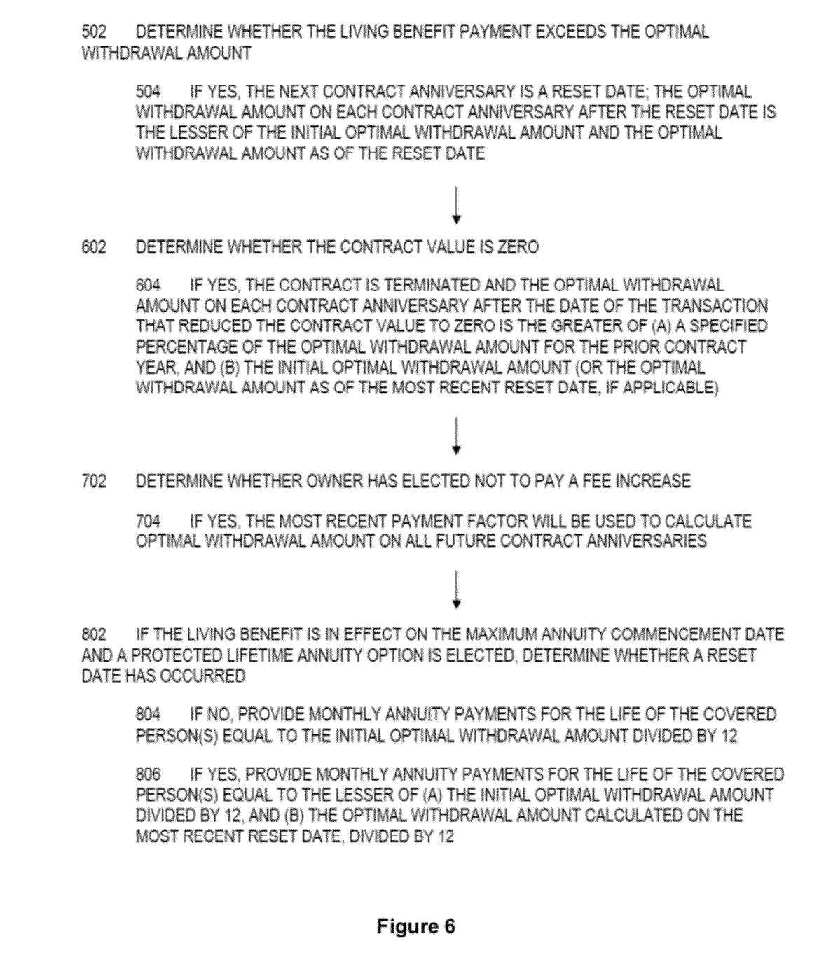

FIG. 6 is an exemplary flowchart showing additional processes that may be performed according to various embodiments of the invention. For example, following 418, the system may determine whether the living benefit payment exceeds the optimal withdrawal amount 502. If so, then the next contract anniversary may be deemed a reset date 504. As described above, the optimal withdrawal amount after the reset date may be the lesser of the initial optimal withdrawal amount and the optimal withdrawal amount as of the reset date.

In addition, in some embodiments, the system may monitor the contract value, and determine whether the contract value is zero 602. If the contract value is zero, the contract is terminated 604 and the optimal withdrawal amount on each contract anniversary after the date of the transaction that reduced the contract to zero is the greater of (a) a specified percentage of the optimal withdrawal amount for the prior contract year, and (b) the initial optimal withdrawal amount (or the optimal withdrawal amount as of the most recent reset date, if applicable).

At 702, the system may determine whether the owner has elected not pay a fee increase. If yes, the most recent payment factor will be used to calculate optimal withdrawal amount on all future contract anniversaries 704.

If the living benefit is in effect on the maximum annuity commencement date and a protected lifetime annuity option is elected, the system may determine whether a reset date has occurred 802. If no reset date has occurred, monthly annuity payments equal to the initial optimal withdrawal amount divided by 12 may be provided for the life of the covered person(s) 804. If a reset date has occurred, monthly annuity payments equal to the lesser of (a) the initial optimal withdrawal amount and (b) the optimal withdrawal amount on the most recent reset date, divided by 12, may be provided for the life of the covered person(s) 806.

### PIM Rider on the System

The PIM rider may be added to a contract as an optional WB (withdrawal benefit) rider. In some embodiments, the base rider functionality is table driven. An Additional Rider/Benefit Controls Table such as that shown in Table I will be used to set up the rider. Table 1 lists exemplary values for various fields that may be used to define the rider. Any fields not listed should be set to their default values (zeros or spaces).

TABLE 1
Additional Rider/Benefit Controls Table, New PIM Plans

| | Rider/Benefit Plan Name | | |
|---|---|---|---|
| | PIMISA | PIMRTA | PIMSCA |
| Benefit Name | Protective | Protective | Protective |
| | Income | Income | Income |
| | Manager | Manager | Manager |
| | | (RightTime) | (Special Case) |
| Availability | Issue | Post Issue | Post Issue |
| Field Security | No | No | Yes |
| Req'd | | | |
| Min. Owner/ | 60 | 60 | 60 |
| Annuitant Issue | | | |
| Age | | | |
| Max. Owner/ | 80 | 80 | 80 |
| Annuitant Issue | | | |
| Age | | | |
| Benefit Charge | 12 Monthly | 12 Monthly | 12 Monthly |
| Basis | | | |
| Benefit Charge | 12 1 Month | 12 1 Month | 12 1 Month |
| Start | | | |
| Voluntary | Y Years | Y Years | Y Years |
| Termination Basis | | | |
| Voluntary | 10 | 10 | 10 |
| Termination Period | | | |
| Roll-up Type | N/A | N/A | N/A |

In some embodiments, contracts that purchase the PIM rider may not also have an enhanced Death Benefit. The only Death Benefit allowed with the PIM rider is the Return of Purchase Payment Death Benefit. This is due to the fact that the rider is designed to deplete the contract value over time. These higher periodic withdrawals may reduce the Death Benefit value more quickly than if a Guaranteed Minimum Withdrawal Benefit (GMWB) rider (e.g., SecurePay from Protective Life) is selected. System edits will prevent a contract from being issued with a PIM rider and an enhanced Death Benefit. In addition, system edits will prevent a PIM RightTime® rider from being added to a contract with an incompatible Death Benefit. The Death Benefit must first be changed, then the rider will be allowed to be added.

### Benefit Election

Preferably, before a client can take withdrawals on a PIM rider, the Benefit Election Date is set. This will trigger edits for Covered Persons, which are required for the PIM Payments. Existing logic for determining Covered Person(s) may be utilized with the PIM rider.

The PIM rider should be elected at the time the rider is purchased. In some embodiments, when a PIM rider is added to a policy, the Benefit Election Date will automatically be populated with the Rider Effective Date (application signed date if prior to issue). Existing system edits for SecurePay will then require the Covered Persons to be entered before the rider can be saved on the policy.

### PIM Fee

A separate Benefit Charge Type of “PM PIM” is added to the system in order to support the charge associated with the PIM rider. This may be similar, for example, to an existing “WB GMWB” charge for SecurePay riders. The logic for implementing the Protective Income Manager Fee is be modeled after the current SecurePay Fee.

Since there is no Benefit Base associated with a PIM rider, the fee must be based on some other value. The calculation for the fee according to some embodiments is shown in Equation 1:

Monthly Fee=[1−(1−Cost)^{1/12}]*β as of the calculation date [Equation 1]

where [1−(1−Cost)^{1/12}] is the monthly cost that is stored in the systems tables, and β=the greater of:
(a) The contract value on the fee calculation date; or
(b) The contract value on the later of the Rider Effective Date or the most recent Reset Date; or
(c) Sum of the gross amount of all payments with the first 120 days if the rider is purchased at issue (only evaluated after the first 120 days of the contract).

The Cost will be table driven. The annual rates for the PIM rider, according to some embodiments, are shown in Table 2. Using Equation 2, these annual rates can be converted to a Monthly Cost, also shown in Table 2.

Monthly Cost=1−[(1−Annual %)^{1/12}] [Equation 2]

TABLE 2
Initial PIM Fee Rates

| | | Monthly |
|---|---|---|
| Rider | Annual Rate | Cost |
| Protective Income Manger | 100 bps (1.0%) | 0.000837 |
| Protective Income Manager | 110 bps (1.1%) | 0.000921 |
| (RightTime) | | |
| Protective Income Manager | 100 bps (1.0%) | 0.000837 |
| (Special Case) | | |

The PIM Monthly Cost will be stored in the Interest/Other Rates Table. In some embodiments, the monthly rate will be stored, not the annual rate. If and when updated rates are required, only one record should be added to the table with the Process and Effective Dates equal to one another.

The PIM Fee will be calculated as of each contract anniversary month, starting the first month after the rider is effective. The charge is not pro-rated for partial months, either when the PIM is added, or if it is terminated. The actual deduction of the fee will occur on the day following the anniversary month in order to allow for backdated quotes on the anniversary month to not include the PIM Fee in the quoted value. The actual transaction used to deduct the PIM Fee will be the ‘PC’ transaction with a special memo code of ‘PIM’. This is the same logic that is used for the SecurePay Fee. All logic rules currently in use for PC transactions for policies issued on the 29th through 31st of any given month will also apply to the PC/PIM transaction. In addition, the same logic that is in place for the SecurePay Fee only being deducted from variable funds also applies to the PIM Fee.

When the PIM rider is added to a contract, the PC/PIM transaction will automatically be added, just as the PC/GMWB transaction is added for SecurePay riders. The start date and frequency for the PC transaction will be determined based on the values in the Additional Rider/Benefit Controls Table.

In some embodiments, as individual PC/PIM transactions process they will not be confirmed. They will, however, appear on the Quarterly Statements with a description of ‘Protective Income Manager Fee’.

### PACs and Other Purchase Payments

Clients will typically purchase the PIM rider with one or more initial payments and then begin taking PIM withdrawals after the first month. Thus, preferably only payments in the first 120 days will count towards the Payment Base. Payments after the first 120 days will be taken into account on the next contract anniversary when the Optimal Withdrawal Amount is recalculated. More information about the 120-day recalculation of the OWA is given below.

In some embodiments, on contracts with a SecurePay rider, once the Benefit Election Date is set and withdrawals start, additional purchase payments are prohibited by edits. These edits will need to be bypassed for PIM riders since in some embodiments additional payments, although not encouraged, are allowable.

PACs (Planned Amortization Class payments) should not be allowed on contracts with a PIM rider. This will automatically be handled by existing edits that do not allow PAC to be set up once the Benefit Election Date has been populated on a WB rider.

### Portfolio Rebalancing

In preferred embodiments, contracts with the PIM benefit have Portfolio Rebalancing. The frequency of the rebalance can be quarterly, semi-annually, or annually. If the owner does not select a frequency, it will be defaulted to a semi-annual basis with the first transaction occurring six months after the rider effective date.

In some embodiments, during the policy issue process, if there is an active PIM rider, Admin will be forced to schedule a PR (portfolio rebalancing) transaction before the system will allow the contract to be issued. If a PR exists on the Schedule Record, the system does not care what the PR effective date is; in other words, during Issue, the system will not modify the date on a scheduled PR transaction.

### Optimal Withdrawal Amount (OWA)

Optimal Withdrawal Amount is calculated as a percentage of the Contract Value. The rider is designed to provide higher, fluctuating withdrawal amounts each year, with the intent of depleting the Contract Value by the maximum annuity date.

The OWA is calculated on the Rider Effective Date and each contract anniversary that follows. This is different than on the GMWB riders, where the Annual Withdrawal Amount (AWA) is calculated on the Benefit Election Date (which could be different than the Rider Effective Date) and on each contract anniversary thereafter.

Equation 3 shows how the OWA is calculated for the PIM rider for some embodiments. When the OWA is calculated on riders that were purchased at issue, the gross amount of the payments at issue are used to calculate the initial OWA. This will allow for all premiums to be included in the case of a front-end load product.

OWA=Contract Value*Payment Factor [Equation 3]

In some embodiments, the Payment Factor is determined by the number of years remaining until the oldest covered person's 95th birthday and an assumed interest rate based on the age and number of covered persons. Equation 4 shows how to calculate the Payment Factor under this option.

Payment Factor=i/((1+i)*(1−(1+i)̂(age on anniv−95))) [Equation 4]

where i=PIM interest rate as shown in Table 3, determined using age of oldest covered person for all products. In some embodiments, the PIM interest rate may be determined using the age of the youngest covered person. The tables in Appendix B provide PIM rider payment factors for Single Life and Joint Life Coverage using Equation 4.

In alternative embodiments, the annual payment factor is determined by the younger Covered Person's attained age (number of years until the younger Covered Person's 95th birthday) instead of the number of years remaining until the contract's maximum annuity date. Under this option, the components in the Payment Factor equation will change slightly, as shown in Equation 5. This will make the equation more consistent in that the same covered person is used to determine the interest and the duration.

Payment Factor=i/((1+i)*(1−(1+i)̂(age on anniv−age until 95))) [Equation 5]

where i=PIM interest rate as shown in Table 3, determined using age of youngest covered person, and age until 95=determined using age of youngest covered person. The tables in Appendix A provide PIM rider payment factors for Single Life and Joint Life Coverage using Equation 5.

In other embodiments, different calculations to determine the PIM Payment Factor may be used.

TABLE 3
PIM Interest Rates

| | Single | Joint |
|---|---|---|
| | Interest Rate | Interest Rate |
| Issue Age | (PIMSNG) | (PIMJNT) |
| 60 | 4.00% | 3.50% |
| 61 | 3.95% | 3.45% |
| 62 | 3.90% | 3.40% |
| 63 | 3.85% | 3.35% |
| 64 | 3.80% | 3.30% |
| 65 | 3.75% | 3.25% |
| 66 | 3.70% | 3.20% |
| 67 | 3.65% | 3.15% |
| 68 | 3.60% | 3.10% |
| 69 | 3.55% | 3.05% |
| 70 | 3.50% | 3.00% |
| 71 | 3.45% | 2.95% |
| 72 | 3.40% | 2.90% |
| 73 | 3.35% | 2.85% |
| 74 | 3.30% | 2.80% |
| 75 | 3.25% | 2.75% |
| 76 | 3.20% | 2.70% |
| 77 | 3.15% | 2.65% |
| 78 | 3.10% | 2.60% |
| 79 | 3.05% | 2.55% |
| 80 | 3.00% | 2.50% |
| 81 | 2.95% | 2.45% |
| 82 | 2.90% | 2.40% |
| 83 | 2.85% | 2.35% |
| 84 | 2.80% | 2.30% |
| 85 | 2.75% | 2.25% |
| 86 | 2.70% | 2.20% |
| 87 | 2.65% | 2.15% |
| 88 | 2.60% | 2.10% |
| 89 | 2.55% | 2.05% |
| 90 | 2.50% | 2.00% |
| 91 | 2.45% | 1.95% |
| 92 | 2.40% | 1.90% |
| 93 | 2.35% | 1.85% |
| 94 | 2.30% | 1.80% |
| 95 | 2.25% | 1.75% |

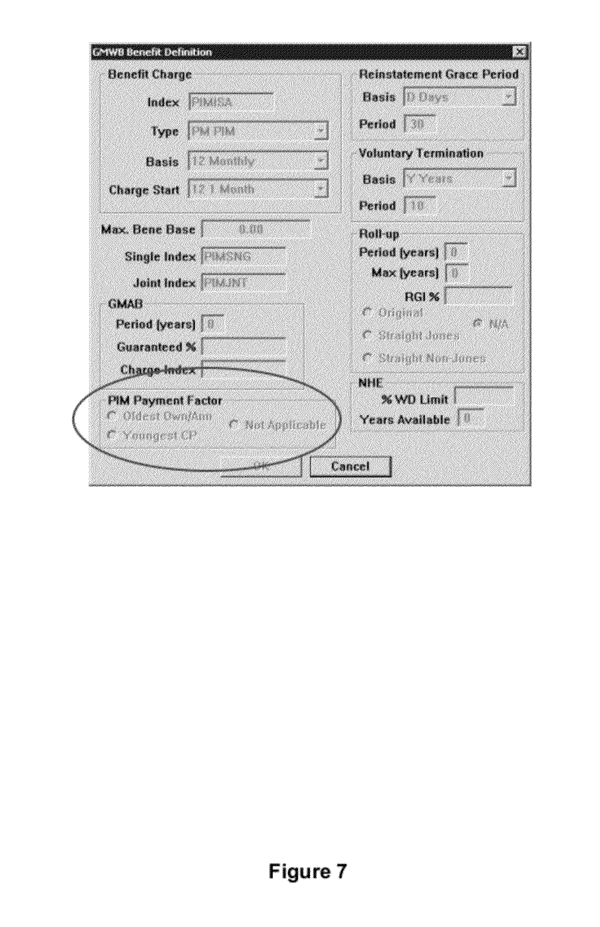

In order to differentiate between the two types of calculations described above, in some embodiments a new field will be added to the Additional Rider/Benefit Controls Table. This will be displayed on the screen as a series of radio buttons (see FIG. 7).

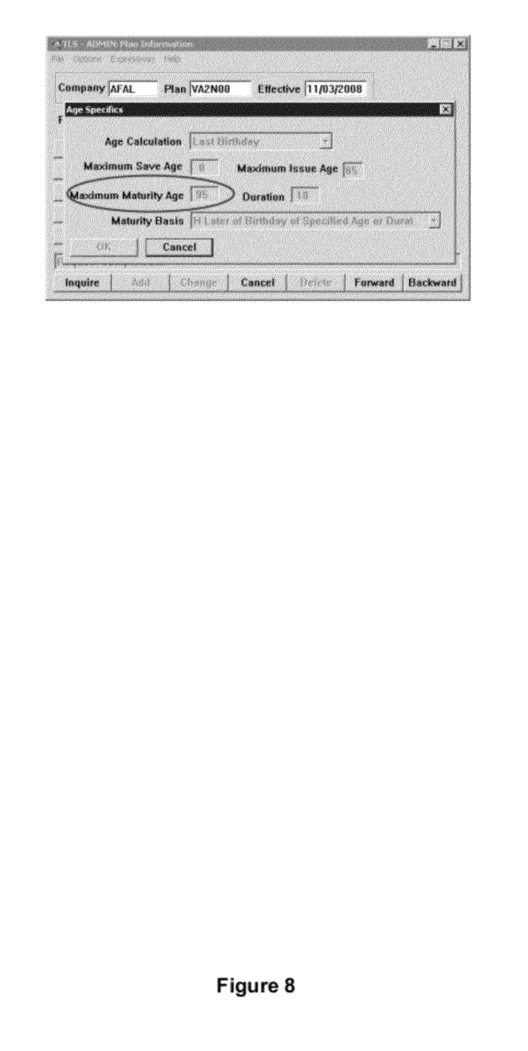

In some embodiments, the age at Latest ACD used in Equation 4 is already stored on the system in the Plan Information Table under Maximum Maturity Age (see FIG. 8). By using this table setting instead of hard coding the age of 95 into the equation, a greater amount of flexibility is built into the equation for alternative products and use of the rider. The age on anniversary is the attained age of the oldest covered person. This will allow the calculation of the number of years remaining until the Latest ACD in Equation 4.

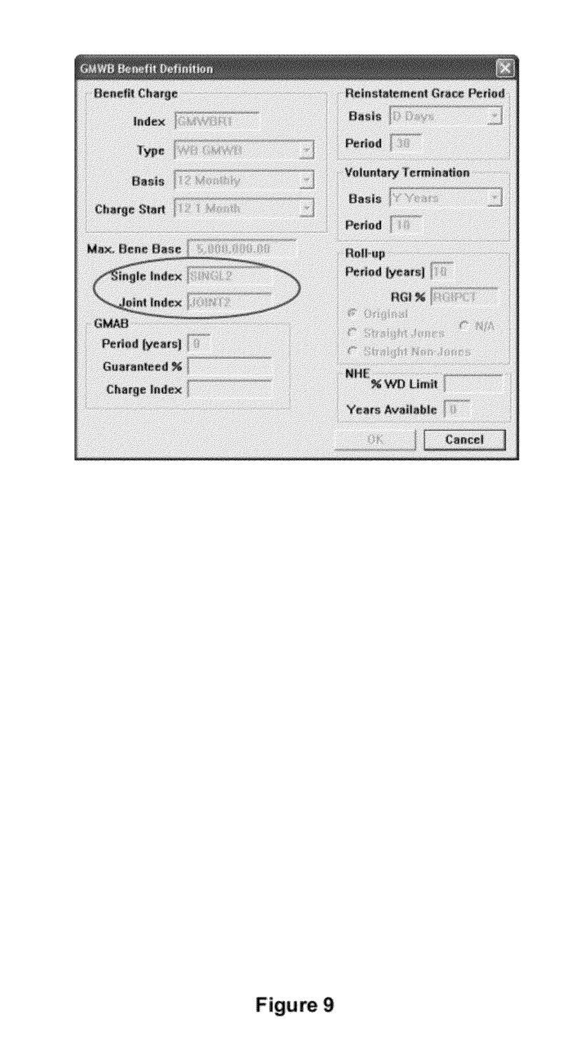

The interest rates in Table 3 will be stored in the Insurance Rates Table, which will allow rates be stored based on age. The index into the Insurance Rate Table will be stored in the Additional Rider/Benefit Control record under the Single Index and Joint Index fields, as seen in FIG. 9. The age used to look up the rate will be the age of the youngest covered person at the time of issue or the latest Reset Date, if there has been a reset. The system stores the youngest covered person as the Primary Covered Person on the Additional Rider Information record.

Recalculate PIM OWA (RP Transaction):

In some embodiments, for PIM riders purchased at contract issue, all payments within the first 120-days of the rider will be used to recalculate the OWA on day 120 of the rider. A new transaction will be added to the system and will automatically be added to the Schedule file when the contract is issued with a PIM rider. This one-time ‘RP’ transaction will process on the 120th day of the contract and recalculate the OWA as of the Rider Effective Date for the contract.

The OWA will be calculated as the sum of the gross amount of all purchase payments within the 120 days less any withdrawals taken since the Rider Effective Date, multiplied by the payment factor as of the Contract Effective Date.

In some embodiments, the RP transaction will not appear on confirms or on the quarterly statements. Withdrawals taken will be deducted from the new OWA amount to determine the new OWA Remaining value.

PIM Limiter on Anniversary:

Each anniversary as the OWA is recalculated there are limiters in place to prevent the amount from dropping or growing beyond reasonable bounds. The OWA may be limited, for example, as follows:
Can be no higher than a specified percentage (e.g., 110%) of previous OWA amount
Can be no lower than a specified percentage (e.g., 90%) of previous OWA amount
Can be no lower than the initial OWA amount
   If a fee increase is declined, then the floor on the next anniversary recalculation is removed.

Nursing Home Enhancement (NHE) and Underwriting:

The NHE and Underwriting that may be used on the SecurePay rider to increase the Maximum Withdrawal Percent (MWP) do not apply to the PIM rider. On SecurePay the MWP is used to calculate the Annual Withdrawal Amount. On PIM, the OWA is calculated using the Payment Factor.

### PIM Payment (Withdrawals)

All withdrawals on contracts with a PIM rider are considered PIM withdrawals. These withdrawals are called PIM Payments in the rider language. They may, however, use a WD transaction code on the system.

Withdrawals can either be unscheduled or scheduled. Withdrawals in excess of the OWA cause a Reset on the next contract anniversary. The OWA is not recalculated until contract anniversary, so any additional withdrawals after an excess withdrawal in a contract year are also considered excess withdrawals. The exception to this is RMD (required minimum distribution) withdrawals. In some embodiments, RMD withdrawals are never considered excess withdrawals. They do, however, reduce the remaining OWA for the year.

In preferred embodiments, surrender charges do not apply to the allowed PIM withdrawal amount. This amount will be treated similar to the free amount on the policy. Modifications may need to be made to ensure that surrender charges are not applied to these withdrawals. However, surrender charges do apply to excess withdrawals that also exceed the free amount.

In some embodiments, if an excess withdrawal, including any applicable surrender charges, reduces the contract value to $0, the contract will terminate as of that date.

The excess amount of a withdrawal is the amount exceeding the OWA remaining (see Equation 6). When an excess withdrawal occurs, any systematic withdrawals are terminated. They may be resumed after the next contract anniversary upon written notice from the client.

Excess WD Amount=Gross WD Amount−OWA Remaining [Equation 6]

Unscheduled Withdrawals:

Unscheduled withdrawals will utilize a PIM memo code. These can be added either via Transaction Maintenance or the Quick Withdrawal screen. Edits are preferably added to ensure the following:
Benefit Election Date has been set
WD uses the PIM memo code (if active rider contract is always in benefit period—will be PIM or RMD)
Excess WD warning if WD exceeds the OWA remaining (does not apply on RMD)
Withdrawals are pro-rata

The module that processes withdrawals is preferably modified to perform the following:
Reduce the value of the OWA remaining by the withdrawal amount. The OWA remaining should never be less than zero
If an unscheduled (excess or non-excess) withdrawal—cancel any PPIM
Delete WD/PPIM from Schedule Activities
Delete Automatic Withdrawal Master Record from Schedule File
Add error message to Error Report to notify Admin that PPIM and Master deleted

RMD Withdrawals:

RMD withdrawals may still be entered according to existing procedures. Even during the Benefit Period, RMD withdrawals will still continue to use the RMD memo code. However, the module that processes withdrawals should be modified to perform the following for RMD withdrawals on contracts with an active PIM rider:
Reduce the value of the OWA remaining by the withdrawal amount. The OWA remaining should never be less than zero
If a one-time RMD WD is processed and the contract has PPIM set up, the automatic withdrawals must be terminated

Scheduled Withdrawals:

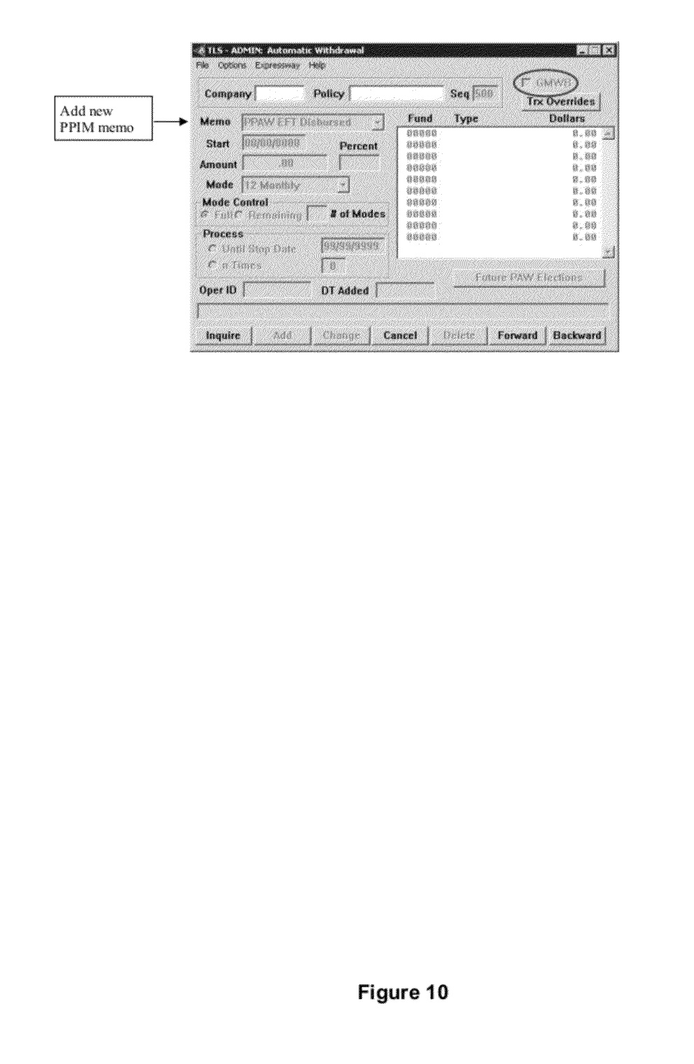

Scheduled withdrawals will preferably utilize a PPIM memo code. These will be set up via the Automatic Withdrawal screen (FIG. 10). Clients will not normally request PPIM withdrawals by dollar amount, but instead by percent of the OWA. This will allow the withdrawal amount to be recalculated each anniversary. If a flat dollar amount is requested, the amount will not be recalculated on anniversary and could lead to an excess withdrawal.

Edits are preferably added to ensure the following:
WD uses the PPIM memo code (if active rider, policy is always in Benefit Period—will be PPIM)
Non-PIM contracts do not use the PPIM memo code
Percentage does not exceed 100%
Withdrawals are pro-rata

In some embodiments, when a WD/PPIM processes, an edit will be added in order to ensure that there is still an active PIM rider. If not, the withdrawal will not process. This will ensure that if the rider is manually terminated and Admin does not delete the scheduled withdrawal, the client does not continue to receive the benefits.

In the event that Admin needs to process a single Automatic Withdrawal through Transaction Maintenance (e.g., if the original transaction were reversed), then a PNIM memo code will be utilized.

### Anniversary Processing

In some embodiments, when a contract has an active PIM rider, additional processing may be required on the contract anniversary. This would be in addition to the normal anniversary processing for the contract.

OWA Calculations:

OWA will be calculated on contract anniversary and stored on the Additional Rider Record. In addition, the OWA Remaining, which is also stored on the Additional Rider Record, should be reset to the calculated OWA. Equation 3 details the OWA calculation.

PPIM Automatic Withdrawals—Reset Amount:

If the contract has systematic withdrawals set up in order that the client may receive the OWA, the periodic amount on the automatic withdrawal should be recalculated each anniversary if the client has selected to receive a percentage of the OWA. At the time the periodic amount is modified on the Automatic Withdrawal Master Record, the Start Date should also be changed to reflect the next scheduled WD/PPIM. This will force the special confirmation to automatically be produced.

### Protected Lifetime Payment and Annuitization

In some embodiments, built into the cost of the rider is a Protected Lifetime Payment (alternatively referred to as Longevity Insurance). This benefit allows the client to elect to receive fixed monthly payment for the life of the covered person equal to 1/12th of the annual Protected Lifetime Payment amount if the contract remains in force on the Maximum Annuity Date.

The annual Protected Lifetime Payment will be equal to the OWA as of the Rider Effective Date or, if a Reset Date has occurred, the lesser of the OWA on the most recent Reset Date or the OWA as of the Rider Effective Date. The system will store the Protected Lifetime Payment and the Reset Date on the Additional Rider Information record.

In some embodiments, if the Annuity Commencement Date occurs before the Maximum Annuity Date, the Contract Value may be taken in a lump sum immediately, and the Protected Lifetime Payment Annuity Option is not available.

### Rider Termination

The rider may be terminated if any of the following occurs:
1. A payment is received with allocation instructions that do not meet AIC Guidelines
2. DCA (Dollar Cost Averaging) instructions are received that do not meet AIC Guidelines
3. Future allocation (and rebalance) instructions are received that do not meet AIC Guidelines
4. A fund-specific withdrawal is made
5. Portfolio Rebalancing is stopped
6. Covered Person is changed
7. Voluntary termination more than 10 years after the Rider Effective Date
8. The contract is annuitized prior to the Latest Annuity Date
9. The contract is terminated for any reason

If the rider is terminated due to any of reasons 1-5 in the above list, it may be reinstated within 30 days of the rider termination date. In some embodiments, PIM is allowed to have an additional payment during the reinstatement period. A non-PIM withdrawal processed during the reinstatement period would have to be reversed and reprocessed as a PIM WD if the rider is reinstated.

In some embodiments, one or more of the following Termination Reasons are available on the Additional Rider Record for the PIM rider:
A—Allocation Change
C—Covered Person
D—Change DCA
H—Stop PC
M—Mistake
P—Purchase Payment
R—Stop PR
T—Transfer
W—Withdrawal
X—Death

For most of the termination reasons, a termination letter is sent to the client. However, in some embodiments, for C, H, M, W, and X, no letter is sent.

### Policy Master Record GMWB Indicator

Preferably, there is an indicator that is stored on the Policy Master record to indicate if a given contract has an active SecurePay Rider. The indicator is used in various places throughout the system to easily determine if a rider is present, most notably on screens throughout the system as a bright red indicator that the contract has a SecurePay Rider. In some embodiments, the GMWB checkbox on the Policy Master Screen is modified to show the bright red indicator for GMWB riders using a model portfolio methodology, and a bright purple indicator for those contracts which contain a SecurePay rider utilizing AIC methodology. GMWB checkboxes on all other screens in the system may continue to show only bright red when a SecurePay rider of any variety is active on a given contract.

Table 4 shows exemplary values that may be used in the indicator field for the SecurePay Riders. The table includes the new values that will be utilized to indicate when a PIM rider is present on a contract. The indicator will continue to be set initially when a Rider is added to the contract, and modifications will be made, as needed, where ever the indicator is referenced to ensure the proper logic is used for SecurePay riders vs. PIM riders.

TABLE 4
PM-GMWB-IND Values

| PM-GMWB-IND | |
|---|---|
| Value | Description |
| I | SecurePay Rider at Issue - uses Model Logic |
| R | SecurePay Rider RightTime - uses Model Logic |
| A | SecurePay Rider at Issue - uses AIC Logic |
| T | SecurePay Rider RightTime - uses AIC Logic |
| P | Protective Income Manager at Issue |
| M | Protective Income Manager RightTime |

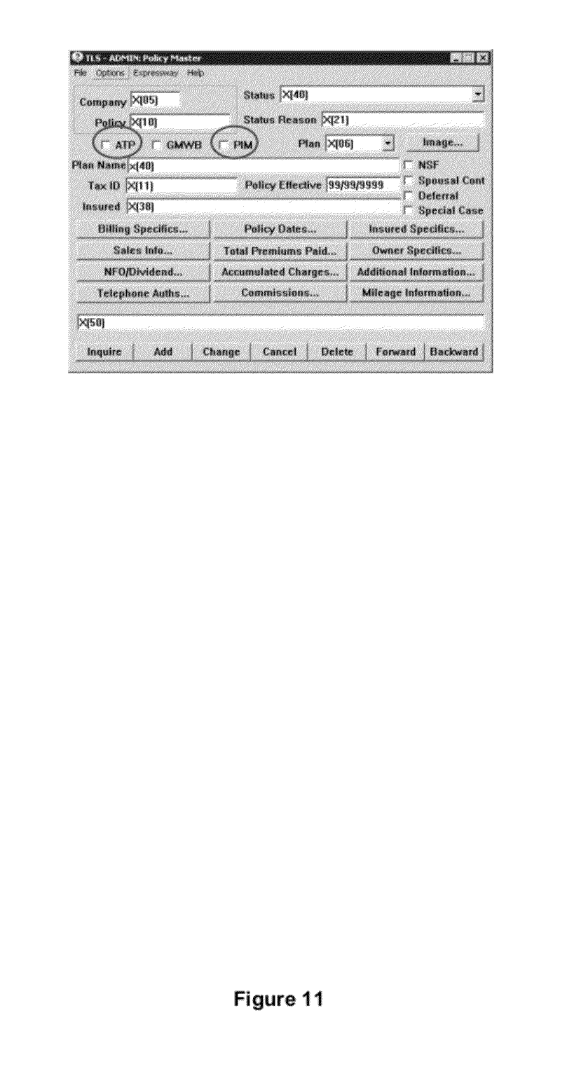

In some embodiments, a new checkbox will be added to the Policy Master Screen. The PIM checkbox (see FIG. 11) will indicate when a PIM rider is present on the contract, as determined by the PM-GMWB-IND being equal to ‘P’ or ‘M’. This checkbox will also show as bright purple when selected, just as the GMWB checkbox does on Policy Master when a SecurePay rider with AIC Logic is present.

### Additional Rider Information Screen

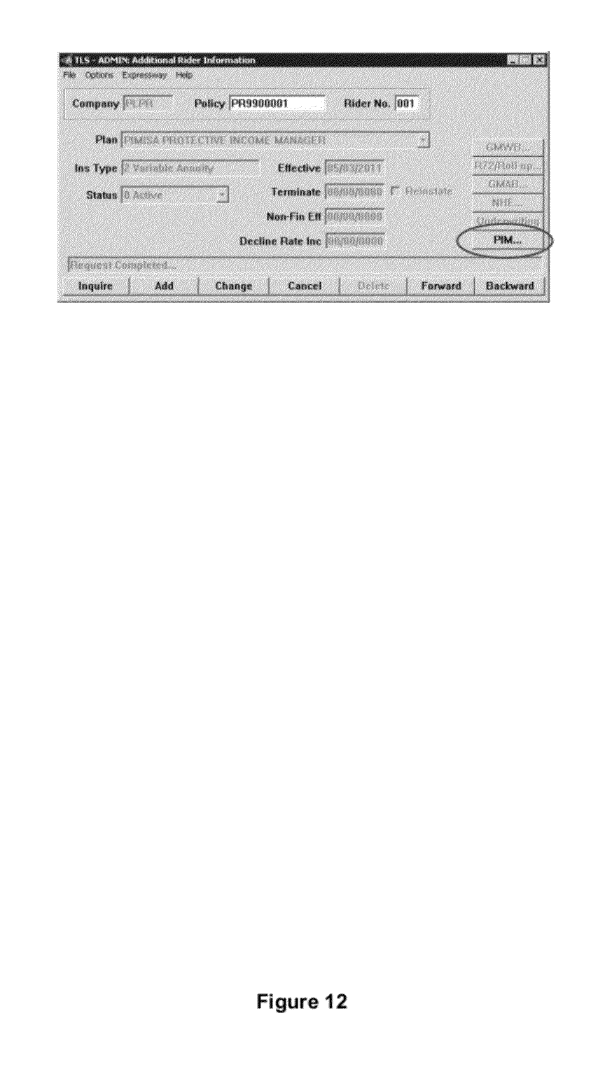

In some embodiments, a new PIM pushbutton or link will be added to the main Additional Rider Information Screen in order to allow a dialog box to be added that will contain the PIM specific terminology (see FIG. 12). Most of the underlying fields are the same fields used for the SecurePay riders. When the screen is brought up for a new rider to be added, all pushbuttons will be available. Once the GMWB indicator is set on Policy Master, then only the appropriate buttons will be available on each contract. For SecurePay, the PIM button will be grayed out and all other buttons will be available. For PIM, the PIM button will be available and all others will be grayed out.

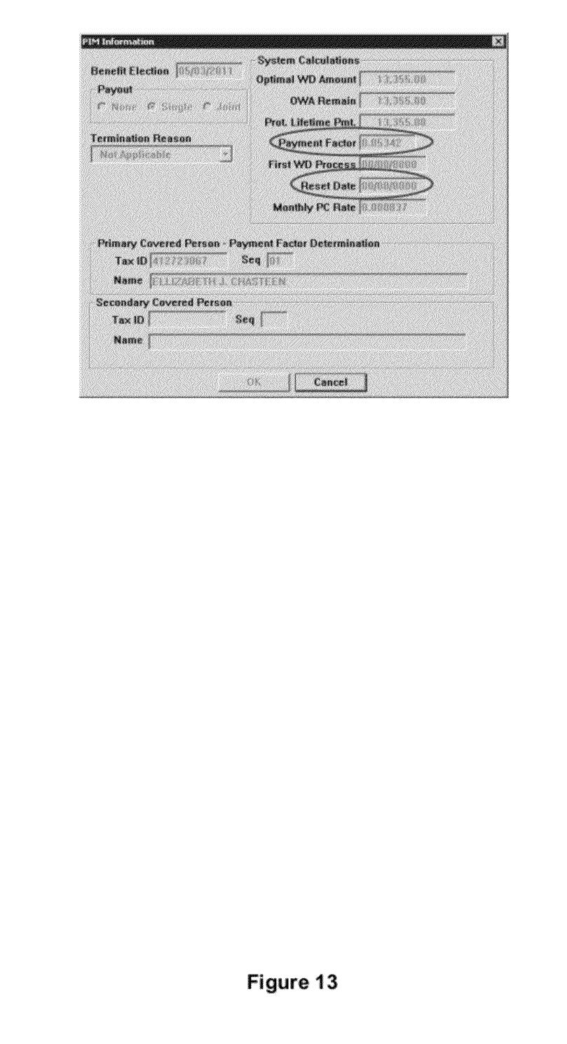

When the PIM pushbutton is selected, a new PIM Information dialog box will be displayed (see FIG. 13). As previously stated, the majority of the fields on this dialog box are also available on the GMWB Information dialog box. Some of the fields have been given updated labels on this dialog box in order to match the terminology to the PIM rider. There are two new fields on this screen that are not available for the SecurePay riders. The Payment Factor and Reset Date fields are new to the PIM rider.

### Appless

The PIM rider can be selected at time of issue on Appless business. Modifications to the NSCC (National Securities Clearing Corporation) File/Processor Interface program may be made in order to recognize the PIM benefit has been selected and to build the Additional Rider Record. This should be coordinated in order to know what codes will be used in the Appless file to indicate the PIM benefit has been selected.

### Correspondence

When the rider is purchased, a rider schedule will be sent to the client. In some embodiments, an updated rider schedule (PIM Amendment) will be sent each time there is a reset and the Protected Lifetime Payment is recalculated.

### Asset Transfer Program (ATP)

In some embodiments, an asset transfer/allocation adjustment mechanism may be used in conjunction with PIM and/or other benefit products. The goal of an Asset Transfer Program (ATP) is to employ a trading strategy to maximize the long term wealth of a portfolio in the withdrawal phase and to reduce catastrophic risk for the company and the client. The ATP automatically rebalances account value at a sub-account specific level according to a defined formula.

### ATP Basic Description

At contract issue and on subsequent contract monthly anniversaries (“monthiversaries”), the system will check to see if ATP signals rebalancing for each sub-account (fund) in the contract. If such a move is signaled, the entire sub-account allocation will be moved to a predetermined account (e.g, a Money Market account such as Oppenheimer Money Fund). Once the ATP signals a move back into the original sub-account, the percentage of account value in the Money Market account associated with the move out of the original sub-account is used to purchase units in the original sub-account.

In some embodiments, ATP is used for all contracts that purchase the Protective Income Manager rider. ATP will work in concert with AIC; contracts will be rebalanced no less frequently than annually in order to comply with AIC guidelines. Sub-accounts that have Accumulation Unit Values (AUVs) less than their 12 month Simple Moving Average will be restricted for new investment or transfers. If funds have been moved to the Money Market account, clients can elect to transfer into sub-accounts that are not restricted. This will be done by changing the allocation on the contract and performing a one-time portfolio rebalance.

### ATP SMA₁₂ Formula

In some embodiments, the ATP will use a 12-month Simple Moving Average to test rebalancing. This 12 month average (SMA₁₂) is the arithmetic average of the twelve most recent AUVs (on each monthiversary) for a given sub-account. The average does include the AUV on the monthiversary on which the allocation decision is being made.

For calculations on the 29th through 31st of a given month, the monthiversary dates for the previous year may not be a valid date. In these cases, the last day of the monthiversary month would be used for calculations.

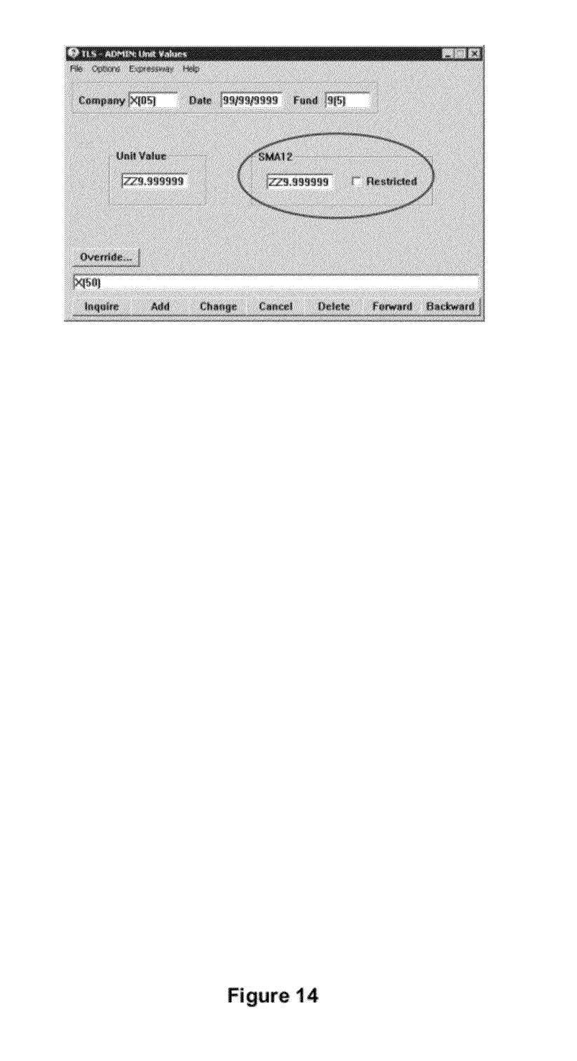

The system will perform the calculations for the SMA₁₂ values in order to make the determination of whether or not money needs to be transferred to/from sub-accounts on contract monthiversary. Instead of potentially making the same calculation in individual sub-accounts numerous times within the same processing cycle, in some embodiments a separate program may be provided that will run in the batch cycle prior to batch processing of all transactions. This program will systematically go through all the available funds and perform the necessary calculations. The values will be stored in a new field added to the Unit Value Table. Care will also need to be taken to perform the calculations for date gaps. In other words, on the business day following a weekend and/or holiday, the calculations should be performed for all days that were skipped over the weekend and/or holiday. In addition, a field will be added to the Unit Value file to indicate whether a fund is restricted because its current AUV is below the SMA₁₂ value. This will provide a historical account of when each fund was and was not restricted. Both of the new fields will be added to the Unit Value Screen (FIG. 14).

In some embodiments, the criterion for the restricting/unrestricting of a sub-account is as follows:
If SMA₁₂≦AUVₜ, then the fund is unrestricted
If SMA₁₂>AUVₜ, then the fund is restricted
   where AUVₜ is the Accumulation Unit Value on the given effective date.

As new funds are added to the Protective portfolio, and thus to the system, unit values for the charge levels included in the Asset Transfer Program should be calculated for at least one year prior to the launch date based on historical Net Asset Values (NAV). These unit values will then need to be loaded into the Unit Value table in order to be available for the SMA₁₂ calculations. If at any point during SMA₁₂ calculations all 12 monthly values are not available for averaging, the fund will not be restricted.

In the event of a pricing error, which may occur from time to time for various reasons, the SMA₁₂ values should be recalculated once the error has been corrected. However, contracts do not have to be reevaluated if they had a monthiversary during the pricing error. In the normal course of processing, if a policy monthiversary gets reprocessed, then it will fix itself with regard to the pricing error. A program will be provided that can be run in production by a Business Analyst in order to recalculate a single day's SMA₁₂ values.

As part of the system Utilities, there is an option to allow Unit Values to be projected forward to a given entered date. This is used in testing to allow contracts to be processed forward. This utility will be modified to include the SMA₁₂ calculations.

### SMA₁₂ Extract to Web

Each business day, as part of the nightly processing cycle, an extract will be created with the SMA₁₂ values. This extract will then be utilized to populate a web site with the information so that customers will be able to tell which funds have been restricted and which funds are unrestricted. Exact layout of the extract is subject to design preference, but the following information is preferably included:
Product Name
Fund Name
Effective Date
Unit Value
SMA₁₂ Value
Restricted Indicator

### Order of Operations

In some embodiments, the order of operations for the Asset Transfer Program is:
1. Premium (allocate as requested)
2. DCA (allocate as requested)
3. Rebalance (if a rebalancing month, meet AIC guidelines)
4. Apply ATP (transfer from restricted sub-accounts/transfer to unrestricted sub-accounts)

Transaction processing order on system, in some embodiments, is as follows (priority number listed in parenthesis after each transaction):
1. PA (110)/PI (120)
2. DA (208)
3. XF (210)
4. PR (485)

The PA (payment) transaction is a premium payment. A PA transaction may be used to indicate a premium payment that is part of the initial paperwork. The first piece of money received on all contracts is preferably a PA transaction code. In some embodiments, for 1035 exchange/rollover/transfer type policies, additional pieces of money considered part of the initial paperwork are put on as PA transactions.

The PI (pour in) transaction is an additional premium payment added to the contract that is not considered part of the initial paperwork. Different transaction codes (PA/PI) are used on the system so that certain values can be correctly calculated. For example, PA transactions (except PA/PAC) are included in the calculation for the penalty free amount on a contract because they are considered “initial premium.” Regular additional payments that are entered as PI transactions are not included in the penalty free amount calculation.

The DA transaction is to move money from the Dollar Cost Averaging account (e.g., a fixed rate account from which money can be allocated to the variable sub-accounts over a six or twelve month period). This code moves the money from the DCA account to the allocated funds.

The XF (transfer) transaction is the transfer of money from one fund to another. A transfer can be specified, for example, by dollar amount or as a percent.

The PR (portfolio rebalancing) transaction is the last transaction to process on the system. In order to have the ATP process after portfolio rebalancing, two new entries should be made in the Transaction Priority Table in the system. A memo code should be utilized along with the XF transaction and the new combinations given a higher priority number than the PR transaction. One option would be XF/ATPU with a priority of 490, and XF/ATPR with a priority of 491. This will allow the base system code for the XF transaction to be utilized with little modification, yet allow the transaction to process in the required order for the program.

In preferred embodiments, there are two memo codes so that the money for funds that have become unrestricted on monthiversary can be moved out of the Money Market account separately from the money from restricted funds being added to the Money Market account. The ATPU memo code will be used on transfers from the Money Market back to the unrestricted funds. The ATPR memo code will be used when transferring money out of restricted funds to the Money Market account. The distinct memo codes will make it easier to determine at a transaction level which type of transfer the transaction represents, without having to go deeper into the fund level to make the determination. This will be helpful for both Admin and processing within the system.

The new XF/ATPU and XF/ATPR transactions will be “smart” transactions. Before processing, either as natural or reapply transactions, they will determine what funds need to be transferred to or from the Money Market account, as appropriate. If no funds need to be transferred and the XF is a natural transaction, it will flush from the system without an error. If no funds need to be transferred and the transaction is a reapply, a $0 transaction will be added to Financial History to place mark that the transaction attempted to reapply but there were no funds with money to be moved.

In some embodiments, two separate processes may be used for rebalancing money into/out of the Money Market account based on fund restrictions:
1. Daily processing—if money is put into a restricted fund via one of the following transactions on a date other than the month anniversary, the money should be immediately moved to the Money Market account
   a. PA or PI
   b. AU (including AU/DTH)
   c. XF (should not occur due to AIC restrictions)
   d. PR
   e. DA
2. Monthiversary processing—a new MV transaction will be utilized on contracts with ATP. This transaction will serve as a placeholder to store the monthiversary value as well as creating necessary XF transactions as follows:
   a. Create the XF/ATPU to move money from the Money Market account back to unrestricted funds.
   b. Create the XF/ATPR to move money from restricted funds to the Money Market account.

AU (adjust up) is a transaction that adds contract value to a policy. In some embodiments, when the death benefit value due at the time of death is greater than the actual contract value on the policy, an AU/DTH transaction is processed to add the required additional value to the policy. The AU/DTH transaction adjusts the contract value to equal the death benefit value that is due on the contract.

An ATP Processing code module handles the processing associated with the ATP program. This will allow all logic for making the determination of whether to move money into/out of funds to be in one location. Not only does this make it easier to maintain, it allows all processes to utilize the same logic without having to code it in multiple places across the system.

Daily Processing:

During Daily processing, the code modules that process transactions that apply money to an account should call the new ATP Processing code module. The ATP Processing module will then determine if an XF/ATPR with a transaction date equal to the newly processed transaction exists. If it does, the ATP Processing module passes control back to the calling program. If it does not, then an XF/ATPR transaction is created with an effective date equal to the effective date of the transaction that just processed and then pass control back to the calling program.

Monthiversary Processing:

With the addition of SecurePay FX and ATP, a new transaction is needed as a placeholder on each contract monthiversary. This transaction will be given a code of MV. The transaction will store the contract value on the monthiversary as well as act as a trigger for monthiversary ATP processing, both in the normal course of processing for the contract and in the event that something is backdated across a monthiversary.

This MV transaction will be a recurring scheduled transaction and will be stored on Scheduled Activities. The first transaction will automatically be scheduled when a policy with a rider requiring ATP is issued, or when such a rider is added under RightTime®. Reinstatement of a rider requiring ATP will automatically cause the MV transaction to be scheduled and “catch up” any missed transactions.

The MV transaction should process after all other transactions, especially the apply transactions, yet before the new XF/ATPU and XF/ATPR transactions, since the MV will be adding these transactions to Transaction Maintenance. This may be accomplished, for example, by adding the MV transaction to the Transaction Priority Table in the system with a priority of 488.

In some embodiments, the MV transaction will not appear on confirms or on the quarterly statements.

### ATP Transfers

The new “smart” XF transaction will determine if there is money to be moved into or out of the Money Market account. Especially on contract monthiversary, this should be a very carefully coordinated event to ensure that the proper amount of money is moved.

XF/ATPU—Transferring Money Back to Unrestricted Funds:

In some embodiments, the XF/ATPU transaction will process on contract monthiversary as this is the only time money is evaluated and moved out of previously restricted funds. It is important to remember that on contract monthiversary, this transaction will process prior to the XF/ATPR to move money out of the SMA₁₂ restricted funds. When this transaction processes, the following should occur:
For each fund that has an allocation on the contract
   Item A—Determine which funds were restricted on the previous monthiversary that are no longer restricted on the current monthiversary. If the number is zero, then there is nothing for the transaction to do. Flush if a natural transaction, or save as a $0 place holder if a reapply transaction. Otherwise, continue processing.
   Item B—Determine if the Money Market account has an allocation percent
   Note: Funds that were restricted on the previous monthiversary that continue to be restricted on the current monthiversary are left alone. The money will remain in the Money Market account
   Note: Funds that were unrestricted on the previous monthiversary that are now restricted are specifically excluded from these calculations since the money has not yet been moved to the Money Market account
For each fund in Item A—determine the allocation percent
Item C—Sum all of the Item A allocation percentages and then add in Item B (Money Market allocation)
For each fund in Item A
   Calculate the amount of money to move from the Money Market back to the fund (Item A allocation percent/Item C total allocation percent)
   Add the fund to the XF/ATPU transaction as a “to” fund with the calculated dollar amount
   Add the dollar amount to the total amount to be removed from the Money Market account
Add the Money Market account with the total dollars to be removed to the XF/ATPU transaction.
Process the XF/ATPU transaction as normal XF would process

XF/ATPR—Transferring Money Out of Restricted Funds:

The XF/ATPR could potentially be processed on any given day of the contract year. The processing for this transaction is much easier than the XF/ATPU. Each allocated fund should be checked to see if the fund is SMA₁₂ restricted on the most recent monthiversary effective date (or Rider Effective Date if no monthiversary transaction has processed yet). If the fund is restricted, 100% of the money in the fund should be transferred to the Money Market Account.

As the XF/ATPR transaction processes, if there are no restricted funds, then there is nothing for the transaction to do. The transaction should be flushed with no error or warning message if it is a natural transaction. If the transaction is a reapply transaction, then it should be saved to Financial History as a $0 place holder.

### ATP Termination

If a rider that requires the Asset Transfer Program is terminated, the ATP requirement for the contract is also terminated at the same time. Any money in the Money Market account due to funds restricted under ATP will be left as is on the contract. If the client has not requested that portfolio rebalancing be terminated as well, then the contract will “straighten itself out” at the next rebalance date. If the client has requested to cancel portfolio rebalancing, then the money will not be transferred until the client specifically requests the money to be moved.

When ATP is terminated, the associated MV transaction will automatically be deleted from the Scheduled Activities file.

### System Screen Modifications for ATP

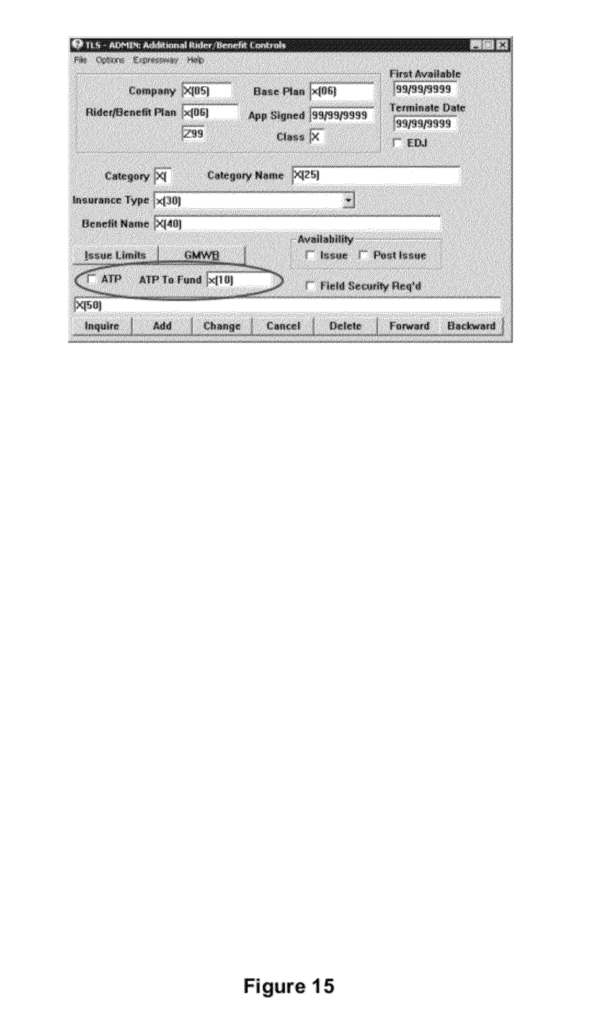

In embodiments where ATP is tied to a specific rider, such as GMWB or PIM, the easiest way to indicate a policy is a participant in the ATP program will be to add a series of checkboxes to the system. The first will be added to the Additional Rider/Benefit Controls Screen (see FIG. 15) in order to indicate if a particular rider or benefit requires participation in the program. In addition, a new field will be added (ATP To Fund) to list the destination fund of ATP money. This is referred to as the “Money Market account” throughout this entire specification. The Fund Short Name will be listed in this box so that if there are multiple charge levels tied to a single Additional Rider/Benefit Control record, the same Fund Short Name will point to the different fund numbers across charge levels. In some embodiments, the ATP To Fund will be the Oppenheimer Money Fund, which has a Fund Short Name of OP MONEY.

The second checkbox will be added to the policy on the Policy Master screen (see FIG. 11) and will be automatically populated if a benefit that requires ATP is added to the contract. This checkbox will not only serve as a visual reminder to Admin personnel, but will also be an indicator at the policy level for ease of use during any and all contract processing.

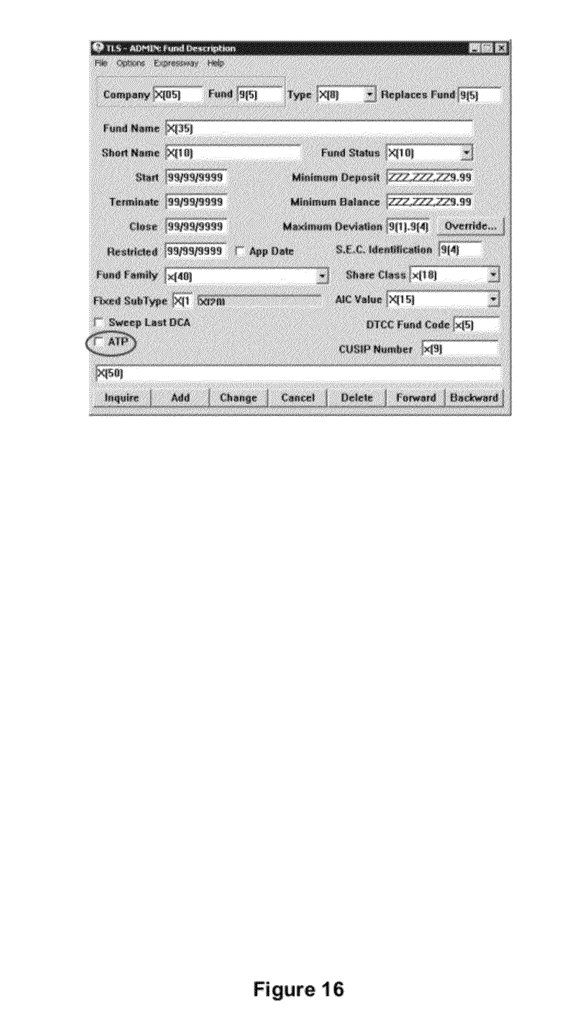

A third checkbox will be added to the Fund Description Screen (see FIG. 16) in order to indicate whether individual sub-accounts are included in the Asset Transfer Program. This indicator will be used in determining which sub-accounts require calculation of the SMA₁₂ value on a daily basis.

Exemplary products and their associated funds included in the program are listed in Table 5.

TABLE 5
ATP Funds

| Com- | | Funds | |
|---|---|---|---|
| pany | Product Name | Included | Funds NOT Included |
| AFAL | ProtectiveRewards | 00681-00688 | 00110—Fixed Acct |
| | Elite NY | 57010-57087 | 00111—DCA 1 |
| | | | 00112—DCA 2 |
| | | | 00656—Money Market |
| | | | 00981—Reinstatement |
| | | | Any AIC Category 1 |
| | | | funds |
| AFNB | ProtectiveRewards | 65010-65087 | 00110—Fixed Acct |
| | II NY | | 00111—DCA 1 |
| | | | 00112—DCA 2 |
| | | | 00981—Reinstatement |
| | | | 65006—Money Market |
| | | | Any AIC Category 1 |
| | | | funds |
| | | | Any other variable fund |
| | | | series for older charge |
| | | | levels |
| AFNX | ProtectiveAccess | 00081-00088 | 00056—Money Market |
| | XL NY | 59010-59087 | 00111—DCA 1 |
| | | | 00112—DCA 2 |
| | | | 00981—Reinstatement |
| | | | Any AIC Category 1 |
| | | | funds |
| | | | Any other variable fund |
| | | | series for older charge |
| | | | levels |
| PLAX | ProtectiveAccess | 00081-00088 | 00056—Money Market |
| | XL | 59010-59087 | 00111—DCA 1 |
| | | | 00112—DCA 2 |
| | | | 00981—Reinstatement |
| | | | Any AIC Category 1 |
| | | | funds |
| | | | Any other variable fund |
| | | | series for older charge |
| | | | levels |
| PLLS | ProtectiveRewards | 00681-00688 | 00110—Fixed Acct |
| | Elite | 57010-57087 | 00111—DCA 1 |
| | | | 00112—DCA 2 |
| | | | 00656—Money Market |
| | | | 00981—Reinstatement |
| | | | Any AIC Category 1 |
| | | | funds |
| PLPR | ProtectiveRewards | 65010-65087 | 00110—Fixed Acct |
| | II | | 00111—DCA 1 |
| | | | 00112—DCA 2 |
| | | | 00981—Reinstatement |
| | | | 65006—Money Market |
| | | | Any AIC Category 1 |
| | | | funds |
| | | | Any other variable fund |
| | | | series for older charge |
| | | | levels |

### AIC Checker Screen

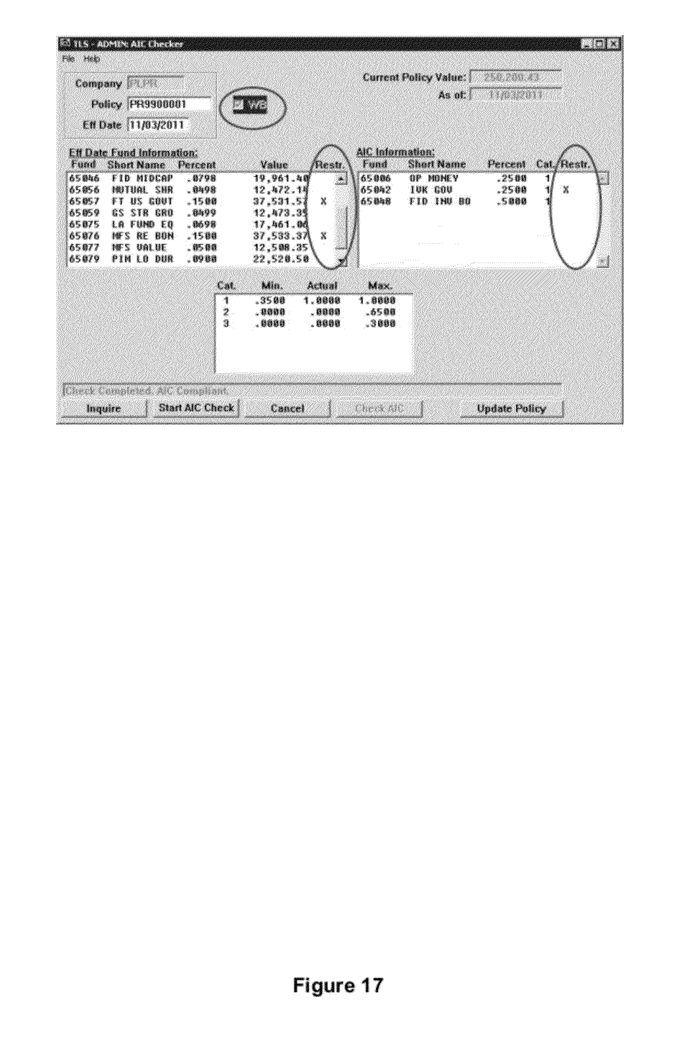

The AIC Checker allows Admin personnel to check whether a client requested allocation is AIC compliant. In order to help with the ATP restrictions, new fields will be added to the AIC Checker. If the rider on the policy requires ATP, then when the AIC Checker is run, any funds that are restricted as of the last contract monthiversary will be designated with an ‘X’ in the Restr. columns, under both Eff Date Fund Information and AIC Information. An example of this can be seen in FIG. 17.

### Correspondence

All automatic transfers into and out of the Money Market account are preferably communicated to the client. Since the transaction code that moves the money on the system will have unique memo codes, these transactions can be uniquely identified on all existing correspondence. The interfaces for the following correspondence types are preferably modified to generate a transaction description unique to the ATP transfers (which will be denoted by XF/ATPU and XF/ATPR on the system):
Confirmations
Quarterly Statements

### Summary of Table Changes

Various table changes may be made for the different pieces of PIM and/or ATP, as summarized below.

For example, the Fund Description Table may be updated to add a new ATP checkbox and initialize for all existing funds.

The Insurance Rates Table should be updated with two new entries for each company code that is adding the PIM rider. The details of the two entries can be seen in Table 3.

The Interest/Other Rates table may be modified to include several new entries for each active product, as summarized in Table 6.

TABLE 6
Interest/Other Rates Table, New Entries

| | | | | Process | | | |
|---|---|---|---|---|---|---|---|
| | | | | Effective | Guarantee | Guarantee | |
| Company | Type | Index | Qualifier | Date | Type | Period | Rate |
| AFAL | Declared/MVA | PIMISA | 999 | | Policy Year | 000 | 0.000837 |
| | Floor/DCI | | | | | | |
| | Declared/MVA | PIMRTA | | | Policy Year | 000 | 0.000921 |
| | Floor/DCI | | | | | | |
| AFNB | Declared/MVA | PIMISA | 999 | | Policy Year | 000 | 0.000837 |
| | Floor/DCI | | | | | | |
| | Declared/MVA | PIMRTA | | | Policy Year | 000 | 0.000921 |
| | Floor/DCI | | | | | | |
| AFNX | Declared/MVA | PIMISA | 999 | | Policy Year | 000 | 0.000837 |
| | Floor/DCI | | | | | | |
| | Declared/MVA | PIMRTA | | | Policy Year | 000 | 0.000921 |
| | Floor/DCI | | | | | | |
| PLAX | Declared/MVA | PIMISA | 999 | | Policy Year | 000 | 0.000837 |
| | Floor/DCI | | | | | | |
| | Declared/MVA | PIMRTA | | | Policy Year | 000 | 0.000921 |
| | Floor/DCI | | | | | | |
| PLLS | Declared/MVA | PIMISA | 999 | | Policy Year | 000 | 0.000837 |
| | Floor/DCI | | | | | | |
| | Declared/MVA | PIMRTA | | | Policy Year | 000 | 0.000921 |
| | Floor/DCI | | | | | | |
| PLPR | Declared/MVA | PIMISA | 999 | | Policy Year | 000 | 0.000837 |
| | Floor/DCI | | | | | | |
| | Declared/MVA | PIMRTA | | | Policy Year | 000 | 0.000921 |
| | Floor/DCI | | | | | | |

The Additional Rider/Benefit Controls Table may be updated as follows:
Add new ATP checkbox and ATP To Fund field and initialize for all existing riders
Add new Max Years field and initialize for all existing riders
Add new entries for the PIM rider

The details associated with the new plans are detailed in Table 1 and Table 7. Any information not specifically detailed for the PIM rider should be assumed to be the default value of zeros or spaces. All new riders added should have the ATP checkbox selected and the ATP To Fund set to OP MONEY.

TABLE 7
Additional Rider/Benefit Controls Table, Plan Details

| | | |
|---|---|---|
| Company | Effective | Rider/Benefit Plans |

| | | | | |
|---|---|---|---|---|
| Code | Base Plan | Date | Code | Details |

| | | | |
|---|---|---|---|
| AFAL | VA2N00 | PIMISA | Add |
| | VA2Q00 | PIMRTA | Add |
| | VA2QT0 | PIMSCA | Add |
| | VA2RCI | | |
| | VA2RCT | | |
| | VA2RCV | | |
| AFNB | VA2N00 | PIMISA | Add |
| | VA2Q00 | PIMRTA | Add |
| | VA2QT0 | PIMSCA | Add |
| | VA2RCI | | |
| | VA2RCT | | |
| | VA2RCV | | |
| AFNX | VEAN00 | PIMISA | Add |
| | VEAQ00 | PIMRTA | Add |
| | VEAQT0 | PIMSCA | Add |
| | VEARCI | | |
| | VEARCT | | |
| | VEARCV | | |
| PLAX | VEAN00 | PIMISA | Add |
| | VEAQ00 | PIMRTA | Add |
| | VEAQT0 | PIMSCA | Add |
| | VEARCI | | |
| | VEARCT | | |
| | VEARCV | | |
| PLLS | VA2N00 | PIMISA | Add |
| | VA2Q00 | PIMRTA | Add |
| | VA2QT0 | PIMSCA | Add |
| | VA2RCI | | |
| | VA2RCT | | |
| | VA2RCV | | |
| PLPR | VA2N00 | PIMISA | Add |
| | VA2Q00 | PIMRTA | Add |
| | VA2QT0 | PIMSCA | Add |
| | VA2RCI | | |
| | VA2RCT | | |
| | VA2RCV | | |

For the Transaction Process Table, Table 8 shows the transactions that are preferably added and the existing transaction from which they should be cloned in order to have the correct accounting settings.

TABLE 8
Transaction Process Table, New Entries

| Company | New Transaction | Clone From |
|---|---|---|
| AFAL | PC/PIM | PC/GMWB |
| | WD/PIM | WD/GMWB |
| | WD/PPIM | WD/PWBL |
| | WD/PNIM | WD/PNBL |
| | MV | RE |
| | RP | RE |
| AFNB | PC/PIM | PC/GMWB |
| | WD/PIM | WD/GMWB |
| | WD/PPIM | WD/PWBL |
| | WD/PNIM | WD/PNBL |
| | MV | RE |
| | RP | RE |
| AFNX | PC/PIM | PC/GMWB |
| | WD/PIM | WD/GMWB |
| | WD/PPIM | WD/PWBL |
| | WD/PNIM | WD/PNBL |
| | MV | RE |
| | RP | RE |
| PLAX | PC/PIM | PC/GMWB |
| | WD/PIM | WD/GMWB |
| | WD/PPIM | WD/PWBL |
| | WD/PNIM | WD/PNBL |
| | MV | RE |
| | RP | RE |
| PLLS | PC/PIM | PC/GMWB |
| | WD/PIM | WD/GMWB |
| | WD/PPIM | WD/PWBL |
| | WD/PNIM | WD/PNBL |
| | MV | RE |
| | RP | RE |
| PLPR | PC/PIM | PC/GMWB |
| | WD/PIM | WD/GMWB |
| | WD/PPIM | WD/PWBL |
| | WD/PNIM | WD/PNBL |
| | MV | RE |
| | RP | RE |

In some embodiments, the new XF/ATPR and XF/ATPU transactions do not need entries in the Transaction Process table. They will utilize the generic XF/**** entry.

### UVT

The annuity administration system Unit Value table will have two fields added as part of the ATP project. The UVT System writes directly to the Unit Value table, and testing should be performed to ensure that the new fields are properly initialized on the records inserted/updated by UVT. If they are not, changes should be made on the UVT System to initialize the fields.

The detailed description herein may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the instructions and/or operations performed may be referred to in terms, such as generating, determining, adding and/or comparing. The instructions and/or operations described herein which form part of the present invention are machine operations. Useful machines for performing the operation of the present invention include general purpose digital computers or similar devices that have been programmed to perform these specialized operations.

The present invention also relates to apparatus for performing these operations. This apparatus may be specially constructed for the required purpose or it may comprise a general purpose computer as selectively activated or reconfigured by a computer program stored in the computer. Various general purpose machines may be used with programs written in accordance with the teachings herein providing a specialized machine thereby, or it may prove more convenient to construct more specialized apparatus to perform the required method steps. The required structure for a variety of these machines will appear from the description given.

Conventional processing system architecture is more fully discussed in Computer Organization and Architecture, by William Stallings, MacMillan Publishing Co. (3rd ed. 1993); conventional processing system network design is more fully discussed in Data Network Design, by Darren L. Spohn, McGraw-Hill, Inc. (1993), and conventional data communications is more fully discussed in Data Communications Principles, by R. D. Gitlin, J. F. Hayes and S. B. Weinstain, Plenum Press (1992) and in The Irwin Handbook of Telecommunications, by James Harry Green, Irwin Professional Publishing (2nd ed. 1992). Each of the foregoing publications is incorporated herein by reference.

Alternatively, the hardware configuration may be arranged according to the multiple instruction multiple data (MIMD) multiprocessor format for additional computing efficiency. The details of this form of computer architecture are disclosed in greater detail in, for example, U.S. Pat. No. 5,163,131; Boxer, A., Where Buses Cannot Go, IEEE Spectrum, February 1995, pp. 41-45; and Barroso, L. A. et al., RPM: A Rapid Prototyping Engine for Multiprocessor Systems, IEEE Computer February 1995, pp. 26-34, all of which are incorporated herein by reference.

In alternate preferred embodiments, the processor or microprocessing circuit may be replaced by or combined with any other suitable processing circuits, including programmable logic devices, such as PALs (programmable array logic) and PLAs (programmable logic arrays), DSPs (digital signal processors), FPGAs (field programmable gate arrays), ASICs (application specific integrated circuits), VLSIs (very large scale integrated circuits) or the like.

The system according to the invention may include a general purpose computer programmed in a particular manner, or a specially programmed special purpose computer. The user, may interact with the system, for example, via a personal computer, wireless device, PDA, etc. Either of these may be implemented as a distributed computer system rather than a single computer. Similarly, the communications link may be a dedicated link, a modem over a POTS line, the Internet, an Intranet and/or any other method of communicating between computers and/or users. Moreover, the processing could be controlled by a software program on one or more computer systems or processors, or could even be partially or wholly implemented in hardware.

Although a single computer may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, laptop/notebook, mini, mainframe and super computers, wireless smart devices, as well as processing system network combinations of the same. Further, portions of the system may be provided in any appropriate electronic format, including, for example, provided over a communication line as electronic signals, provided on CD and/or DVD, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an object oriented and/or interpretive environment such as Java and transported to multiple destinations to various users.

It is to be understood that the invention is not limited in its application to the details of construction and to the arrangements of the components set forth in the description above or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. In alternative embodiments, one or more process steps may be implemented by a user assisted process and/or manually. Other alterations or modifications of the above processes are also contemplated. For example, further insubstantial approximations of the process and/or algorithms are also considered within the scope of the processes described herein.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

### EXAMPLES

### Example 1

### Protective Income Manager Rider

This example demonstrates the operation of the Protective Income Manager Rider according to some embodiments. The example is based on hypothetical Contract Values and transactions and assumes hypothetical positive and negative investment performance of the Separate Account. The example is not representative of past or future performance and is not intended to project or predict performance. There is, of course, no assurance that the Separate Account will experience positive investment performance. The example does not reflect the deduction of fees and charges.

Conditions of the example are as follows:
Joe, 75 years old on the Rider Effective Date
Purchased the Protective Income Manager Rider at the time of Contract purchase
Elected Single Life Coverage
Began making Protective Income Manager Withdrawals immediately

TABLE 9

| | | | Hypothetical | Protective | Contract | | | | Hypothetical | |
|---|---|---|---|---|---|---|---|---|---|---|
| | | | Contract | Income | Value | | | | Contract | |
| | | | Value | Manager | times | Optimal | Total | | Value | Protected |
| | Attained | Purchase | (Beginning | Payment | Payment | Withdrawal | Withdrawal | Excess | (End of | Lifetime |
| Contract Year | Age | Payments | of Year) | Factor | Factor | Amount | Taken | Withdrawal | Year) | Payment^{(A)} |
| 1 | 75 | 100,000 | 100,000^{(B)} | 0.06661 | 6,661 | 6,661 | 6,661 | — | 95,684 | 6,661 |
| 2 | 76 | — | 95,684 | 0.06912 | 6,614 | 6,661^{(C)} | 6,661 | — | 92,517 | 6,661 |
| 3 | 77 | — | 92,517 | 0.07192 | 6,654 | 6,661 | 6,661 | — | 98,541 | 6,661 |
| 4 | 78 | — | 98,541 | 0.07505 | 7,396 | 7,327^{(D)} | 7,327 | — | 91,009 | 6,661 |
| 5 | 79 | 25,000 | 116,009 | 0.07859 | 9,117 | 8,060 | 8,060 | — | 103,677 | 6,661 |
| 6 | 80 | — | 103,677 | 0.08260 | 8,564 | 8,564 | 40,000 | 31,436^{(E)} | 56,987 | 6,661 |
| 7 | 81 | — | 56,987 | 0.08570 | 4,884 | 4,884^{(F)} | 4,884 | — | 50,637 | 4,884^{(G)} |
| 8 | 82 | — | 50,637 | 0.09104 | 4,610 | 4,884 | 4,884 | — | 51,573 | 4,884 |
| 9 | 83 | — | 51,573 | 0.09729 | 5,018 | 5,018^{(H)} | 5,018 | — | 46,185 | 4,884 |
| 10 | 84 | — | 46,185 | 0.10469 | 4,835 | 4,884 | 4,884 | — | 38,156 | 4,884 |

^{(A)}Protected Lifetime Payments are available if the rider is in effect on the Maximum Annuity Commencement Date, and equal the lesser of (a) your initial Optimal Withdrawal Amount; or (b) your Optimal Withdrawal Amount as of a Reset Date.
^{(B)}The initial Contract Value is equal to the initial Purchase Payment of $100,000.
^{(C)}We recalculate the Optimal Withdrawal Amount by multiplying the Payment Factor (0.06912) by the Contract Value ($95,684), which equals $6,614. However, this amount is lower than our guarantee that, so long as there has not been an Excess Withdrawal, the Optimal Withdrawal Amount will always be at least the greater of 90% of the prior Optimal Withdrawal Amount (90% × $6,661 = $5,994) or the initial Optimal Withdrawal Amount ($6,661). Therefore, the recalculated Optimal Withdrawal Amount is equal to $6,661.
^{(D)}Although the Payment Factor (0.07505) times the Contract Value ($98,541) equals $7,396, the Optimal Withdrawal Amount is $7,327 since the Optimal Withdrawal Amount cannot be higher than 110% of the prior Optimal Withdrawal Amount ($6,661 × 1.10 = $7,327).
^{(E)}An Excess Withdrawal occurs when total withdrawals taken during the Contract Year exceed the Optimal Withdrawal Amount.
^{(F)}On the next Contract Anniversary following an Excess Withdrawal (the “Reset Date”), we reset the “floor” for future Optimal Withdrawal Amounts to equal the lesser of the initial Optimal Withdrawal Amount or the Optimal Withdrawal Amount as of the Reset Date. We will also use a new Protective Income Manager Payment Factor determined solely by the age of the (younger) Covered Person (for riders purchased before a specified date, determined by the current number of years remaining until the Maximum Annuity Commencement Date and the age of the (younger) Covered Person) on the Reset Date (provided you have not declined an increase in the Protective Income Manager fee). This will result in a lower Protective Income Manager Payment Factor. In this example, the factor that would have applied in the absence of a Reset (0.08721) is replaced by a new Payment Factor (0.08570) as Joe is now 81 years old. This means the new Optimal Withdrawal Amount is equal to $4,884, which is the Contract Value ($56,987) times the Payment Factor (0.08570). Optimal Withdrawal Amount calculation floors do not apply at Reset Dates.
^{(G)}This Contract Anniversary is a Reset Date due to the Excess Withdrawal during the prior Contract Year. If the Optimal Withdrawal Amount on a Reset Date is lower than the initial Optimal Withdrawal Amount, then the Protected Lifetime Payment is reduced to equal that year's Optimal Withdrawal Amount.
^{(H)}The Optimal Withdrawal Amount is equal to $51,573 (Contract Value) times 0.09729 (Payment Factor) = $5,018.

### Example 2

### Allocation Adjustment

This example demonstrates the operation of the Allocation Adjustment. In some embodiments, all Owners who purchase the Protective Income Manager rider must participate in the Allocation Adjustment. The example is based on hypothetical Contract Values and transactions and assumes hypothetical positive and negative investment performance of the Separate Account. The example is not representative of past or future performance and is not intended to project or predict performance. There is, of course, no assurance that the Separate Account will experience positive investment performance.

TABLE 10

| | | | | | Hypothetical |
|---|---|---|---|---|---|
| | | | | Hypothetical | Contract |
| | | | | Contract | Value in |
| Contract | Accumulation | | Is Sub-Account 1 | Value in | Money Fund |
| Month | Unit Value | SMA12^{(A)} | Restricted?^{(B)} | Sub-Account 1^{(C)} | Sub-Account^{(D)} |
| At issue | 6.17 | 6.16 | | 10,000 | |
| 1 | 6.24 | 6.17 | No^{(E)} | 10,089 | |
| 2 | 5.76 | 6.14 | Yes | — | 9,282^{(F)} |
| 3 | 5.41 | 6.09 | Yes | | 9,286 |
| 4 | 5.35 | 6.03 | Yes | | 9,290 |
| 5 | 4.53 | 5.87 | Yes | | 9,294 |
| 6 | 3.73 | 5.62 | Yes | | 9,298 |
| 7 | 2.94 | 5.33 | Yes | | 9,302 |
| 8 | 3.33 | 5.08 | Yes | | 9,305 |
| 9 | 3.15 | 4.85 | Yes | | 9,309 |
| 10 | 2.98 | 4.62 | Yes | | 9,313 |
| 11 | 3.29 | 4.41 | Yes | | 9,317 |
| 12 | 3.81 | 4.21 | Yes | | 9,321 |
| 13 | 4.19 | 4.04^{(G)} | No^{(H)} | 9,325 | |

^{(A)}SMA12 is the sum of the 12 most recent Monthly Anniversary Days Accumulation Unit values divided by 12.
^{(B)}Once we calculate a Sub-Account's SMA on a Monthly Anniversary Day, we then compare that SMA to the Sub-Account's current Accumulation Unit value on that Monthly Anniversary Day. If the Sub-Account's current Accumulation Unit value is equal to or less than the Sub-Account's SMA over the most recent 12 Monthly Anniversary Days, then we will consider the Sub-Account to be restricted.
^{(C)}$10,000 of the initial Purchase Payment is allocated to the hypothetical Sub-Account 1.
^{(D)}If a Sub-Account becomes restricted, as described in (B), we transfer the Contract Value in that Sub-Account to the Money Fund Sub-Account, until the Sub-Account is no longer restricted.
^{(E)}At the end of contract month 1, the Accumulation Unit value of Sub-Account 1 (6.24) is greater than SMA12 (6.17). Therefore, Sub-Account 1 is not restricted.
^{(F)}At the end of contract month 2, the Accumulation Unit value of Sub-Account 1 (5.76) is less than or equal to SMA12 (6.14). Therefore, Sub-Account 1 is restricted and the entire allocation in Sub-Account 1 ($9,282) is transferred to the Money Sub-Account.
^{(G)}Calculation of SMA12 (4.19 + 3.81 + 3.29 + 2.98 + 3.15 + 3.33 + 2.94 + 3.73 + 4.53 + 5.35 + 5.41 + 5.76)/12 = 4.04.
^{(H)}At the end of contract month 13, the Accumulation Unit value of Sub-Account 1 (4.19) is greater than SMA12 (4.04). Therefore, Sub-Account 1 is no longer restricted and the entire allocation in the Money Fund Sub-Account is re-allocated back to Sub-Account 1.

### Example 3

### Joint Life Coverage

This example demonstrate the operations of the Protective Income Manager Rider (with Payment Factor calculated per Equation 5) under various Separate Account performance scenarios when there is joint life coverage and a significant age difference exists between the two Covered Persons. The examples are based on hypothetical Contract Values and transactions. The examples are not representative of past or future performance and are not intended to project or predict performance. There is, of course, no assurance that the Separate Account will experience positive investment performance. The examples reflect the deduction of fees and charges. See Example 1 for a detailed example of the operation of the Protective Income Manager Rider.

### Example 3A

### Negative Separate Account Performance

Conditions:
Covered Person #1, Joe, 60 years old on the Rider Effective Date
Covered Person #2, Sally, 80 years old on the Rider Effective Date
Purchased the Protective Income Manager Rider at the time of Contract purchase and Payment Factor calculated per Equation 5
Elected Joint Life Coverage
Began making Protective Income Manager Withdrawals immediately equal to the annual Optimal Withdrawal Amount
Separate Account performance (before all fees and charges): −7% in all years

TABLE 11

| | End of | | | | | | | | | |
|---|---|---|---|---|---|---|---|---|---|---|
| | Year | | Beginning of | | Protecting | | End of | | | |
| | Oldest | | Year | | Income | Impact of | Year | Separate | Protected | |
| Contract | Attained | | Contract | Contract | Manager | Fund | Contract | Account | Lifetime | Annuity |
| Year | Age | Premium | Value | Charges | Withdrawal^{(A)} | Performance^{(B)} | Value^{(C)} | Performance | Payment | Payment |
| 1 | 81 | $100,000.00 | $100,000.00 | $2,071.86 | $4,830.76 | $(7,675.56) | $85,421.83 | −7.00% | | |
| 2 | 82 | $ — | $ 85,421.83 | $1,911.24 | $4,830.76 | $(6,524.48) | $72,155.36 | −7.00% | | |
| 3 | 83 | $ — | $ 72,155.36 | $1,765.06 | $4,830.76 | $(5,478.35) | $60,081.19 | −7.00% | | |
| 4 | 84 | $ — | $ 60,081.19 | $1,632.03 | $4,830.76 | $(4,526.25) | $49,092.15 | −7.00% | | |
| 5 | 85 | $ — | $ 49,092.15 | $1,510.95 | $4,830.76 | $(3,658.66) | $39,091.78 | −7.00% | | |
| 6 | 86 | $ — | $ 39,091.78 | $1,400.77 | $4,830.76 | $(2,869.92) | $29,990.33 | −7.00% | | |
| 7 | 87 | $ — | $ 29,990.33 | $1,300.49 | $4,830.76 | $(2,151.38) | $21,707.70 | −7.00% | | |
| 8 | 88 | $ — | $ 21,707.70 | $1,209.23 | $4,830.76 | $(1,498.30) | $14,169.41 | −7.00% | | |
| 9 | 89 | $ — | $ 14,169.41 | $1,126.17 | $4,830.76 | $ (903.51) | $ 7,308.98 | −7.00% | | |
| 10 | 90 | $ — | $ 7,308.98 | $1,050.58 | $4,830.76 | $ (362.25) | $ 1,065.39 | −7.00% | | |
| 11 | 91 | $ — | $ 1,065.39 | $ 249.03 | $4,830.76 | $ (11.23) | $ — | −7.00% | | |
| 12 | 92 | $ — | $ — | $ — | $4,830.76 | $ — | $ — | −7.00% | | |
| 13 | 93 | $ — | $ — | $ — | $4,830.76 | $ — | $ — | −7.00% | | |
| 14 | 94 | $ — | $ — | $ — | $4,830.76 | $ — | $ — | −7.00% | | |
| 15 | 95 | $ — | $ — | $ — | $4,830.76 | $ — | $ — | −7.00% | $4.830.76 | $0.00^{(D)} |

^{(A)}$4830.76 equals .0483076 (the Protective Income Manager Payment Factor in year one) × $100,000 (the initial Contract Value). The Protective Income Manager Payment Factor is based on the age of Joe (the younger Covered Person) on the Rider Effective Date, as well as his attained age on the date we calculate the Optimal Withdrawal Amount (which, in this example, is the full amount withdrawn each year).
^{(B)}The numbers in the Impact of Fund Performance column reflect the performance of the underlying funds and fund expenses.
^{(C)}The End of Year Contract Value is equal to the Beginning of Year Contract Value minus Contract Charges minus the PIM Withdrawal minus Fund Expenses.
^{(D)}On the Maximum Annuity Commencement Date, which is when Sally (the older Covered Person) reaches age 95, Sally and Joe must choose to receive annuity payments under their Contract or Protected Lifetime Payments under the rider. Because there is no Contract Value remaining to annuitize, Sally and Joe will receive Protected Lifetime Payments in an annual amount of $4,830.76 until they both die.

### Example 3B

### Flat Separate Account Performance

Conditions:
Covered Person #1, Joe, 60 years old on the Rider Effective Date
Covered Person #2, Sally, 80 years old on the Rider Effective Date
Purchased the Protective Income Manager Rider at the time of Contract purchase and Payment Factor calculated per Equation 5
Elected Joint Life Coverage
Began making Protective Income Manager Withdrawals immediately equal to the annual Optimal Withdrawal Amount
Separate Account performance (before all fees and charges): 0% in all years

TABLE 12

| | End of | | | | | | | | | |
|---|---|---|---|---|---|---|---|---|---|---|
| | Year | | Beginning of | | Protective | | End of | | | |
| | Oldest | | Year | | Income | Impact of | Year | Separate | Protected | |
| Contract | Attained | | Contract | Contract | Manager | Fund | Contract | Account | Lifetime | Annuity |
| Year | Age | Premium | Value | Charges | Withdrawal^{(A)} | Performance^{(B)} | Value^{(C)} | Performance | Payment | Payment |
| 1 | 81 | $100,000.00 | $100,000.00 | $2,108.18 | $4,830.76 | $(963.64) | $92,097.42 | 0.00% | | |
| 2 | 82 | $ — | $ 92,097.42 | $2,018.20 | $4,830.76 | $(885.39) | $84,363.08 | 0.00% | | |
| 3 | 83 | $ — | $ 84,363.08 | $1,930.12 | $4,830.76 | $(808.80) | $76,793.40 | 0.00% | | |
| 4 | 84 | $ — | $ 76,793.40 | $1,843.92 | $4,830.76 | $(733.85) | $69,384.87 | 0.00% | | |
| 5 | 85 | $ — | $ 69,384.87 | $1,759.56 | $4,830.76 | $(660.49) | $62,134.06 | 0.00% | | |
| 6 | 86 | $ — | $ 62,134.06 | $1,676.99 | $4,830.76 | $(588.69) | $55,037.62 | 0.00% | | |
| 7 | 87 | $ — | $ 55,037.62 | $1,596.18 | $4,830.76 | $(518.42) | $48,092.26 | 0.00% | | |
| 8 | 88 | $ — | $ 48,092.26 | $1,517.09 | $4,830.76 | $(449.65) | $41,294.77 | 0.00% | | |
| 9 | 89 | $ — | $ 41,294.77 | $1,439.69 | $4,830.76 | $(382.34) | $34,641.98 | 0.00% | | |
| 10 | 90 | $ — | $ 34,641.98 | $1,363.93 | $4,830.76 | $(316.46) | $28,130.83 | 0.00% | | |
| 11 | 91 | $ — | $ 28,130.83 | $1,289.79 | $4,830.76 | $(251.99) | $21,758.30 | 0.00% | | |
| 12 | 92 | $ — | $ 21,758.30 | $1,217.22 | $4,830.76 | $(188.89) | $15,521.44 | 0.00% | | |
| 13 | 93 | $ — | $ 15,521.44 | $1,146.20 | $4,830.76 | $(127.13) | $ 9,417.35 | 0.00% | | |
| 14 | 94 | $ — | $ 9,417.35 | $1,076.69 | $4,830.76 | $ (66.69) | $ 3,443.22 | 0.00% | | |
| 15 | 95 | $ — | $ 3,443.22 | $ 613.78 | $4,830.76 | $ (11.50) | $ — | 0.00% | $4,830.76 | $0.00^{(D)} |

^{(A)}$4830.76 equals .0483076 (the Protective Income Manager Payment Factor in year one) × $100,000 (the initial Contract Value). The Protective Income Manager Payment Factor is based on the age of Joe (the younger Covered Person) on the Rider Effective Date, as well as his attained age on the date we calculate the Optimal Withdrawal Amount (which, in this example, is the full amount withdrawn each year).
^{(B)}The numbers in the Impact of Fund Performance column reflect the performance of the underlying funds and fund expenses.
^{(C)}The End of Year Contract Value is equal to the Beginning of Year Contract Value minus Contract Charges minus the PIM Withdrawal minus Fund Expenses.
^{(D)}On the Maximum Annuity Commencement Date, which is when Sally (the older Covered Person) reaches age 95, Sally and Joe must choose to receive annuity payments under their Contract or Protected Lifetime Payments under the rider. Because there is no Contract Value remaining to annuitize, Sally and Joe will receive Protected Lifetime Payments in an annual amount of $4,830.76 until they both die.

### Example 3C

### Positive Separate Account Performance

Conditions:
Covered Person #1, Joe, 60 years old on the Rider Effective Date
Covered Person #2, Sally, 80 years old on the Rider Effective Date
Purchased the Protective Income Manager Rider at the time of Contract purchase and Payment Factor calculated per Equation 5
Elected Joint Life Coverage
Began making Protective Income Manager Withdrawals immediately equal to the annual Optimal Withdrawal Amount
Separate Account performance (before all fees and charges): 7% in all years

TABLE 13

| | End of Year | | Beginning of | | Protective | | End of | | | |
|---|---|---|---|---|---|---|---|---|---|---|
| Con- | Oldest | | Year | | Income | Impact of | Year | Separate | Protected | |
| tract | Attained | | Contract | Contract | Manager | Fund | Contract | Account | Lifetime | Annuity |
| Year | Age | Premium | Value | Charges | Withdrawal^{(A)} | Performance^{(B)} | Value^{(C)} | Performance | Payment | Payment |
| 1 | 81 | $100,000.00 | $100,000.00 | $2,143.61 | $4,830.76 | $5,752.85 | $98,778.48 | 7.00% | | |
| 2 | 82 | $ — | $ 98,778.48 | $2,129.19 | $4,844.41 | $5,680.28 | $97,485.16 | 7.00% | | |
| 3 | 83 | $ — | $ 97,485.16 | $2,113.93 | $4,857.53 | $5,603.26 | $96,116.97 | 7.00% | | |
| 4 | 84 | $ — | $ 96,116.97 | $2,097.79 | $4,870.07 | $5,522.11 | $94,671.22 | 7.00% | | |
| 5 | 85 | $ — | $ 94,671.22 | $2,080.74 | $4,881.96 | $5,436.20 | $93,144.72 | 7.00% | | |
| 6 | 86 | $ — | $ 93,144.72 | $2,062.75 | $4,893.14 | $5,345.58 | $91,534.41 | 7.00% | | |
| 7 | 87 | $ — | $ 91,534.41 | $2,043.78 | $4,903.54 | $5,250.66 | $89,837.76 | 7.00% | | |
| 8 | 88 | $ — | $ 89,837.76 | $2,023.80 | $4,913.10 | $5,149.95 | $88,050.81 | 7.00% | | |
| 9 | 89 | $ — | $ 88,050.81 | $2,002.76 | $4.921.69 | $5,044.23 | $86,170.59 | 7.00% | | |
| 10 | 90 | $ — | $ 86,170.59 | $1,980.63 | $4,929.24 | $4,932.96 | $84,193.68 | 7.00% | | |
| 11 | 91 | $ — | $ 84,193.68 | $1,957.37 | $4,935.62 | $4,815.62 | $82,116.31 | 7.00% | | |
| 12 | 92 | $ — | $ 82,116.31 | $1,932.94 | $4,940.69 | $4,692.83 | $79,935.51 | 7.00% | | |
| 13 | 93 | $ — | $ 79,935.51 | $1,907.30 | $4,944.32 | $4,564.11 | $77,648.00 | 7.00% | | |
| 14 | 94 | $ — | $ 77,648.00 | $1,880.42 | $4,946.37 | $4,428.71 | $75,249.92 | 7.00% | | |
| 15 | 95 | $ — | $ 75,249.92 | $1,852.25 | $4,946.62 | $4,287.07 | $72,738.13 | 7.00% | $4,830.76 | $5,912.40^{(D)} |

^{(A)}$4830.76 equals .0483076 (the Protective Income Manager Payment Factor in year one) × $100,000 (the initial Contract Value). The Protective Income Manager Payment Factor is based on the age of Joe (the younger Covered Person) on the Rider Effective Date, as well as his attained age on the date we calculate the Optimal Withdrawal Amount (which, in this example, is the full amount withdrawn each year).
^{(B)}The numbers in the Impact of Fund Performance column reflect the performance of the underlying funds and fund expenses.
^{(C)}The End of Year Contract Value is equal to the Beginning of Year Contract Value minus Contract Charges minus the PIM Withdrawal minus Fund Expenses.
^{(D)}On the Maximum Annuity Commencement Date, which is when Sally (the older Covered Person) reaches age 95, Sally and Joe must choose to receive annuity payments under their Contract or Protected Lifetime Payments under the rider. Because the annuity payments of $5,912.40 are greater than Protected Lifetime Payments of $4,830.76, Sally and Joe will receive annuity payments in an annual amount of $5,912.40 until they both die. The $5,912.40 represents Annuity Option B—Life Income With Or Without A Certain Period under the Contract with a 10-year Certain Period, assuming a 4% current interest rate.

APPENDIX A
PAYMENT FACTORS PER EQUATION 5
Single Life Coverage

| Attained Age | | | | | | | | | | | | | | |
|---|---|---|---|---|---|---|---|---|---|---|---|---|---|---|
| of Covered | | | | | | | | | | | | | | |
| Person On Date | Age of Covered Person on Rider Effective Date or Last Reset Date | | | | | | | | | | | | | |
| of Calculation | 60 | 61 | 62 | 63 | 64 | 65 | 66 | 67 | 68 | 69 | 70 | 71 | 72 | 73 |
| 94 | 1.00000 | 1.00000 | 1.00000 | 1.00000 | 1.00000 | 1.00000 | 1.00000 | 1.00000 | 1.00000 | 1.00000 | 1.00000 | 1.00000 | 1.00000 | 1.00000 |
| 93 | 0.50980 | 0.50968 | 0.50956 | 0.50944 | 0.50932 | 0.50920 | 0.50908 | 0.50896 | 0.50884 | 0.50872 | 0.50860 | 0.50848 | 0.50836 | 0.50824 |
| 92 | 0.34649 | 0.34633 | 0.34616 | 0.34600 | 0.34584 | 0.34568 | 0.34551 | 0.34535 | 0.34519 | 0.34503 | 0.34486 | 0.34470 | 0.34454 | 0.34438 |
| 91 | 0.26489 | 0.26471 | 0.26452 | 0.26434 | 0.26415 | 0.26397 | 0.26378 | 0.26360 | 0.26341 | 0.26323 | 0.26304 | 0.26286 | 0.26267 | 0.26249 |
| 90 | 0.21599 | 0.21579 | 0.21559 | 0.21539 | 0.21519 | 0.21499 | 0.21479 | 0.21459 | 0.21439 | 0.21419 | 0.21399 | 0.21379 | 0.21359 | 0.21339 |
| 89 | 0.18342 | 0.18321 | 0.18300 | 0.18279 | 0.18258 | 0.18237 | 0.18216 | 0.18195 | 0.18174 | 0.18153 | 0.18132 | 0.18111 | 0.18090 | 0.18069 |
| 88 | 0.16020 | 0.15998 | 0.15976 | 0.15954 | 0.15933 | 0.15911 | 0.15889 | 0.15867 | 0.15845 | 0.15823 | 0.15801 | 0.15780 | 0.15758 | 0.15736 |
| 87 | 0.14282 | 0.14259 | 0.14236 | 0.14214 | 0.14191 | 0.14169 | 0.14146 | 0.14123 | 0.14101 | 0.14078 | 0.14056 | 0.14033 | 0.14011 | 0.13988 |
| 86 | 0.12932 | 0.12909 | 0.12886 | 0.12862 | 0.12839 | 0.12816 | 0.12793 | 0.12770 | 0.12746 | 0.12723 | 0.12700 | 0.12677 | 0.12654 | 0.12631 |
| 85 | 0.11855 | 0.11831 | 0.11807 | 0.11784 | 0.11760 | 0.11736 | 0.11712 | 0.11689 | 0.11665 | 0.11641 | 0.11618 | 0.11594 | 0.11570 | 0.11547 |
| 84 | 0.10976 | 0.10952 | 0.10927 | 0.10903 | 0.10879 | 0.10854 | 0.10830 | 0.10806 | 0.10782 | 0.10758 | 0.10734 | 0.10709 | 0.10685 | 0.10661 |
| 83 | 0.10245 | 0.10221 | 0.10196 | 0.10171 | 0.10146 | 0.10122 | 0.10097 | 0.10072 | 0.10048 | 0.10023 | 0.09998 | 0.09974 | 0.09949 | 0.09925 |
| 82 | 0.09629 | 0.09604 | 0.09579 | 0.09554 | 0.09528 | 0.09503 | 0.09478 | 0.09453 | 0.09428 | 0.09403 | 0.09378 | 0.09353 | 0.09328 | 0.09303 |
| 81 | 0.09103 | 0.09077 | 0.09051 | 0.09026 | 0.09000 | 0.08975 | 0.08949 | 0.08924 | 0.08898 | 0.08873 | 0.08847 | 0.08822 | 0.08797 | 0.08771 |
| 80 | 0.08648 | 0.08622 | 0.08596 | 0.08570 | 0.08544 | 0.08518 | 0.08492 | 0.08466 | 0.08441 | 0.08415 | 0.08389 | 0.08363 | 0.08337 | 0.08312 |
| 79 | 0.08252 | 0.08225 | 0.08199 | 0.08173 | 0.08146 | 0.08120 | 0.08094 | 0.08067 | 0.08041 | 0.08015 | 0.07989 | 0.07963 | 0.07937 | 0.07911 |
| 78 | 0.07904 | 0.07877 | 0.07850 | 0.07823 | 0.07797 | 0.07770 | 0.07743 | 0.07717 | 0.07690 | 0.07664 | 0.07637 | 0.07611 | 0.07584 | 0.07558 |
| 77 | 0.07596 | 0.07568 | 0.07541 | 0.07514 | 0.07487 | 0.07460 | 0.07433 | 0.07406 | 0.07379 | 0.07352 | 0.07325 | 0.07298 | 0.07272 | 0.07245 |
| 76 | 0.07321 | 0.07293 | 0.07266 | 0.07238 | 0.07211 | 0.07184 | 0.07156 | 0.07129 | 0.07102 | 0.07075 | 0.07047 | 0.07020 | 0.06993 | 0.06966 |
| 75 | 0.07075 | 0.07047 | 0.07019 | 0.06992 | 0.06964 | 0.06936 | 0.06908 | 0.06881 | 0.06853 | 0.06826 | 0.06798 | 0.06771 | 0.06743 | 0.06716 |
| 74 | 0.06854 | 0.06826 | 0.06797 | 0.06769 | 0.06741 | 0.06713 | 0.06685 | 0.06657 | 0.06629 | 0.06601 | 0.06574 | 0.06546 | 0.06518 | 0.06490 |
| 73 | 0.06654 | 0.06625 | 0.06597 | 0.06568 | 0.06540 | 0.06511 | 0.06483 | 0.06455 | 0.06427 | 0.06398 | 0.06370 | 0.06342 | 0.06314 | 0.06286 |
| 72 | 0.06472 | 0.06443 | 0.06414 | 0.06385 | 0.06357 | 0.06328 | 0.06299 | 0.06271 | 0.06242 | 0.06214 | 0.06185 | 0.06157 | 0.06129 | |
| 71 | 0.06306 | 0.06277 | 0.06248 | 0.06219 | 0.06190 | 0.06161 | 0.06132 | 0.06103 | 0.06074 | 0.06045 | 0.06017 | 0.05988 | | |
| 70 | 0.06155 | 0.06125 | 0.06096 | 0.06067 | 0.06037 | 0.06008 | 0.05979 | 0.05949 | 0.05920 | 0.05891 | 0.05862 | | | |
| 69 | 0.06016 | 0.05986 | 0.05956 | 0.05927 | 0.05897 | 0.05867 | 0.05838 | 0.05808 | 0.05779 | 0.05750 | | | | |
| 68 | 0.05888 | 0.05858 | 0.05828 | 0.05798 | 0.05768 | 0.05738 | 0.05708 | 0.05679 | 0.05649 | | | | | |
| 67 | 0.05770 | 0.05740 | 0.05710 | 0.05679 | 0.05649 | 0.05619 | 0.05589 | 0.05559 | | | | | | |
| 66 | 0.05662 | 0.05631 | 0.05600 | 0.05569 | 0.05539 | 0.05508 | 0.05478 | | | | | | | |
| 65 | 0.05561 | 0.05530 | 0.05499 | 0.05468 | 0.05437 | 0.05406 | | | | | | | | |
| 64 | 0.05467 | 0.05436 | 0.05404 | 0.05373 | 0.05342 | | | | | | | | | |
| 63 | 0.05380 | 0.05348 | 0.05316 | 0.05285 | | | | | | | | | | |
| 62 | 0.05298 | 0.05267 | 0.05235 | | | | | | | | | | | |
| 61 | 0.05223 | 0.05190 | | | | | | | | | | | | |
| 60 | 0.05152 | | | | | | | | | | | | | |
| Attained Age | | | | | | | | | | | | | | |
| of Covered | | | | | | | | | | | | | | |
| Person On Date | Age of Covered Person on Rider Effective Date or Last Reset Date | | | | | | | | | | | | | |
| of Calculation | 74 | 75 | 76 | 77 | 78 | 79 | 80 | 81 | 82 | 83 | 84 | 85 | 86 | 87 |
| 94 | 1.00000 | 1.00000 | 1.00000 | 1.00000 | 1.00000 | 1.00000 | 1.00000 | 1.00000 | 1.00000 | 1.00000 | 1.00000 | 1.00000 | 1.00000 | 1.00000 |
| 93 | 0.50812 | 0.50800 | 0.50787 | 0.50775 | 0.50763 | 0.50751 | 0.50739 | 0.50727 | 0.50715 | 0.50702 | 0.50690 | 0.50678 | 0.50666 | 0.50654 |
| 92 | 0.34421 | 0.34405 | 0.34389 | 0.34372 | 0.34356 | 0.34340 | 0.34323 | 0.34307 | 0.34291 | 0.34274 | 0.34258 | 0.34242 | 0.34225 | 0.34209 |
| 91 | 0.26230 | 0.26212 | 0.26193 | 0.26175 | 0.26156 | 0.26138 | 0.26119 | 0.26101 | 0.26082 | 0.26063 | 0.26045 | 0.26026 | 0.26008 | 0.25989 |
| 90 | 0.21319 | 0.21299 | 0.21279 | 0.21259 | 0.21239 | 0.21219 | 0.21199 | 0.21179 | 0.21160 | 0.21140 | 0.21120 | 0.21100 | 0.21080 | 0.21060 |
| 89 | 0.18048 | 0.18027 | 0.18006 | 0.17985 | 0.17964 | 0.17943 | 0.17922 | 0.17901 | 0.17880 | 0.17859 | 0.17838 | 0.17817 | 0.17796 | 0.17775 |
| 88 | 0.15714 | 0.15692 | 0.15670 | 0.15649 | 0.15627 | 0.15605 | 0.15583 | 0.15561 | 0.15540 | 0.15518 | 0.15496 | 0.15474 | 0.15452 | 0.15431 |
| 87 | 0.13966 | 0.13943 | 0.13921 | 0.13898 | 0.13876 | 0.13853 | 0.13831 | 0.13808 | 0.13786 | 0.13763 | 0.13741 | 0.13719 | 0.13696 | 0.13674 |
| 86 | 0.12608 | 0.12585 | 0.12561 | 0.12538 | 0.12515 | 0.12492 | 0.12469 | 0.12446 | 0.12423 | 0.12400 | 0.12377 | 0.12354 | 0.12331 | |
| 85 | 0.11523 | 0.11499 | 0.11476 | 0.11452 | 0.11429 | 0.11405 | 0.11382 | 0.11358 | 0.11335 | 0.11311 | 0.11288 | 0.11264 | | |
| 84 | 0.10637 | 0.10613 | 0.10589 | 0.10565 | 0.10541 | 0.10517 | 0.10493 | 0.10469 | 0.10445 | 0.10421 | 0.10397 | | | |
| 83 | 0.09900 | 0.09876 | 0.09851 | 0.09827 | 0.09802 | 0.09778 | 0.09754 | 0.09729 | 0.09705 | 0.09681 | | | | |
| 82 | 0.09278 | 0.09253 | 0.09228 | 0.09203 | 0.09179 | 0.09154 | 0.09129 | 0.09104 | 0.09080 | | | | | |
| 81 | 0.08746 | 0.08721 | 0.08696 | 0.08670 | 0.08645 | 0.08620 | 0.08595 | 0.08570 | | | | | | |
| 80 | 0.08286 | 0.08260 | 0.08235 | 0.08209 | 0.08184 | 0.08158 | 0.08133 | | | | | | | |
| 79 | 0.07885 | 0.07859 | 0.07833 | 0.07807 | 0.07781 | 0.07755 | | | | | | | | |
| 78 | 0.07531 | 0.07505 | 0.07479 | 0.07453 | 0.07426 | | | | | | | | | |
| 77 | 0.07218 | 0.07192 | 0.07165 | 0.07139 | | | | | | | | | | |
| 76 | 0.06939 | 0.06912 | 0.06885 | | | | | | | | | | | |
| 75 | 0.06689 | 0.06661 | | | | | | | | | | | | |
| 74 | 0.06463 | | | | | | | | | | | | | |
| 73 | | | | | | | | | | | | | | |
| 72 | | | | | | | | | | | | | | |
| 71 | | | | | | | | | | | | | | |
| 70 | | | | | | | | | | | | | | |
| 69 | | | | | | | | | | | | | | |
| 68 | | | | | | | | | | | | | | |
| 67 | | | | | | | | | | | | | | |
| 66 | | | | | | | | | | | | | | |
| 65 | | | | | | | | | | | | | | |
| 64 | | | | | | | | | | | | | | |
| 63 | | | | | | | | | | | | | | |
| 62 | | | | | | | | | | | | | | |
| 61 | | | | | | | | | | | | | | |
| 60 | | | | | | | | | | | | | | |

| Attained Age | | | | | | | |
|---|---|---|---|---|---|---|---|
| of Covered | | | | | | | |
| Person On Date | Age of Covered Person on Rider Effective Date or Last Reset Date | | | | | | |
| of Calculation | 88 | 89 | 90 | 91 | 92 | 93 | 94 |
| 94 | 1.00000 | 1.00000 | 1.00000 | 1.00000 | 1.00000 | 1.00000 | 1.00000 |
| 93 | 0.50642 | 0.50629 | 0.50617 | 0.50605 | 0.50593 | 0.50581 | |
| 92 | 0.34192 | 0.34176 | 0.34160 | 0.34143 | 0.34127 | | |
| 91 | 0.25971 | 0.25952 | 0.25933 | 0.25915 | | | |
| 90 | 0.21040 | 0.21020 | 0.21000 | | | | |
| 89 | 0.17754 | 0.17733 | | | | | |
| 88 | 0.15409 | | | | | | |
| 87 | | | | | | | |
| 86 | | | | | | | |
| 85 | | | | | | | |
| 84 | | | | | | | |
| 83 | | | | | | | |
| 82 | | | | | | | |
| 81 | | | | | | | |
| 80 | | | | | | | |
| 79 | | | | | | | |
| 78 | | | | | | | |
| 77 | | | | | | | |
| 76 | | | | | | | |
| 75 | | | | | | | |
| 74 | | | | | | | |
| 73 | | | | | | | |
| 72 | | | | | | | |
| 71 | | | | | | | |
| 70 | | | | | | | |
| 69 | | | | | | | |
| 68 | | | | | | | |
| 67 | | | | | | | |
| 66 | | | | | | | |
| 65 | | | | | | | |
| 64 | | | | | | | |
| 63 | | | | | | | |
| 62 | | | | | | | |
| 61 | | | | | | | |
| 60 | | | | | | | |

Joint Life Coverage

| Attained Age | | | | | | | | | | | | | | |
|---|---|---|---|---|---|---|---|---|---|---|---|---|---|---|
| of Younger | Age of Younger Covered Person on Rider Effective Date or Last Reset Date | | | | | | | | | | | | | |
| Covered Person | 60 | 61 | 62 | 63 | 64 | 65 | 66 | 67 | 68 | 69 | 70 | 71 | 72 | 73 |
| 94 | 1.00000 | 1.00000 | 1.00000 | 1.00000 | 1.00000 | 1.00000 | 1.00000 | 1.00000 | 1.00000 | 1.00000 | 1.00000 | 1.00000 | 1.00000 | 1.00000 |
| 93 | 0.50860 | 0.50848 | 0.50836 | 0.50824 | 0.50812 | 0.50800 | 0.50787 | 0.50775 | 0.50763 | 0.50751 | 0.50739 | 0.50727 | 0.50715 | 0.50702 |
| 92 | 0.34486 | 0.34470 | 0.34454 | 0.34438 | 0.34421 | 0.34405 | 0.34389 | 0.34372 | 0.34356 | 0.34340 | 0.34323 | 0.34307 | 0.34291 | 0.34274 |
| 91 | 0.26304 | 0.26286 | 0.26267 | 0.26249 | 0.26230 | 0.26212 | 0.26193 | 0.26175 | 0.26156 | 0.26138 | 0.26119 | 0.26101 | 0.26082 | 0.26063 |
| 90 | 0.21399 | 0.21379 | 0.21359 | 0.21339 | 0.21319 | 0.21299 | 0.21279 | 0.21259 | 0.21239 | 0.21219 | 0.21199 | 0.21179 | 0.21160 | 0.21140 |
| 89 | 0.18132 | 0.18111 | 0.18090 | 0.18069 | 0.18048 | 0.18027 | 0.18006 | 0.17985 | 0.17964 | 0.17943 | 0.17922 | 0.17901 | 0.17880 | 0.17859 |
| 88 | 0.15801 | 0.15780 | 0.15758 | 0.15736 | 0.15714 | 0.15692 | 0.15670 | 0.15649 | 0.15627 | 0.15605 | 0.15583 | 0.15561 | 0.15540 | 0.15518 |
| 87 | 0.14056 | 0.14033 | 0.14011 | 0.13988 | 0.13966 | 0.13943 | 0.13921 | 0.13898 | 0.13876 | 0.13853 | 0.13831 | 0.13808 | 0.13786 | 0.13763 |
| 86 | 0.12700 | 0.12677 | 0.12654 | 0.12631 | 0.12608 | 0.12585 | 0.12561 | 0.12538 | 0.12515 | 0.12492 | 0.12469 | 0.12446 | 0.12423 | 0.12400 |
| 85 | 0.11618 | 0.11594 | 0.11570 | 0.11547 | 0.11523 | 0.11499 | 0.11476 | 0.11452 | 0.11429 | 0.11405 | 0.11382 | 0.11358 | 0.11335 | 0.11311 |
| 84 | 0.10734 | 0.10709 | 0.10685 | 0.10661 | 0.10637 | 0.10613 | 0.10589 | 0.10565 | 0.10541 | 0.10517 | 0.10493 | 0.10469 | 0.10445 | 0.10421 |
| 83 | 0.09998 | 0.09974 | 0.09949 | 0.09925 | 0.09900 | 0.09876 | 0.09851 | 0.09827 | 0.09802 | 0.09778 | 0.09754 | 0.09729 | 0.09705 | 0.09681 |
| 82 | 0.09378 | 0.09353 | 0.09325 | 0.09303 | 0.09278 | 0.09253 | 0.09228 | 0.09203 | 0.09179 | 0.09154 | 0.09129 | 0.09104 | 0.09080 | 0.09055 |
| 81 | 0.08847 | 0.08822 | 0.08797 | 0.08771 | 0.08746 | 0.08721 | 0.08696 | 0.08670 | 0.08645 | 0.08620 | 0.08595 | 0.08570 | 0.08545 | 0.08520 |
| 80 | 0.08389 | 0.08363 | 0.08337 | 0.08312 | 0.08286 | 0.08260 | 0.08235 | 0.08209 | 0.08184 | 0.08158 | 0.08133 | 0.08107 | 0.08082 | 0.08056 |
| 79 | 0.07989 | 0.07963 | 0.07937 | 0.07911 | 0.07885 | 0.07859 | 0.07833 | 0.07807 | 0.07781 | 0.07755 | 0.07729 | 0.07703 | 0.07678 | 0.07652 |
| 78 | 0.07637 | 0.07611 | 0.07584 | 0.07558 | 0.07531 | 0.07505 | 0.07479 | 0.07453 | 0.07426 | 0.07400 | 0.07374 | 0.07348 | 0.07322 | 0.07296 |
| 77 | 0.07325 | 0.07298 | 0.07272 | 0.07245 | 0.07218 | 0.07192 | 0.07165 | 0.07139 | 0.07112 | 0.07086 | 0.07059 | 0.07033 | 0.07006 | 0.06980 |
| 76 | 0.07047 | 0.07020 | 0.06993 | 0.06966 | 0.06939 | 0.06912 | 0.06885 | 0.06858 | 0.06832 | 0.06805 | 0.06778 | 0.06751 | 0.06725 | 0.06698 |
| 75 | 0.06798 | 0.06771 | 0.06743 | 0.06716 | 0.06689 | 0.06661 | 0.06634 | 0.06607 | 0.06580 | 0.06553 | 0.06526 | 0.06499 | 0.06472 | 0.06445 |
| 74 | 0.06574 | 0.06546 | 0.06518 | 0.06490 | 0.06463 | 0.06435 | 0.06408 | 0.06380 | 0.06353 | 0.06326 | 0.06298 | 0.06271 | 0.06244 | 0.06217 |
| 73 | 0.06370 | 0.06342 | 0.06314 | 0.06286 | 0.06258 | 0.06230 | 0.06203 | 0.06175 | 0.06147 | 0.06120 | 0.06092 | 0.06064 | 0.06037 | 0.06010 |
| 72 | 0.06185 | 0.06157 | 0.06129 | 0.06100 | 0.06072 | 0.06044 | 0.06016 | 0.05988 | 0.05960 | 0.05932 | 0.05904 | 0.05876 | 0.05849 | |
| 71 | 0.06017 | 0.05988 | 0.05959 | 0.05931 | 0.05902 | 0.05874 | 0.05846 | 0.05817 | 0.05789 | 0.05761 | 0.05733 | 0.05705 | | |
| 70 | 0.05862 | 0.05833 | 0.05804 | 0.05776 | 0.05747 | 0.05718 | 0.05689 | 0.05661 | 0.05632 | 0.05604 | 0.05576 | | | |
| 69 | 0.05720 | 0.05691 | 0.05662 | 0.05633 | 0.05604 | 0.05575 | 0.05546 | 0.05517 | 0.05488 | 0.05460 | | | | |
| 68 | 0.05590 | 0.05560 | 0.05531 | 0.05501 | 0.05472 | 0.05443 | 0.05414 | 0.05384 | 0.05355 | | | | | |
| 67 | 0.05469 | 0.05439 | 0.05409 | 0.05380 | 0.05350 | 0.05321 | 0.05291 | 0.05262 | | | | | | |
| 66 | 0.05357 | 0.05327 | 0.05297 | 0.05267 | 0.05237 | 0.05207 | 0.05178 | | | | | | | |
| 65 | 0.05253 | 0.05223 | 0.05193 | 0.05162 | 0.05132 | 0.05102 | | | | | | | | |
| 64 | 0.05157 | 0.05126 | 0.05096 | 0.05065 | 0.05035 | | | | | | | | | |
| 63 | 0.05067 | 0.05036 | 0.05005 | 0.04974 | | | | | | | | | | |
| 62 | 0.04983 | 0.04952 | 0.04921 | | | | | | | | | | | |
| 61 | 0.04904 | 0.04873 | | | | | | | | | | | | |
| 60 | 0.04831 | | | | | | | | | | | | | |
| Attained Age | | | | | | | | | | | | | | |
| of Younger | Age of Younger Covered Person on Rider Effective Date or Last Reset Date | | | | | | | | | | | | | |
| Covered Person | 74 | 75 | 76 | 77 | 78 | 79 | 80 | 81 | 82 | 83 | 84 | 85 | 86 | 87 |
| 94 | 1.00000 | 1.00000 | 1.00000 | 1.00000 | 1.00000 | 1.00000 | 1.00000 | 1.00000 | 1.00000 | 1.00000 | 1.00000 | 1.00000 | 1.00000 | 1.00000 |
| 93 | 0.50690 | 0.50678 | 0.50666 | 0.50654 | 0.50642 | 0.50629 | 0.50617 | 0.50605 | 1.50593 | 0.50581 | 0.50568 | 0.50556 | 0.50544 | 0.50532 |
| 92 | 0.34258 | 0.34242 | 0.34225 | 0.34209 | 0.34192 | 0.34176 | 0.34160 | 0.34143 | 0.34127 | 0.34111 | 0.34094 | 0.34078 | 0.34061 | 0.34045 |
| 91 | 0.26045 | 0.26026 | 0.26008 | 0.25989 | 0.25971 | 0.25952 | 0.25933 | 0.25915 | 0.25896 | 0.25878 | 0.25859 | 0.25840 | 0.25822 | 0.25803 |
| 90 | 0.21120 | 0.21100 | 0.21080 | 0.21060 | 0.21040 | 0.21020 | 0.21000 | 0.20980 | 0.20960 | 0.20940 | 0.20920 | 0.20900 | 0.20880 | 0.20860 |
| 89 | 0.17838 | 0.17817 | 0.17796 | 0.17775 | 0.17754 | 0.17733 | 0.17712 | 0.17691 | 0.17670 | 0.17649 | 0.17628 | 0.17607 | 0.17586 | 0.17565 |
| 88 | 0.15496 | 0.15474 | 0.15452 | 0.15431 | 0.15409 | 0.15387 | 0.15365 | 0.15344 | 0.15322 | 0.15300 | 0.15278 | 0.15257 | 0.15235 | 0.15213 |
| 87 | 0.13741 | 0.13719 | 0.13696 | 0.13674 | 0.13651 | 0.13629 | 0.13607 | 0.13584 | 0.13562 | 0.13539 | 0.13517 | 0.13495 | 0.13473 | 0.13450 |
| 86 | 0.12377 | 0.12354 | 0.12331 | 0.12308 | 0.12286 | 0.12263 | 0.12240 | 0.12217 | 0.12194 | 0.12171 | 0.12148 | 0.12125 | 0.12103 | |
| 85 | 0.11288 | 0.11264 | 0.11241 | 0.11217 | 0.11194 | 0.11171 | 0.11147 | 0.11124 | 0.11101 | 0.11077 | 0.11054 | 0.11031 | | |
| 84 | 0.10397 | 0.10373 | 0.10349 | 0.10326 | 0.10302 | 0.10278 | 0.10254 | 0.10230 | 0.10207 | 0.10183 | 0.10159 | | | |
| 83 | 0.09656 | 0.09632 | 0.09608 | 0.09584 | 0.09559 | 0.09535 | 0.09511 | 0.09487 | 0.09463 | 0.09439 | | | | |
| 82 | 0.09030 | 0.09006 | 0.08981 | 0.08956 | 0.08932 | 0.08907 | 0.03883 | 0.08858 | 0.08834 | | | | | |
| 81 | 0.08495 | 0.08470 | 0.08445 | 0.08420 | 0.08395 | 0.08370 | 0.08345 | 0.08320 | | | | | | |
| 80 | 0.08031 | 0.08006 | 0.07980 | 0.07955 | 0.07930 | 0.07905 | 0.07880 | | | | | | | |
| 79 | 0.07626 | 0.07601 | 0.07575 | 0.07550 | 0.07524 | 0.07499 | | | | | | | | |
| 78 | 0.07270 | 0.07244 | 0.07218 | 0.07192 | 0.07166 | | | | | | | | | |
| 77 | 0.06954 | 0.06928 | 0.06901 | 0.06875 | | | | | | | | | | |
| 76 | 0.06672 | 0.06645 | 0.06619 | | | | | | | | | | | |
| 75 | 0.06418 | 0.06391 | | | | | | | | | | | | |
| 74 | 0.06190 | | | | | | | | | | | | | |
| 73 | | | | | | | | | | | | | | |
| 72 | | | | | | | | | | | | | | |
| 71 | | | | | | | | | | | | | | |
| 70 | | | | | | | | | | | | | | |
| 69 | | | | | | | | | | | | | | |
| 68 | | | | | | | | | | | | | | |
| 67 | | | | | | | | | | | | | | |
| 66 | | | | | | | | | | | | | | |
| 65 | | | | | | | | | | | | | | |
| 64 | | | | | | | | | | | | | | |
| 63 | | | | | | | | | | | | | | |
| 62 | | | | | | | | | | | | | | |
| 61 | | | | | | | | | | | | | | |
| 60 | | | | | | | | | | | | | | |

| Attained Age | Age of Younger Covered Person on | | | | | | |
|---|---|---|---|---|---|---|---|
| of Younger | Rider Effective Date or Last Reset Date | | | | | | |
| Covered Person | 88 | 89 | 90 | 91 | 92 | 93 | 94 |
| 94 | 1.00000 | 1.00000 | 1.00000 | 1.00000 | 1.00000 | 1.00000 | 1.00000 |
| 93 | 0.50520 | 0.50507 | 0.50495 | 0.50483 | 0.50471 | 0.50458 | |
| 92 | 0.34028 | 0.34012 | 0.33996 | 0.33979 | 0.33963 | | |
| 91 | 0.25785 | 0.25766 | 0.25747 | 0.25729 | | | |
| 90 | 0.20840 | 0.20820 | 0.20800 | | | | |
| 89 | 0.17544 | 0.17523 | | | | | |
| 88 | 0.15192 | | | | | | |
| 87 | | | | | | | |
| 86 | | | | | | | |
| 85 | | | | | | | |
| 84 | | | | | | | |
| 83 | | | | | | | |
| 82 | | | | | | | |
| 81 | | | | | | | |
| 80 | | | | | | | |
| 79 | | | | | | | |
| 78 | | | | | | | |
| 77 | | | | | | | |
| 76 | | | | | | | |
| 75 | | | | | | | |
| 74 | | | | | | | |
| 73 | | | | | | | |
| 72 | | | | | | | |
| 71 | | | | | | | |
| 70 | | | | | | | |
| 69 | | | | | | | |
| 68 | | | | | | | |
| 67 | | | | | | | |
| 66 | | | | | | | |
| 65 | | | | | | | |
| 64 | | | | | | | |
| 63 | | | | | | | |
| 62 | | | | | | | |
| 61 | | | | | | | |
| 60 | | | | | | | |

APPENDIX B
PAYMENT FACTORS PER EQUATION 4
Single Life Coverage

| Years | | | | | | | | | | | | |
|---|---|---|---|---|---|---|---|---|---|---|---|---|
| Remaining | | | | | | | | | | | | |
| Until Maximum | | | | | | | | | | | | |
| Annuity | | | | | | | | | | | | |
| Commencement | Age of Covered Person on Rider Effective Date or Last Reset Date | | | | | | | | | | | |
| Date | 60 | 61 | 62 | 63 | 64 | 65 | 66 | 67 | 68 | 69 | 70 | 71 |
| 1 | 1.00000 | 1.00000 | 1.00000 | 1.00000 | 1.00000 | 1.00000 | 1.00000 | 1.00000 | 1.00000 | 1.00000 | 1.00000 | 1.00000 |
| 2 | 0.50980 | 0.50968 | 0.50956 | 0.50944 | 0.50932 | 0.50920 | 0.50908 | 0.50896 | 0.50884 | 0.50872 | 0.50860 | 0.50848 |
| 3 | 0.34649 | 0.34633 | 0.34616 | 0.34600 | 0.34584 | 0.34568 | 0.34551 | 0.34535 | 0.34519 | 0.34503 | 0.34486 | 0.34470 |
| 4 | 0.26489 | 0.26471 | 0.26452 | 0.26434 | 0.26415 | 0.26397 | 0.26378 | 0.26360 | 0.26341 | 0.26323 | 0.26304 | 0.26286 |
| 5 | 0.21599 | 0.21579 | 0.21559 | 0.21539 | 0.21519 | 0.21499 | 0.21479 | 0.21459 | 0.21439 | 0.21419 | 0.21399 | 0.21379 |
| 6 | 0.18342 | 0.18321 | 0.18300 | 0.18279 | 0.18258 | 0.18237 | 0.18216 | 0.18195 | 0.18174 | 0.18153 | 0.18132 | 0.18111 |
| 7 | 0.16020 | 0.15998 | 0.15976 | 0.15954 | 0.15933 | 0.15911 | 0.15889 | 0.15867 | 0.15845 | 0.15823 | 0.15801 | 0.15780 |
| 8 | 0.14282 | 0.14259 | 0.14236 | 0.14214 | 0.14191 | 0.14169 | 0.14146 | 0.14123 | 0.14101 | 0.14078 | 0.14056 | 0.14033 |
| 9 | 0.12932 | 0.12909 | 0.12886 | 0.12862 | 0.12839 | 0.12816 | 0.12793 | 0.12770 | 0.12746 | 0.12723 | 0.12700 | 0.12677 |
| 10 | 0.11855 | 0.11831 | 0.11807 | 0.11784 | 0.11760 | 0.11736 | 0.11712 | 0.11689 | 0.11665 | 0.11641 | 0.11618 | 0.11594 |
| 11 | 0.10976 | 0.10952 | 0.10927 | 0.10903 | 0.10879 | 0.10854 | 0.10830 | 0.10806 | 0.10782 | 0.10758 | 0.10734 | 0.10709 |
| 12 | 0.10245 | 0.10221 | 0.10196 | 0.10171 | 0.10146 | 0.10122 | 0.10097 | 0.10072 | 0.10048 | 0.10023 | 0.09998 | 0.09974 |
| 13 | 0.09629 | 0.09604 | 0.09579 | 0.09554 | 0.09528 | 0.09503 | 0.09478 | 0.09453 | 0.09428 | 0.09403 | 0.09378 | 0.09353 |
| 14 | 0.09103 | 0.09077 | 0.09051 | 0.09026 | 0.09000 | 0.08975 | 0.08949 | 0.08924 | 0.08898 | 0.08873 | 0.08847 | 0.08822 |
| 15 | 0.08648 | 0.08622 | 0.08596 | 0.08570 | 0.08544 | 0.08518 | 0.08492 | 0.08466 | 0.08441 | 0.08415 | 0.08389 | 0.08363 |
| 16 | 0.08252 | 0.08225 | 0.08199 | 0.08173 | 0.08146 | 0.08120 | 0.08094 | 0.08067 | 0.08041 | 0.08015 | 0.07989 | 0.07963 |
| 17 | 0.07904 | 0.07877 | 0.07850 | 0.07823 | 0.07797 | 0.07770 | 0.07743 | 0.07717 | 0.07690 | 0.07664 | 0.07637 | 0.07611 |
| 18 | 0.07596 | 0.07568 | 0.07541 | 0.07514 | 0.07487 | 0.07460 | 0.07433 | 0.07406 | 0.07379 | 0.07352 | 0.07325 | 0.07298 |
| 19 | 0.07321 | 0.07293 | 0.07266 | 0.07238 | 0.07211 | 0.07184 | 0.07156 | 0.07129 | 0.07102 | 0.07075 | 0.07047 | 0.07020 |
| 20 | 0.07075 | 0.07047 | 0.07019 | 0.06992 | 0.06964 | 0.06936 | 0.06908 | 0.06881 | 0.06853 | 0.06826 | 0.06798 | 0.06771 |
| 21 | 0.06854 | 0.06826 | 0.06797 | 0.06769 | 0.06741 | 0.06713 | 0.06685 | 0.06657 | 0.06629 | 0.06601 | 0.06574 | 0.06546 |
| 22 | 0.06654 | 0.06625 | 0.06597 | 0.06568 | 0.06540 | 0.06511 | 0.06483 | 0.06455 | 0.06427 | 0.06398 | 0.06370 | 0.06342 |
| 23 | 0.06472 | 0.06443 | 0.06414 | 0.06385 | 0.06357 | 0.06328 | 0.06299 | 0.06271 | 0.06242 | 0.06214 | 0.06185 | 0.06157 |
| 24 | 0.06306 | 0.06277 | 0.06248 | 0.06219 | 0.06190 | 0.06161 | 0.06132 | 0.06103 | 0.06074 | 0.06045 | 0.06017 | 0.05988 |
| 25 | 0.06155 | 0.06125 | 0.06096 | 0.06067 | 0.06037 | 0.06008 | 0.05979 | 0.05949 | 0.05920 | 0.05891 | 0.05862 | |
| 26 | 0.06016 | 0.05986 | 0.05956 | 0.05927 | 0.05897 | 0.05867 | 0.05838 | 0.05808 | 0.05779 | 0.05750 | | |
| 27 | 0.05888 | 0.05858 | 0.05828 | 0.05798 | 0.05768 | 0.05738 | 0.05708 | 0.05679 | 0.05649 | | | |
| 28 | 0.05770 | 0.05740 | 0.05710 | 0.05679 | 0.05649 | 0.05619 | 0.05589 | 0.05559 | | | | |
| 29 | 0.05662 | 0.05631 | 0.05600 | 0.05569 | 0.05539 | 0.05508 | 0.05478 | | | | | |
| 30 | 0.05561 | 0.05530 | 0.05499 | 0.05468 | 0.05437 | 0.05406 | | | | | | |
| 31 | 0.05467 | 0.05436 | 0.05404 | 0.05373 | 0.05342 | | | | | | | |
| 32 | 0.05380 | 0.05348 | 0.05316 | 0.05285 | | | | | | | | |
| 33 | 0.05298 | 0.05267 | 0.05235 | | | | | | | | | |
| 34 | 0.05223 | 0.05190 | | | | | | | | | | |
| 35 | 0.05152 | | | | | | | | | | | |
| Years | | | | | | | | | | | | |
| Remaining | | | | | | | | | | | | |
| Until Maximum | | | | | | | | | | | | |
| Annuity | | | | | | | | | | | | |
| Commencement | Age of Covered Person on Rider Effective Date or Last Reset Date | | | | | | | | | | | |
| Date | 72 | 73 | 74 | 75 | 76 | 77 | 78 | 79 | 80 | 81 | 82 | 83 |
| 1 | 1.00000 | 1.00000 | 1.00000 | 1.00000 | 1.00000 | 1.00000 | 1.00000 | 1.00000 | 1.00000 | 1.00000 | 1.00000 | 1.00000 |
| 2 | 0.50836 | 0.50824 | 0.50812 | 0.50800 | 0.50787 | 0.50775 | 0.50763 | 0.50751 | 0.50739 | 0.50727 | 0.50715 | 0.50702 |
| 3 | 0.34454 | 0.34438 | 0.34421 | 0.34405 | 0.34389 | 0.34372 | 0.34356 | 0.34340 | 0.34323 | 0.34307 | 0.34291 | 0.34274 |
| 4 | 0.26267 | 0.26249 | 0.26230 | 0.26212 | 0.26193 | 0.26175 | 0.26156 | 0.26138 | 0.26119 | 0.26101 | 0.26082 | 0.26063 |
| 5 | 0.21359 | 0.21339 | 0.21319 | 0.21299 | 0.21279 | 0.21259 | 0.21239 | 0.21219 | 0.21199 | 0.21179 | 0.21160 | 0.21140 |
| 6 | 0.18090 | 0.18069 | 0.18048 | 0.18027 | 0.18006 | 0.17985 | 0.17964 | 0.17943 | 0.17922 | 0.17901 | 0.17880 | 0.17859 |
| 7 | 0.15758 | 0.15736 | 0.15714 | 0.15692 | 0.15670 | 0.15649 | 0.15627 | 0.15605 | 0.15583 | 0.15561 | 0.15540 | 0.15518 |
| 8 | 0.14011 | 0.13988 | 0.13966 | 0.13943 | 0.13921 | 0.13898 | 0.13876 | 0.13853 | 0.13831 | 0.13808 | 0.13786 | 0.13763 |
| 9 | 0.12654 | 0.12631 | 0.12608 | 0.12585 | 0.12561 | 0.12538 | 0.12515 | 0.12492 | 0.12469 | 0.12446 | 0.12423 | 0.12400 |
| 10 | 0.11570 | 0.11547 | 0.11523 | 0.11499 | 0.11476 | 0.11452 | 0.11429 | 0.11405 | 0.11382 | 0.11358 | 0.11335 | 0.11311 |
| 11 | 0.10685 | 0.10661 | 0.10637 | 0.10613 | 0.10589 | 0.10565 | 0.10541 | 0.10517 | 0.10493 | 0.10469 | 0.10445 | 0.10421 |
| 12 | 0.09949 | 0.09925 | 0.09900 | 0.09876 | 0.09851 | 0.09827 | 0.09802 | 0.09778 | 0.09754 | 0.09729 | 0.09705 | 0.09681 |
| 13 | 0.09328 | 0.09303 | 0.09278 | 0.09253 | 0.09228 | 0.09203 | 0.09179 | 0.09154 | 0.09129 | 0.09104 | 0.09080 | |
| 14 | 0.08797 | 0.08771 | 0.08746 | 0.08721 | 0.08696 | 0.08670 | 0.08645 | 0.08620 | 0.08595 | 0.08570 | | |
| 15 | 0.08337 | 0.08312 | 0.08286 | 0.08260 | 0.08235 | 0.08209 | 0.08184 | 0.08158 | 0.08133 | | | |
| 16 | 0.07937 | 0.07911 | 0.07885 | 0.07859 | 0.07833 | 0.07807 | 0.07781 | 0.07755 | | | | |
| 17 | 0.07584 | 0.07558 | 0.07531 | 0.07505 | 0.07479 | 0.07453 | 0.07426 | | | | | |
| 18 | 0.07272 | 0.07245 | 0.07218 | 0.07192 | 0.07165 | 0.07139 | | | | | | |
| 19 | 0.06993 | 0.06966 | 0.06939 | 0.06912 | 0.06885 | | | | | | | |
| 20 | 0.06743 | 0.06716 | 0.06689 | 0.06661 | | | | | | | | |
| 21 | 0.06518 | 0.06490 | 0.06463 | | | | | | | | | |
| 22 | 0.06314 | 0.06286 | | | | | | | | | | |
| 23 | 0.06129 | | | | | | | | | | | |
| 24 | | | | | | | | | | | | |
| 25 | | | | | | | | | | | | |
| 26 | | | | | | | | | | | | |
| 27 | | | | | | | | | | | | |
| 28 | | | | | | | | | | | | |
| 29 | | | | | | | | | | | | |
| 30 | | | | | | | | | | | | |
| 31 | | | | | | | | | | | | |
| 32 | | | | | | | | | | | | |
| 33 | | | | | | | | | | | | |
| 34 | | | | | | | | | | | | |
| 35 | | | | | | | | | | | | |

| Years | | | | | | | | | | | |
|---|---|---|---|---|---|---|---|---|---|---|---|
| Remaining | | | | | | | | | | | |
| Until Maximum | | | | | | | | | | | |
| Annuity | | | | | | | | | | | |
| Commencement | Age of Covered Person on Rider Effective Date or Last Reset Date | | | | | | | | | | |
| Date | 84 | 85 | 86 | 87 | 88 | 89 | 90 | 91 | 92 | 93 | 94 |
| 1 | 1.00000 | 1.00000 | 1.00000 | 1.00000 | 1.00000 | 1.00000 | 1.00000 | 1.00000 | 1.00000 | 1.00000 | 1.00000 |
| 2 | 0.50690 | 0.50678 | 0.50666 | 0.50654 | 0.50642 | 0.50629 | 0.50617 | 0.50605 | 0.50593 | 0.50581 | |
| 3 | 0.34258 | 0.34242 | 0.34225 | 0.34209 | 0.34192 | 0.34176 | 0.34160 | 0.34143 | 0.34127 | | |
| 4 | 0.26045 | 0.26026 | 0.26008 | 0.25989 | 0.25971 | 0.25952 | 0.25933 | 0.25915 | | | |
| 5 | 0.21120 | 0.21100 | 0.21080 | 0.21060 | 0.21040 | 0.21020 | 0.21000 | | | | |
| 6 | 0.17838 | 0.17817 | 0.17796 | 0.17775 | 0.17754 | 0.17733 | | | | | |
| 7 | 0.15496 | 0.15474 | 0.15452 | 0.15431 | 0.15409 | | | | | | |
| 8 | 0.13741 | 0.13719 | 0.13696 | 0.13674 | | | | | | | |
| 9 | 0.12377 | 0.12354 | 0.12331 | | | | | | | | |
| 10 | 0.11288 | 0.11264 | | | | | | | | | |
| 11 | 0.10397 | | | | | | | | | | |
| 12 | | | | | | | | | | | |
| 13 | | | | | | | | | | | |
| 14 | | | | | | | | | | | |
| 15 | | | | | | | | | | | |
| 16 | | | | | | | | | | | |
| 17 | | | | | | | | | | | |
| 18 | | | | | | | | | | | |
| 19 | | | | | | | | | | | |
| 20 | | | | | | | | | | | |
| 21 | | | | | | | | | | | |
| 22 | | | | | | | | | | | |
| 23 | | | | | | | | | | | |
| 24 | | | | | | | | | | | |
| 25 | | | | | | | | | | | |
| 26 | | | | | | | | | | | |
| 27 | | | | | | | | | | | |
| 28 | | | | | | | | | | | |
| 29 | | | | | | | | | | | |
| 30 | | | | | | | | | | | |
| 31 | | | | | | | | | | | |
| 32 | | | | | | | | | | | |
| 33 | | | | | | | | | | | |
| 34 | | | | | | | | | | | |
| 35 | | | | | | | | | | | |

Joint Life Coverage

| Years | | | | | | | | | | | | |
|---|---|---|---|---|---|---|---|---|---|---|---|---|
| Remaining | | | | | | | | | | | | |
| Until Maximum | | | | | | | | | | | | |
| Annuity | | | | | | | | | | | | |
| Commencement | Age of Younger Covered Person on Rider Effective Date or Last Reset Date | | | | | | | | | | | |
| Date | 60 | 61 | 62 | 63 | 64 | 65 | 66 | 67 | 68 | 69 | 70 | 71 |
| 1 | 1.00000 | 1.00000 | 1.00000 | 1.00000 | 1.00000 | 1.00000 | 1.00000 | 1.00000 | 1.00000 | 1.00000 | 1.00000 | 1.00000 |
| 2 | 0.50860 | 0.50848 | 0.50836 | 0.50824 | 0.50812 | 0.50800 | 0.50787 | 0.50775 | 0.50763 | 0.50751 | 0.50739 | 0.50727 |
| 3 | 0.34486 | 0.34470 | 0.34454 | 0.34438 | 0.34421 | 0.34405 | 0.34389 | 0.34372 | 0.34356 | 0.34340 | 0.34323 | 0.34307 |
| 4 | 0.26304 | 0.26286 | 0.26267 | 0.26249 | 0.26230 | 0.26212 | 0.26193 | 0.26175 | 0.26156 | 0.26138 | 0.26119 | 0.26101 |
| 5 | 0.21399 | 0.21379 | 0.21359 | 0.21339 | 0.21319 | 0.21299 | 0.21279 | 0.21259 | 0.21239 | 0.21219 | 0.21199 | 0.21179 |
| 6 | 0.18132 | 0.18111 | 0.18090 | 0.18069 | 0.18048 | 0.18027 | 0.18006 | 0.17985 | 0.17964 | 0.17943 | 0.17922 | 0.17901 |
| 7 | 0.15801 | 0.15780 | 0.15758 | 0.15736 | 0.15714 | 0.15692 | 0.15670 | 0.15649 | 0.15627 | 0.15605 | 0.15583 | 0.15561 |
| 8 | 0.14056 | 0.14033 | 0.14011 | 0.13988 | 0.13966 | 0.13943 | 0.13921 | 0.13898 | 0.13876 | 0.13853 | 0.13831 | 0.13808 |
| 9 | 0.12700 | 0.12677 | 0.12654 | 0.12631 | 0.12608 | 0.12585 | 0.12561 | 0.12538 | 0.12515 | 0.12492 | 0.12469 | 0.12446 |
| 10 | 0.11618 | 0.11594 | 0.11570 | 0.11547 | 0.11523 | 0.11499 | 0.11476 | 0.11452 | 0.11429 | 0.11405 | 0.11382 | 0.11358 |
| 11 | 0.10734 | 0.10709 | 0.10685 | 0.10661 | 0.10637 | 0.10613 | 0.10589 | 0.10565 | 0.10541 | 0.10517 | 0.10493 | 0.10469 |
| 12 | 0.09998 | 0.09974 | 0.09949 | 0.09925 | 0.09900 | 0.09876 | 0.09851 | 0.09827 | 0.09802 | 0.09778 | 0.09754 | 0.09729 |
| 13 | 0.09378 | 0.09353 | 0.09328 | 0.09303 | 0.09278 | 0.09253 | 0.09228 | 0.09203 | 0.09179 | 0.09154 | 0.09129 | 0.09104 |
| 14 | 0.08847 | 0.08822 | 0.08797 | 0.08771 | 0.08746 | 0.08721 | 0.08696 | 0.08670 | 0.08645 | 0.08620 | 0.08595 | 0.08570 |
| 15 | 0.08389 | 0.08363 | 0.08337 | 0.08312 | 0.08286 | 0.08260 | 0.08235 | 0.08209 | 0.08184 | 0.08158 | 0.08133 | 0.08107 |
| 16 | 0.07989 | 0.07963 | 0.07937 | 0.07911 | 0.07885 | 0.07859 | 0.07833 | 0.07807 | 0.07781 | 0.07755 | 0.07729 | 0.07703 |
| 17 | 0.07637 | 0.07611 | 0.07584 | 0.07558 | 0.07531 | 0.07505 | 0.07479 | 0.07453 | 0.07426 | 0.07400 | 0.07374 | 0.07348 |
| 18 | 0.07325 | 0.07298 | 0.07272 | 0.07245 | 0.07218 | 0.07192 | 0.07165 | 0.07139 | 0.07112 | 0.07086 | 0.07059 | 0.07033 |
| 19 | 0.07047 | 0.07020 | 0.06993 | 0.06966 | 0.06939 | 0.06912 | 0.06885 | 0.06858 | 0.06832 | 0.06805 | 0.06778 | 0.06751 |
| 20 | 0.06798 | 0.06771 | 0.06743 | 0.06716 | 0.06689 | 0.06661 | 0.06634 | 0.06607 | 0.06580 | 0.06553 | 0.06526 | 0.06499 |
| 21 | 0.06574 | 0.06546 | 0.06518 | 0.06490 | 0.06463 | 0.06435 | 0.06408 | 0.06380 | 0.06353 | 0.06326 | 0.06298 | 0.06271 |
| 22 | 0.06370 | 0.06342 | 0.06314 | 0.06286 | 0.06258 | 0.06230 | 0.06203 | 0.06175 | 0.06147 | 0.06120 | 0.06092 | 0.06064 |
| 23 | 0.06185 | 0.06157 | 0.06129 | 0.06100 | 0.06072 | 0.06044 | 0.06016 | 0.05988 | 0.05960 | 0.05932 | 0.05904 | 0.05876 |
| 24 | 0.06017 | 0.05988 | 0.05959 | 0.05931 | 0.05902 | 0.05874 | 0.05846 | 0.05817 | 0.05789 | 0.05761 | 0.05733 | 0.05705 |
| 25 | 0.05862 | 0.05833 | 0.05804 | 0.05776 | 0.05747 | 0.05718 | 0.05689 | 0.05661 | 0.05632 | 0.05604 | 0.05576 | |
| 26 | 0.05720 | 0.05691 | 0.05662 | 0.05633 | 0.05604 | 0.05575 | 0.05546 | 0.05517 | 0.05488 | 0.05460 | | |
| 27 | 0.05590 | 0.05560 | 0.05531 | 0.05501 | 0.05472 | 0.05443 | 0.05414 | 0.05384 | 0.05355 | | | |
| 28 | 0.05469 | 0.05439 | 0.05409 | 0.05380 | 0.05350 | 0.05321 | 0.05291 | 0.05262 | | | | |
| 29 | 0.05357 | 0.05327 | 0.05297 | 0.05267 | 0.05237 | 0.05207 | 0.05178 | | | | | |
| 30 | 0.05253 | 0.05223 | 0.05193 | 0.05162 | 0.05132 | 0.05102 | | | | | | |
| 31 | 0.05157 | 0.05126 | 0.05096 | 0.05065 | 0.05035 | | | | | | | |
| 32 | 0.05067 | 0.05036 | 0.05005 | 0.04974 | | | | | | | | |
| 33 | 0.04983 | 0.04952 | 0.04921 | | | | | | | | | |
| 34 | 0.04904 | 0.04873 | | | | | | | | | | |
| 35 | 0.04831 | | | | | | | | | | | |
| Years | | | | | | | | | | | | |
| Remaining | | | | | | | | | | | | |
| Until Maximum | | | | | | | | | | | | |
| Annuity | | | | | | | | | | | | |
| Commencement | Age of Younger Covered Person on Rider Effective Date or Last Reset Date | | | | | | | | | | | |
| Date | 72 | 73 | 74 | 75 | 76 | 77 | 78 | 79 | 80 | 81 | 82 | 83 |
| 1 | 1.00000 | 1.00000 | 1.00000 | 1.00000 | 1.00000 | 1.00000 | 1.00000 | 1.00000 | 1.00000 | 1.00000 | 1.00000 | 1.00000 |
| 2 | 0.50715 | 0.50702 | 0.50690 | 0.50678 | 0.50666 | 0.50654 | 0.50642 | 0.50629 | 0.50617 | 0.50605 | 0.50593 | 0.50581 |
| 3 | 0.34291 | 0.34274 | 0.34258 | 0.34242 | 0.34225 | 0.34209 | 0.34192 | 0.34176 | 0.34160 | 0.34143 | 0.34127 | 0.34111 |
| 4 | 0.26082 | 0.26063 | 0.26045 | 0.26026 | 0.26008 | 0.25989 | 0.25971 | 0.25952 | 0.25933 | 0.25915 | 0.25896 | 0.25878 |
| 5 | 0.21160 | 0.21140 | 0.21120 | 0.21100 | 0.21080 | 0.21060 | 0.21040 | 0.21020 | 0.21000 | 0.20980 | 0.20960 | 0.20940 |
| 6 | 0.17880 | 0.17859 | 0.17838 | 0.17817 | 0.17796 | 0.17775 | 0.17754 | 0.17733 | 0.17712 | 0.17691 | 0.17670 | 0.17649 |
| 7 | 0.15540 | 0.15518 | 0.15496 | 0.15474 | 0.15452 | 0.15431 | 0.15409 | 0.15387 | 0.15365 | 0.15344 | 0.15322 | 0.15300 |
| 8 | 0.13786 | 0.13763 | 0.13741 | 0.13719 | 0.13696 | 0.13674 | 0.13651 | 0.13629 | 0.13607 | 0.13584 | 0.13562 | 0.13539 |
| 9 | 0.12423 | 0.12400 | 0.12377 | 0.12354 | 0.12331 | 0.12308 | 0.12286 | 0.12263 | 0.12240 | 0.12217 | 0.12194 | 0.12171 |
| 10 | 0.11335 | 0.11311 | 0.11288 | 0.11264 | 0.11241 | 0.11217 | 0.11194 | 0.11171 | 0.11147 | 0.11124 | 0.11101 | 0.11077 |
| 11 | 0.10445 | 0.10421 | 0.10397 | 0.10373 | 0.10349 | 0.10326 | 0.10302 | 0.10278 | 0.10254 | 0.10230 | 0.10207 | 0.10183 |
| 12 | 0.09705 | 0.09681 | 0.09656 | 0.09632 | 0.09608 | 0.09584 | 0.09559 | 0.09535 | 0.09511 | 0.09487 | 0.09463 | 0.09439 |
| 13 | 0.09080 | 0.09055 | 0.09030 | 0.09006 | 0.08981 | 0.08956 | 0.08932 | 0.08907 | 0.08883 | 0.08858 | 0.08834 | |
| 14 | 0.08545 | 0.08520 | 0.08495 | 0.08470 | 0.08445 | 0.08420 | 0.08395 | 0.08370 | 0.08345 | 0.08320 | | |
| 15 | 0.08082 | 0.08056 | 0.08031 | 0.08006 | 0.07980 | 0.07955 | 0.07930 | 0.07905 | 0.07880 | | | |
| 16 | 0.07678 | 0.07652 | 0.07626 | 0.07601 | 0.07575 | 0.07550 | 0.07524 | 0.07499 | | | | |
| 17 | 0.07322 | 0.07296 | 0.07270 | 0.07244 | 0.07218 | 0.07192 | 0.07166 | | | | | |
| 18 | 0.07006 | 0.06980 | 0.06954 | 0.06928 | 0.06901 | 0.06875 | | | | | | |
| 19 | 0.06725 | 0.06698 | 0.06672 | 0.06645 | 0.06619 | | | | | | | |
| 20 | 0.06472 | 0.06445 | 0.06418 | 0.06391 | | | | | | | | |
| 21 | 0.06244 | 0.06217 | 0.06190 | | | | | | | | | |
| 22 | 0.06037 | 0.06010 | | | | | | | | | | |
| 23 | 0.05849 | | | | | | | | | | | |
| 24 | | | | | | | | | | | | |
| 25 | | | | | | | | | | | | |
| 26 | | | | | | | | | | | | |
| 27 | | | | | | | | | | | | |
| 28 | | | | | | | | | | | | |
| 29 | | | | | | | | | | | | |
| 30 | | | | | | | | | | | | |
| 31 | | | | | | | | | | | | |
| 32 | | | | | | | | | | | | |
| 33 | | | | | | | | | | | | |
| 34 | | | | | | | | | | | | |
| 35 | | | | | | | | | | | | |

| Years | | | | | | | | | | | |
|---|---|---|---|---|---|---|---|---|---|---|---|
| Remaining | | | | | | | | | | | |
| Until Maximum | | | | | | | | | | | |
| Annuity | | | | | | | | | | | |
| Commencement | Age of Younger Covered Person on Rider Effective Date or Last Reset Date | | | | | | | | | | |
| Date | 84 | 85 | 86 | 87 | 88 | 89 | 90 | 91 | 92 | 93 | 94 |
| 1 | 1.00000 | 1.00000 | 1.00000 | 1.00000 | 1.00000 | 1.00000 | 1.00000 | 1.00000 | 1.00000 | 1.00000 | 1.00000 |
| 2 | 0.50568 | 0.50556 | 0.50544 | 0.50532 | 0.50520 | 0.50507 | 0.50495 | 0.50483 | 0.50471 | 0.50458 | |
| 3 | 0.34094 | 0.34078 | 0.34061 | 0.34045 | 0.34028 | 0.34012 | 0.33996 | 0.33979 | 0.33963 | | |
| 4 | 0.25859 | 0.25840 | 0.25822 | 0.25803 | 0.25785 | 0.25766 | 0.25747 | 0.25729 | | | |
| 5 | 0.20920 | 0.20900 | 0.20880 | 0.20860 | 0.20840 | 0.20820 | 0.20800 | | | | |
| 6 | 0.17628 | 0.17607 | 0.17586 | 0.17565 | 0.17544 | 0.17523 | | | | | |
| 7 | 0.15278 | 0.15257 | 0.15235 | 0.15213 | 0.15192 | | | | | | |
| 8 | 0.13517 | 0.13495 | 0.13473 | 0.13450 | | | | | | | |
| 9 | 0.12148 | 0.12125 | 0.12103 | | | | | | | | |
| 10 | 0.11054 | 0.11031 | | | | | | | | | |
| 11 | 0.10159 | | | | | | | | | | |
| 12 | | | | | | | | | | | |
| 13 | | | | | | | | | | | |
| 14 | | | | | | | | | | | |
| 15 | | | | | | | | | | | |
| 16 | | | | | | | | | | | |
| 17 | | | | | | | | | | | |
| 18 | | | | | | | | | | | |
| 19 | | | | | | | | | | | |
| 20 | | | | | | | | | | | |
| 21 | | | | | | | | | | | |
| 22 | | | | | | | | | | | |
| 23 | | | | | | | | | | | |
| 24 | | | | | | | | | | | |
| 25 | | | | | | | | | | | |
| 26 | | | | | | | | | | | |
| 27 | | | | | | | | | | | |
| 28 | | | | | | | | | | | |
| 29 | | | | | | | | | | | |
| 30 | | | | | | | | | | | |
| 31 | | | | | | | | | | | |
| 32 | | | | | | | | | | | |
| 33 | | | | | | | | | | | |
| 34 | | | | | | | | | | | |
| 35 | | | | | | | | | | | |

What is claimed is:

1. A computer system architecture for generating, administering, and issuing a living benefit rider product attached to an annuity product, comprising:
a payment factor computer database storing payment factors;
an interest rates computer database storing interest rates;
a policy information computer database storing customer specific policy related information;
an electronic annuity application computer system receiving requests for the annuity product including a request for an election of the living benefit rider product;
a transaction computer system executing transactions associated with the living benefit rider product;
a unit value computer system determining unit values of underlying investment funds based on daily stock market information and applying charges associated with the annuity product including the living benefit rider product;
a general ledger computer system tracking pertinent financial transactions;
a check writing and electronic funds transfer computer system processing withdrawals of proceeds under predetermined terms of the living benefit rider product;
a financial reporting and trending computer system tracking sales and product performance; and
an annuity administration computer system, connectable to said payment factor database, said interest rates database, said policy information database, said electronic annuity application computer system, said transaction computer system, said unit value computer system, said general ledger computer system, said check writing and electronic funds transfer computer system, and said financial reporting and trending computer system, said annuity administration computer system receiving the election of the living benefit rider product from said electronic annuity application computer system including an election of single or joint coverage and an age of each covered person, and processing a request for a living benefit payment including determining an account value responsive to data received from said unit value computer system, determining the living benefit rider product including a predetermined withdrawal amount based on the interest rates, the customer specific policy related information, and the payment factors, and generating instructions to issue a policy for the annuity product including the living benefit rider product.

2. A computer system architecture for generating, administering, and issuing a living benefit rider product attached to an annuity product, comprising:
a payment factor computer database storing payment factors;
an interest rates computer database storing interest rates;
a policy information computer database storing customer specific policy related information;
an electronic annuity application computer system receiving requests for the annuity product including a request for an election of the living benefit rider product;
a transaction computer system executing transactions associated with the living benefit rider product including accessing financial computer systems; and
an annuity administration computer system, connectable to said payment factor database, said interest rates database, said policy information database, said electronic annuity application computer system, and said transaction computer system, said annuity administration computer system receiving the election of the living benefit rider product from said electronic annuity application computer system including an election of single or joint coverage and an age of each covered person, and processing a request for a living benefit payment including determining an account value responsive to data received from said financial computer systems, determining the living benefit rider product including a predetermined withdrawal amount based on the interest rates, the customer specific policy related information, and the payment factors, and generating instructions to issue a policy for the annuity product including the living benefit rider product.

3. The computer system architecture of claim 2, wherein the annuity administration computer system interfaces with a third party print computer system and a mailing partner computer system to provide client statements and transaction confirmations.

4. The computer system architecture of claim 2, wherein the annuity administration computer system interfaces with one or more broker dealer computer systems to track agent licensing information, calculate and pay commissions on policy sales, and access commission and contract information.

5. The computer system architecture of claim 2, further comprising at least one of a general ledger computer system tracking pertinent financial transactions, a check writing and electronic funds transfer computer system processing withdrawals of proceeds under predetermined terms of the living benefit rider product, and a financial reporting and trending computer system tracking sales and product performance.

6. The computer system architecture of claim 2, further comprising a unit value computer system determining unit values of underlying investment funds based on daily stock market information and applying charges associated with the annuity product including the living benefit rider product.

7. The computer system architecture of claim 2, further comprising at least one client interaction computer application for a policyholder to make direct transactions that will impact the annuity product including the living benefit rider product, the client interaction computer application comprising at least one of an interactive voice response system, an internet interface for accessing values and initiating transactions, a policy print computer system generating printed policies and policy statements, and a tax reporting computer system generating tax reports.

8. A computer system architecture for providing a living benefit, comprising:
an annuity administration computer system receiving an election of a protective income manager (PIM) variable annuity benefit;
one or more computer databases storing a plurality of system tables;
one or more financial computer systems; and
one or more client interaction computer systems,
the computer databases, the financial computer systems, and the client interaction computer systems each in electronic communication with the annuity administration computer system processing PIM withdrawals,
wherein said receiving the election of the PIM benefit comprises receiving policy information including an election of single or joint coverage and an age of each covered person, and receiving a purchase payment, and
wherein said processing the PIM withdrawals comprises determining a contract value responsive to data from the one or more financial computer systems, determining a payment factor responsive to data from one or more of the plurality of system tables, and determining an optimal withdrawal amount based on the contract value and the payment factor.

9. The computer system of claim 8, wherein the plurality of system tables comprise at least one of a product rules table, a PIM payment factors table, an interest rates table, a policy information table, and a business rules table.

10. The computer system of claim 8, wherein the financial computer systems comprise at least one of a general ledger system, a check processing system, a financial reporting system, and a variable fund unit value system.

11. The computer system of claim 8, wherein the client interaction computer systems comprise at least one of an electronic annuity application system, a policy print system, an interactive voice response system, a system providing internet access to values and transactions, and a system providing client statements and trade confirmations.

12. The computer system of claim 8, further comprising an allocation computer system allocating payments and contract value responsive to allocation instructions based on at least one of predetermined Allocation by Investment Category (AIC) guidelines and a Benefit Allocation Model Portfolio.

13. The computer system of claim 8, further comprising an Allocation Adjustment computer system determining an accumulation unit value for each sub-account in a predetermined investment category, and when the accumulation unit value for a particular sub-account is determined to fall below a predetermined value, transferring the contract value in that sub-account to an alternate specified account.

14. The computer system of claim 13, wherein the accumulation unit value is a 12-month Simple Moving Average (SMA₁₂).

15. A computer implemented method of providing a living benefit, comprising:
receiving an electronic election of a protective income manager (PIM) variable annuity benefit, by an annuity administration computer system, said receiving the electronic election comprising receiving policy information including an election of single or joint coverage and an age of each covered person, and receiving a purchase payment;
storing the policy information in a computer database in communication with the annuity administration computer system;
determining a contract value, by the annuity administration computer system, responsive to data from a unit value computer system in communication with the annuity administration computer system valuing each underlying variable fund;
determining a payment factor, by the annuity administration computer system, responsive to data from one or more system tables stored in the computer database, including at least one of a product rules table, a payment factors table, an interest/other rates table, a policy information table, and a business rules table;
determining an optimal withdrawal amount, by the annuity administration computer system, based on the contract value and the payment factor; and
providing a PIM payment, by the annuity administration computer system, using a check processing system or an electronic funds transfer system in communication with the annuity administration computer system.

16. The computer implemented method of claim 15, further comprising receiving the electronic election of the PIM benefit from a broker dealer computer system.

17. The computer implemented method of claim 15, further comprising receiving the electronic election of the PIM benefit from an electronic annuity application computer system.

18. The computer implemented method of claim 15, further comprising determining a fee for the PIM benefit, by the annuity administration computer system, responsive to the contract value and data from the interest/other rates table.

19. The computer implemented method of claim 15, further comprising rebalancing the portfolio, by the annuity administration computer system, on a periodic basis.

20. The computer implemented method of claim 15, further comprising determining the optimal withdrawal amount on each monthly anniversary of the PIM effective date.

21. The computer implemented method of claim 20, further comprising, when withdrawal in excess of the optimal withdrawal amount is made, resetting the optimal withdrawal amount on the next monthly anniversary, and determining the optimal withdrawal amount on each subsequent monthly anniversary to be the lesser of the initial optimal withdrawal amount and the reset optimal withdrawal amount.

22. The computer implemented method of claim 15, further comprising, when joint coverage is elected, determining the payment factor responsive to the age of the youngest covered person.

23. The computer implemented method of claim 15, further comprising providing a PIM payment at least equal to the initial optimal withdrawal amount, even when the contract value is zero.

24. The computer implemented method of claim 15, further comprising monitoring, by the annuity administration computer system, the unit value for each sub-account in a predetermined investment category, and, when the value for a particular sub-account is determined to fall below a predetermined value, transferring the contract value in that sub-account to an alternate specified account.

25. The computer implemented method of claim 23, wherein the unit value for each sub-account in a predetermined investment category is a 12-month Simple Moving Average (SMA₁₂).

26. A computer implemented method of generating an electronic transaction to perform an allocation adjustment for a customer account of an annuity product, comprising:
retrieving by a specially programmed computer processor customer specific policy related information associated with the annuity product from a policy information computer database;
determining by the specially programmed computer processor an accumulation unit value for at least one fund in a specified investment class of the account at a given time t (AUVₜ) for the customer specific policy related information;
determining by the specially programmed computer processor a 12-month simple moving average accumulation unit value for the at least one fund for the prior 12 months (SMA₁₂);
when AUVₜ is less than SMA₁₂, designating by the specially programmed computer processor the at least one fund as restricted;
when the AUVₜ is greater than or equal to SMA₁₂, designating by the specially programmed computer processor the at least one fund as unrestricted; and when the at least one fund is designated as restricted, generating by the specially programmed computer processor the electronic transaction to perform the allocation adjustment for the customer account.

27. The computer implemented method of claim 26, further comprising:
when the at least one fund is designated as restricted, generating by the specially programmed computer processor the electronic transaction to perform the allocation adjustment for the customer account to convert the at least one fund to a predetermined alternative fund.

28. The computer implemented method of claim 26, wherein the alternative fund is a money market fund.

29. The computer implemented method of claim 27, further comprising:
determining an updated AUV for the restricted fund at a time subsequent to time t; and
when the updated AUV is greater than or equal to SMA₁₂, designating the previously-restricted fund as unrestricted, and using the percentage of account value in the alternative fund associated with said electronic transaction to purchase units in the previously-restricted fund.

30. The computer implemented method of claim 29, wherein the time subsequent to time t is monthly anniversary of the contract.

31. The computer implemented method of claim 26, further comprising:
generating a daily extract with information including AUVₜ, SMA₁₂, name of the fund, and restricted indicator, and using the extract to populate a web site with the information so that customers can tell which funds have been restricted and which fund are unrestricted.

32. A computer system architecture for allocation adjustment for a variable account of an insurance contract, comprising:
a unit value computer system determining an accumulation unit value for each underlying fund in the variable account and, for each contract, converting all purchase payments and contract value in the fund into accumulation units;
a computer database storing unit value data;
an allocation adjustment computer system determining the accumulation unit value for each fund in a specified investment class of the variable account at a given time t (AUVₜ), determining a 12-month simple moving average accumulation unit value for the fund for the prior 12 months (SMA₁₂), and when AUVₜ is less than SMA₁₂, designating the fund as restricted, and when the AUVₜ is greater than or equal to SMA₁₂, designating the fund as unrestricted; and
a transaction computer system transferring all money in the restricted fund to a predetermined alternative fund when the fund is restricted, and when a previously-restricted fund is designated as unrestricted, using the percentage of account value in the alternative fund associated with said transferring to purchase units in the previously-restricted fund.

33. The computer system architecture of claim 32, wherein the alternative fund is a money market fund.

34. The computer system architecture of claim 32, further comprising the transaction computer system determining an updated AUV for the restricted fund at a time subsequent to time t, and, when the updated AUV is greater than or equal to SMA₁₂, designating the previously-restricted fund as unrestricted, and using the percentage of account value in the alternative fund associated with said transferring to purchase units in the previously-restricted fund.

35. The computer system architecture of claim 34, wherein the time subsequent to time t is monthly anniversary of the contract.

36. The computer system architecture of claim 32, further comprising:
a reporting computer system generating a daily extract with information including AUVₜ, SMA₁₂, name of the fund, and restricted indicator, and using the extract to populate a web site with the information so that customers can tell which funds have been restricted and which fund are unrestricted.
